(19) United States
(12) Patent Application Publication
(10) Pub. No.: US 2022/0175002 A1
(43) Pub. Date: Jun. 9, 2022

(54) COMPOSITIONS COMPRISING MOGROSIDES, STEVIOL GLYCOSIDES AND GLYCOSYLATED DERIVATIVES THEREOF AND METHODS OF ENHANCING THE MOUTHFEEL OR SWEETNESS OF CONSUMABLES

(71) Applicant: EPC Natural Products Co., Ltd., BEIJING (CN)

(72) Inventors: Jingang SHI, BEIJING (CN); Hansheng WANG, BEIJING (CN); Thomas EIDENBERGER, WELS (AT); Xiaorui ZHANG, BEIJING (CN); Weiyao SHI, Bethlehem, PA (US)

(21) Appl. No.: 17/457,250

(22) Filed: Dec. 1, 2021

Related U.S. Application Data
(60) Provisional application No. 63/120,462, filed on Dec. 2, 2020.

(51) Int. Cl. A23L 27/30

(52) U.S. Cl. CPC A23L 27/36; A23L 27/31

(57) ABSTRACT

The invention describes compositions comprising glycosylated mogroside(s) or glycosylated swingle extracts and methods of enhancing the mouthfeel, sweetness or flavor of consumable products.

This application claims the benefit of priority from U.S. Provisional Patent Application No. 63/120,462 filed Dec. 2, 2020.

### FIELD

The invention relates generally to compositions comprising glycosylated mogroside(s) or glycosylated swingle extracts and methods of enhancing the mouthfeel, sweetness or flavor of consumable products.

### BACKGROUND

Caloric sugars are widely used in the food and beverage industry. However, there is a growing trend toward use of more healthy alternatives, including non-caloric or low caloric sweeteners. Popular non-caloric sweeteners include high intensity synthetic sweeteners, such as aspartame (e.g., NutraSweet, Equal), sucralose (Splenda), and acesulfame potassium (also known as acesulfame K, or Ace-K), as well as high intensity natural sweeteners, which are typically derived from plants, such as Stevia and fruits of Siraitia grosvenorii (Swingle). However, the taste and temporal profiles of stevia extracts and swingle extracts are not ideal and often contain certain off-flavors, and unfavored tastes such as bitterness, metallic taste, licorice taste, lingering aftertaste and delayed onset of sweetness.

Therefore, a need exists for low caloric sweeteners with improved taste profiles.

### SUMMARY

One aspect of the present application relates to a sweetener or flavoring composition. The sweetener or flavoring composition comprises (A) one or more glycosylated mogrosides (GMGs); and (B) one or more non-mogroside sweeteners.

In some embodiments, the one or more GMGs comprise a glycosylated mogroside IIe, a glycosylated mogroside III, a glycosylated mogroside IIIe, a glycosylated mogroside IV, a glycosylated mogroside IVe, a glycosylated mogroside V, a glycosylated mogroside VI, a glycosylated siamenoside I, a glycosylated 11-oxomogroside V, or any combination thereof.

In some embodiments, the the one or more GMGs comprises glycosylated mogroside V. In some embodiments, the glycosylated mogroside V comprises MGV-G1, MGV-G2, MGV-G3, MGV-G4 and/or MGV-G5.

In some embodiments, the one or more non-mogroside sweeteners comprise steviol glycosides. In some embodiments, the one or more non-mogroside sweeteners comprise RD, RM or both RD and RM. In some embodiments, the one or more non-mogroside sweeteners comprise RU. In some embodiments, the one or more non-mogroside sweeteners comprise glycosylated steviol glycosides (GSGs). In some embodiments, the one or more non-mogroside sweeteners comprise glycosylated RU.

In some embodiments, the weight ratio of A:B is in the range of 99:1 to 1:99.

In some embodiments, the sweetener or flavoring composition further comprises one or more un-reacted mogrosides. In some embodiments, the one or more un-reacted mogrosides are present in a total amount of 0.001-20 wt % of the sweetener or flavoring composition.

In some embodiments, the sweetener or flavoring composition further comprises un-reacted dextrins. In some embodiments, the un-reacted dextrins are present in a total amount of 0.001-30 wt % of the composition.

In some embodiments, the sweetener or flavoring composition further comprises a sweetener selected from the group consisting of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

Another aspect of the present application relates to a method of improving the taste profile of a steviol glycoside composition, comprising: additing to the steviol glycoside composition, a sufficient amount of a glycosylated mogroside.

In some embodiments, the steviol glycoside composition comprises RU. In some embodiments, the steviol glycoside composition comprises RD, RM or a combination thereof.

Another aspect of the present application relates to a method of improving the taste profile of a glycosylate steviol glycoside composition, comprising: additing to the glycosylated steviol glycoside composition, a sufficient amount of a glycosylated mogroside.

In some embodiments, the glycosylated steviol glycoside composition comprises glycosylated RU.

### BRIEF DESCRIPTION OF THE DRAWINGS

FIG. 1 is a schematic diagram of the Time-intensity curve of GMGs prepared with different ratios of maltodextrin.

FIG. 2 shows sensory evaluation results of different GMGs in 200 ppm RU90 solutions.

FIG. 3 shows sensory evaluation results of different GMGs in 200 ppm Reb M solutions.

FIG. 4 shows the relationship between the sensory evaluation results as a function of the weight ratio of GMG to RU90.

FIG. 5 shows the relationship between the overall likability as a function of the weight ratio of GMG to RU90.

FIG. 6 shows the relationship between the sensory evaluation results as a function of the weight ratio of GMG to Reb M.

FIG. 7 shows the relationship between the overall likability as a function of the weight ratio of GMG to Reb M.

FIG. 8 shows the relationship between the sensory evaluation results as a function of the weight ratio of GMG to GRU.

FIG. 9 shows the relationship between the overall likability as a function of the weight ratio of GMG to GRU.

FIG. 10 shows the relationship between the sensory evaluation results as a function of the weight ratio of GMG to RD.

FIG. 11 shows the relationship between the overall likability as a function of the weight ratio of GMG to RD.

FIG. 12 shows the relationship between the sensory evaluation results as a function of the weight ratio of GMG to RD/RM.

FIG. 13 shows the relationship between the overall likability as a function of the weight ratio of GMG to RD/RM.

### DETAILED DESCRIPTION

### Definitions

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

The term “mogroside” or “MG”, as used herein, refers to a family of triterpene glycosides isolated from fruits of Siraitia grosvenorii (Swingle), also known as Momordica grosvenori (Swingle), Luo Han Guo or monk fruit etc. Extracts of the fruits, i.e., Swingle extracts, are commercially used as natural sweeteners. A number of compounds, including but are not limited to, mogroside IIe (MGIIe, MG-IIe or Mo IIe), mogroside III (MGIII, MG-III or Mo III), mogroside IIIe (MGIIIe, MG-IIIe or MO IIIe), mogroside IV (MGIV, MG-VI or Mo IV), mogroside IVa (MGIVa, MG-IVa or Mo IVa), mogroside IVe (MGIVe, MG-IVe or Mo IVe), mogroside V (MGV, MG-V, MV or Mo V), isomogroside V (IMGV, IMG-V or Mo V Iso), 7-oxomogroside V (7-OMGV, 7-OMG-V or 7-0 Mo V), 11-oxomogroside V (11-OMGV, 11-OMG-V or 11-0 Mo V), dehydroxy Mo V (DMGV, DMG-V), mogroside VI (MGVI, MG-VI), 11-oxomogroside VI (11-OMGVI, 11-OMG-VI or 11-0 Mo VI), mogroside A (MGA, MG-A), neomogroside (NMG), mogroester (MGE), siamenoside I (SSI or Siam I), grosvenorine I (GVRI, GVR-I), grosvenorine II (GVRII, GVR-II), grosmomoside I (GMSI, GMS-I) and grosmomoside II (GMSII, GMS-II), have been identified from the fruits of Siraitia grosvenorii (Swingle) that are responsible for the sweetness of the fruits. MGV is a mogrol glycoside containing five sugar residues per molecule. The chemical structure of MGV, MGIIe, MGIII and MGIV is represented by formula (I) as shown below. In recent years, various extraction and purification methods have been developed which are capable of providing Luo Han Guo fruit extracts having a relatively high content of MGV. Such extracts are now being marketed as non-caloric natural sweeteners in some countries.

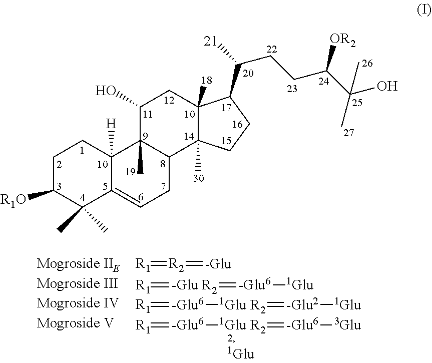

As used herein, the terms “steviol glycoside,” or “SG” refers to a glycoside of steviol, a diterpene compound shown in Formula II.

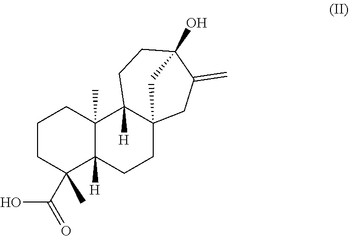

Based on the type of sugar (i.e. glucose, rhamnose/deoxyhexose, xylose/arabinose) SGs can be grouped into three families (1) SGs with glucose; (2) SG with glucose and one rhamnose or deoxyhexose moiety; and (3) SGs with glucose and one xylose or arabinose moiety.

Table A provides a non-limiting list of about 80 SGs grouped according to the molecular weight. The steviol glycosides for use in the present application are not limited by source or origin. Steviol glycosides may be extracted from Stevia leaves, synthesized by enzymatic processes, synthesized by chemical syntheses, or produced by fermentation. Steviol glycosides found in the Stevia plant include rebaudioside A (RA), rebaudioside B (RB), rebaudioside D (RD), stevioside, rubusoside, as well as those in Table B (below) etc., and further includes mixtures thereof. The steviol glycoside of interest can be purified before use.

TABLE A
SGs grouped by molecular weight (MW)

| | | | # Added | | | | |
|---|---|---|---|---|---|---|---|
| | | | Rhamnose/ | # Added | | | |
| | | # Added | Deoxy- | Xylose/ | | | |
| | | Glucose | hexose | Arabinose | | | |
| | | moieties | moieties | moieties | | | |
| SG Name | MW | mw = 180 | mw = 164 | mw = 150 | R1 (C-19) | R2 (C-13) | Backbone |
| Related | 457 | — | | | | | |
| SvGn#1 | | | | | | | |
| Steviol- | 479 | 1 | | | H- | Glcβ1- | Steviol |
| monoside | | | | | | | |
| Steviol- | 479 | 1 | 1 | | Glcβ1- | H- | |
| monoside A | | | | | | | |
| SG-4 | 611 | 1 | | 1 | H- | Xylβ(1-2)Glcβ1- | Steviol |
| Dulcoside | 625 | 1 | 1 | | H- | Rhaα(1-2)Glcβ1- | Steviol |
| A1 | | | | | | | |
| Iso-steviol- | 641 | 2 | | | H- | Glcβ(1-2)Glcβ1- | Isosteviol |
| bioside | | | | | | | |
| Reb-G1 | 641 | 2 | | | H- | Glcβ(1-3)Glcβ1- | Steviol |
| Rubusoside | 641 | 2 | | | Glcβ1- | Glcβ1- | Steviol |
| Steviolbioside | 641 | 2 | | | H- | Glcβ(1-2)Glcβ1- | Steviol |
| Related | 675 | — | | | | | |
| SvGn#3 | | | | | | | |
| Reb-F1 | 773 | 2 | | 1 | H- | Xylβ(1-2)[Glcβ(1- | Steviol |
| | | | | | | 3)]Glcβ1- | |
| Reb-R1 | 773 | 2 | | 1 | H- | Glcβ(1-2)[Glcβ(1- | Steviol |
| | | | | | | 3)]Xylβ1- | |
| Stevioside F | 773 | 2 | | 1 | Glcβ1- | Xylβ(1-2)Glcβ1- | Steviol |
| (SG-1) | | | | | | | |
| SG-Unk1 | 773 | 2 | | 1 | — | — | Steviol |
| Dulcoside A | 787 | 2 | 1 | | Glcβ1- | Rhaα(1-2)Glcβ1- | Steviol |
| Dulcoside B | 787 | 2 | 1 | | H- | Rhaα(1-2)[Glcβ(1- | Steviol |
| (JECFA C) | | | | | | 3)]Glcβ1- | |
| SG-3 | 787 | 2 | 1 | | H- | 6-deoxyGlcβ(1- | Steviol |
| | | | | | | 2)[Glcβ(1-3)]Glcβ1- | |
| Stevioside D | 787 | 2 | 1 | | Glcβ1- | Glcβ(1-2)6- | |
| | | | | | | deoxyGlcβ1- | |
| Iso-Reb B | 803 | 3 | | | H- | Glcβ(1-2)[Glcβ(1- | Isosteviol |
| | | | | | | 3 )]Glcβ1- | |
| Iso- | 803 | 3 | | | Glcβ1- | Glcβ(1-2)Glcβ1- | Isosteviol |
| Stevioside | | | | | | | |
| Reb B | 803 | 3 | | | H- | Glcβ(1-2)[Glcβ(1- | Steviol |
| | | | | | | 3)]Glcβ1- | |
| Reb G | 803 | 3 | | | Glcβ1- | Glcβ(1-3)Glcβ1- | Steviol |
| Reb-KA | 803 | 3 | | | Glcβ(1-2)Glcβ1- | Glcβ1- | Steviol |
| SG-13 | 803 | 3 | | | Glcβ1- | Glcβ(1-2)Glcβ1- | Isomeric |
| | | | | | | | steviol |
| | | | | | | | (12α- |
| | | | | | | | hydroxy) |
| Stevioside | 803 | 3 | | | Glcβ1- | Glcβ(1-2)Glcβ1- | Steviol |
| Stevioside B | 803 | 3 | | | Glcβ(1-3)Glcβ1- | Glcβ1- | Steviol |
| (SG-15) | | | | | | | |
| Reb F | 935 | 3 | | 1 | Glcβ1- | Xylβ(1-2)[Glcβ(1- | Steviol |
| | | | | | | 3)]Glcβ1- | |
| Reb R | 935 | 3 | | 1 | Glcβ1- | Glcβ(1-2)[Glcβ(1- | Steviol |
| | | | | | | 3)]Xylβ1- | |
| SG-Unk2 | 935 | 3 | | 1 | — | — | Steviol |
| SG-Unk3 | 935 | 3 | | 1 | — | — | Steviol |
| Reb F3 | 935 | 3 | | 1 | Xylβ(1-6)Glcβ1- | Glcβ(1-2)Glcβ1- | Steviol |
| (SG-11) | | | | | | | |
| Reb F2 | 935 | 3 | | 1 | Glcβ1- | Glcβ(1-2)[Xylβ(1- | Steviol |
| (SG-14) | | | | | | 3)]Glcβ1- | |
| Reb C | 949 | 3 | 1 | | Glcβ1- | Rhaα(1-2)[Glcβ(1- | Steviol |
| | | | | | | 3)]Glcβ1- | |
| Reb C2/Reb S | 949 | 3 | 1 | | Rhaα(1-2)Glcβ1- | Glcβ(1-2)Glcβ1- | Steviol |
| Stevioside E | 949 | 3 | 1 | | Glcβ1- | 6-DeoxyGlcβ(1- | Steviol |
| (SG-9) | | | | | | 2)[Glcβ(1-3)1Glcβ1- | |
| Stevioside | 949 | 3 | 1 | | 6-DeoxyGlcβ1- | Glcβ(1-2)[Glcβ(1- | |
| E2 | | | | | | 3)]Glcβ1- | |
| SG-10 | 949 | 3 | 1 | | Glcβ1- | Glcα(1-3)Glcβ(1- | Steviol |
| | | | | | | 2)[Glcβ(1-31)Glcβ1- | |
| Reb L1 | 949 | 3 | 1 | | H- | Glcβ(1-3)Rhaα(1- | Steviol |
| | | | | | | 2)[Glcβ(1-3])Glcβ1- | |
| SG-2 | 949 | 3 | 1 | | Glcβ1- | 6-deoxyGlcβ(1- | Steviol |
| | | | | | | 2)[Glcβ(1-3)]Glcβ1- | |
| Reb A3 | 965 | 4 (1 Fru) | | | Glcβ1- | Glcβ(1-2)[Fruβ(1- | |
| (SG-8) | | | | | | 3)]Glcβ1- | |
| Iso-Reb A | 965 | 4 | | | Glcβ1- | Glcβ(1-2)[Glcβ(1- | Isosteviol |
| | | | | | | 3)]Glcβ1- | |
| Reb A | 965 | 4 | | | Glcβ1- | Glcβ(1-2)[Glcβ(1- | Steviol |
| | | | | | | 3)]Glcβ1- | |
| Reb A2 | 965 | 4 | | | Glcβ1- | Glcβ(1-6)[Glcβ(1- | Steviol |
| (SG-7) | | | | | | 2)]Glcβ1- | |
| Reb E | 965 | 4 | | | Glcβ(1-2)Glcβ1- | Glcβ(1-2)Glcβ1- | Steviol |
| Reb H1 | 965 | 4 | | | H- | Glcβ(1-6)Glcβ(1- | Steviol |
| | | | | | | 3)[Glcβ1-3)]Glcβ1- | |
| Related | 981 | — | | | | | |
| SvGn#2 | | | | | | | |
| Related | 981 | — | | | | | |
| SvGn#5 | | | | | | | |
| Reb U2 | 1097 | 4 | | 1 | Xylβ(1-2)[Glcβ(1- | Glcβ(1-2)Glcβ1- | |
| | | | | | 3)]Glcβ1- | | |
| Reb T | 1097 | 4 | | 1 | Xylβ(1-2)Glcβ1- | Glcβ(1-2)[Glcβ(1- | |
| | | | | | | 3)]Glcβ1- | |
| Reb W | 1097 | 4 | | 1 | Glcβ(1-2)[Ararβ(1- | Glcβ(1-2)Glcβ1- | |
| | | | | | 3)]Glcβ1- | | |
| Reb W2 | 1097 | 4 | | 1 | Araβ(1-2)Glcβ1- | Glcβ(1-2)[Glcβ(1- | |
| | | | | | | 3)]Glcβ1- | |
| Reb W3 | 1097 | 4 | | 1 | Araβ(1-6)Glcβ1- | Glcβ(1-2)[Glcβ(1- | |
| | | | | | | 3)]Glcβ1- | |
| Reb U | 1097 | 4 | | 1 | Araα(1-2)-Glcβ1- | Glcβ(1-2)[Glcβ(1- | Steviol |
| | | | | | | 3)]Glcβ1- | |
| SG-12 | 1111 | 4 | 1 | | Rhaα(1-2)Glcβ1- | Glcβ(1-2)[Glcβ(1- | Steviol |
| | | | | | | 3)]Glcβ1- | |
| Reb H | 1111 | 4 | 1 | | Glcβ1- | Glcβ(1-3)Rhaα(1- | Steviol |
| | | | | | | 2)[Glcβ(1-3)]Glcβ1- | |
| Reb J | 1111 | 4 | 1 | | Rhaα(1-2)Glcβ1- | Glcβ(1-2)[Glcβ(1- | Steviol |
| | | | | | | 3)]Glcβ1- | |
| Reb K | 1111 | 4 | 1 | | Glcβ(1-2)Glcβ1- | Rhaα(1-2)[Glcβ(1- | Steviol |
| | | | | | | 3)]Glcβ1- | |
| Reb K2 | 1111 | 4 | 1 | | Glcβ(1-6)Glcβ1- | Rhaα(1-2)[Glcβ(1- | Steviol |
| | | | | | | 3)]Glcβ1- | |
| SG-Unk4 | 1111 | 4 | 1 | | — | — | Steviol |
| SG-Unk5 | 1111 | 4 | 1 | | — | — | Steviol |
| Reb D | 1127 | 5 | | | Glcβ(1-2)Glcβ1- | Glcβ(1-2)[Glcβ(1- | Steviol |
| | | | | | | 3)]Glcβ1- | |
| Reb I | 1127 | 5 | | | Glcβ(1-3)Glcβ1- | Glcβ(1-2)[Glcβ(1- | Steviol |
| | | | | | | 3)]Glcβ1- | |
| Reb L | 1127 | 5 | | | Glcβ1- | Glcβ(1-6)Glcβ(1- | Steviol |
| | | | | | | 2)[Glcβ(1-3)]Glcβ1- | |
| Reb I3 | 1127 | 5 | | | [Glcβ(1-2)Glcβ(1- | Glcβ(1-2)Glcβ1- | |
| | | | | | 6)]Glcβ1- | | |
| SG-Unk6 | 1127 | 5 | | | — | — | Steviol |
| Reb Q | 1127 | 5 | | | Glcβ1- | Glcα(1-4)Glcβ(1- | Steviol |
| (SG-5) | | | | | | 2)[Glcβ(1-3)]Glcβ1- | |
| Reb I2 | 1127 | 5 | | | Glcβ1- | Glcα(1-3)Glcβ1- | Steviol |
| (SG-6) | | | | | | 2[Glcβ1-3)]Glcβ1- | |
| Reb Q2 | 1127 | 5 | | | Glcα(1-2)Glcα(1- | Glcβ(1-2)Glcβ1- | |
| | | | | | 4)Glcβ1- | | |
| Reb Q3 | 1127 | 5 | | | Glcβ1- | Glcα(1-4)Glcβ(1- | |
| | | | | | | 3)[Glcβ(1-2)]Glcβ1- | |
| Reb T1 | 1127 | 5 (1 Gal) | | | Galβ(1-2)Glcβ1- | Glcβ(1-2)[Glcβ(1- | |
| | | | | | | 3)]Glcβ1- | |
| Related | 1127 | — | | | | | |
| SvGn#4 | | | | | | | |
| Reb V2 | 1259 | 5 | | 1 | Xylβ(1-2)[Glcβ(1- | Glcβ(1-2)[Glcβ(1- | Steviol |
| | | | | | 3)]-Glcβ1- | 3)]Glcβ1- | |
| Reb V | 1259 | 5 | | 1 | Glcβ(1-2)[Glcβ(1- | Xylβ(1-2)[Glcβ(1- | |
| | | | | | 3)]Glcβ1- | 3)]-Glcβ1- | |
| Reb Y | 1259 | 5 | | 1 | Glcβ(1-2)[Araβ(1- | Glcβ(1-2)[Glcβ(1- | |
| | | | | | 3)]Glcβ1- | 3)]Glcβ1- | |
| Reb N | 1273 | 5 | 1 | | Rhaα(1-2)[Glcβ(1- | Glcβ(1-2)[Glcβ(1- | Steviol |
| | | | | | 3)]Glcβ1- | 3)]Glcβ1- | |
| Reb M | 1289 | 6 | | | Glcβ(1-2)[Glcβ(1- | Glcβ(1-2)[Glcβ(1- | Steviol |
| | | | | | 3)]Glcβ1- | 3)]Glcβ1- | |
| 15α-OH | 1305 | 6 | | | Glcβ1-2(Glcβ1- | Glcβ(1-2)[Glcβ1- | 15α- |
| Reb M | | | | | 3)Glcβ1- | 3]Glcβ1- | Hydroxy- |
| | | | | | | | steviol |
| Reb O | 1435 | 6 | 1 | | Glcβ(1-3)Rhaα(1- | Glcβ(1-2)[Glcβ(1- | Steviol |
| | | | | | 2)[Glcβ(1-3)]Glcβ1- | 3)]Glcβ1- | |
| Reb O2 | 1435 | 6 | 1 | | Glcβ(1-4)Rhaα(1- | Glcβ(1-2)[Glcβ(1- | |
| | | | | | 2)[Glcβ(1-3)]Glcβ1- | 3)]Glcβ1- | |

Legend: SG-1 to 16: SGs without a specific name; SG-Unk1-6: SGs without detailed structural proof; Glc: Glucose; Rha: Rhamnose; Xyl: Xylose; Ara: Arabinose.

TABLE B

| | | | | Added | Added | | | |
|---|---|---|---|---|---|---|---|---|
| | | | Added | Rhamnoe/ | Xylose/ | | | |
| | | | Glucose | DeoxyHex | Arabinose | | | |
| | Name | MW | MW = 180 | MW = 164 | MW = 150 | R1 (C-19) | R2 (C-13) | Backbone |
| SG-1G | Steviol- | 480 | 1 | | | H- | Glcβ1- | Steviol |
| | monoside | | | | | | | |
| | Steviol- | 480 | 1 | | | Glcβ1- | H- | Steviol |
| | monoside | | | | | | | |
| | A | | | | | | | |
| SG-1G1R | Dulcoside | 626 | 1 | 1 | | H- | Rhaα(1-2)Glcβ1- | Steviol |
| | A1 | | | | | | | |
| | Dulcoside | 626 | 1 | 1 | | | | Steviol |
| | A1 | | | | | | | |
| SG-1G1X | SG-4 | 612 | 1 | | 1 | H- | Xylβ(1-2)Glcβ1- | Steviol |
| SG-2G | Reb-G1 | 642 | 2 | | | H- | Glcβ(1-3)Glcβ1- | Steviol |
| | Rubusoside | 642 | 2 | | | Glcβ1- | Glcβ1- | Steviol |
| | Steviolbioside | 642 | 2 | | | H- | Glcβ(1-2)Glcβ1- | Steviol |
| SG-2G1R | Dulcoside | 788 | 2 | 1 | | Glcβ1- | Rhaα(1-2)Glcβ1- | Steviol |
| | A | | | | | | | |
| | Dulcoside | 788 | 2 | 1 | | H- | Rhaα(1- | Steviol |
| | B (JECFA | | | | | | 2)[Glcβ(1- | |
| | C) | | | | | | 3)]Glcβ1- | |
| | SG-3 | 788 | 2 | 1 | | H- | 6-deoxyGlcβ(1- | Steviol |
| | | | | | | | 2)[Glcβ(1- | |
| | | | | | | | 3)]Glcβ1- | |
| | Stevioside | 788 | 2 | 1 | | Glcβ1- | Glcβ(1-2)6- | Steviol |
| | D | | | | | | deoxyGlcβ1- | |
| SG-2G1X | Reb-F1 | 774 | 2 | | 1 | H- | Xylβ(1- | Steviol |
| | | | | | | | 2)[Glcβ1- | |
| | | | | | | | 3)]Glcβ1- | |
| | Reb-R1 | 774 | 2 | | 1 | H- | Glcβ(1- | Steviol |
| | | | | | | | 2)[Glcβ1- | |
| | | | | | | | 3)]Xylβ1- | |
| | Stevioside | 774 | 2 | | 1 | Glcβ1- | Xylβ(1-2)Glcβ1- | Steviol |
| | F (SG-1) | | | | | | | |
| | SG-Unk1 | 774 | 2 | | 1 | — | — | Steviol |
| SG-3G | Reb B | 804 | 3 | | | H- | Glcβ(1- | Steviol |
| | | | | | | | 2)[Glcβ1- | |
| | | | | | | | 3)]Glcβ1- | |
| | Reb G | 804 | 3 | | | Glcβ1- | Glcβ(1-3)Glcβ1- | Steviol |
| | Reb-KA | 804 | 3 | | | Glcβ(1- | Glcβ1- | Steviol |
| | | | | | | 2)Glcβ1- | | |
| | Stevioside | 804 | 3 | | | Glcβ1- | Glcβ(1-2)Glcβ1- | Steviol |
| | Stevioside | 804 | 3 | | | Glcβ(1- | Glcβ1- | Steviol |
| | B (SG-15) | | | | | 3)Glcβ1- | | |
| SG- | Reb A3 | 966 | 4 (1 | | | Glcβ1- | Glcβ(1- | Steviol |
| 3G1Fru | (SG-8) | | Fru) | | | | 2)[Fruβ(1- | |
| | | | | | | | 3)]Glcβ1- | |
| SG- | Reb C | 950 | 3 | 1 | | Glcβ1- | Rhaα(1- | Steviol |
| 3G1R | | | | | | | 2)[Glcβ1- | |
| | | | | | | | 3)]Glcβ1- | |
| | Reb C2/ | 950 | 3 | 1 | | Rhaα(1- | Glcβ(1-2)Glcβ1- | Steviol |
| | Reb S | | | | | 2)Glcβ1- | | |
| | Stevioside | 950 | 3 | 1 | | Glcβ1- | 6-DeoxyGlcβ(1- | Steviol |
| | E (SG-9) | | | | | | 2)[Glcβ1- | |
| | | | | | | | 3)]Glcβ1- | |
| | Stevioside | 950 | 3 | 1 | | 6- | Glcβ(1- | Steviol |
| | E2 | | | | | DeoxyGlcβ1- | 2)[Glcβ1- | |
| | | | | | | | 3)]Glcβ1- | |
| | SG-10 | 950 | 3 | 1 | | Glcβ1- | Glcα(1- | Steviol |
| | | | | | | | 3)Glcβ(1- | |
| | | | | | | | 2)[Glcβ1- | |
| | | | | | | | 3])Glcβ1- | |
| | Reb L1 | 950 | 3 | 1 | | H- | Glcβ(1- | Steviol |
| | | | | | | | 3)Rhaα(1- | |
| | | | | | | | 2)[Glcβ(1- | |
| | | | | | | | 3)]Glcβ1- | |
| | SG-2 | 950 | 3 | 1 | | Glcβ1- | 6-deoxyGlcβ(1- | Steviol |
| | | | | | | | 2)[Glcβ1- | |
| | | | | | | | 3)]Glcβ1- | |
| SG- | Reb F | 936 | 3 | | 1 | Glcβ1- | Xylβ(1- | Steviol |
| 3G1X | | | | | | | 2)[Glcβ1- | |
| | | | | | | | 3)]Glcβ1- | |
| | Reb R | 936 | 3 | | 1 | Glcβ1- | Glcβ(1- | Steviol |
| | | | | | | | 2)[Glcβ1- | |
| | | | | | | | 3)]Xylβ1- | |
| | SG-Unk2 | 936 | 3 | | 1 | — | — | Steviol |
| | SG-Unk3 | 936 | 3 | | 1 | — | — | Steviol |
| | Reb F3 | 936 | 3 | | 1 | Xylβ(1- | Glcβ(1-2)Glcβ1- | Steviol |
| | (SG-11) | | | | | 6)Glcβ1- | | |
| | Reb F2 | 936 | 3 | | 1 | Glcβ1- | Glcβ(1- | Steviol |
| | (SG-14) | | | | | | 2)[Xylβ(1- | |
| | | | | | | | 3)]Glcβ1- | |
| SG-4G | Reb A | 966 | 4 | | | Glcβ1- | Glcβ(1- | Steviol |
| | | | | | | | 2)[Glcβ1- | |
| | | | | | | | 3)]Glcβ1- | |
| | Reb A2 | 966 | 4 | | | Glcβ1- | Glcβ(1-6)[Glcβ(1- | Steviol |
| | (SG-7) | | | | | | 2)]Glcβ1- | |
| | Reb E | 966 | 4 | | | Glcβ(1- | Glcβ(1-2)Glcβ1- | Steviol |
| | | | | | | | 2)Glcβ1- | |
| | Reb H1 | 966 | 4 | | | H- | Glcβ(1- | Steviol |
| | | | | | | | 6)Glcβ(1- | |
| | | | | | | | 3)[Glcβ1- | |
| | | | | | | | 3)]Glcβ1- | |
| SG- | Reb T1 | 1128 | 5 (1 | | | Galβ(1- | Glcβ(1- | Steviol |
| 4G1Gal | | | Gal) | | | 2)Glcβ1- | 2)[Glcβ1- | |
| | | | | | | | 3)]Glcβ1- | |
| SG- | SG-12 | 1112 | 4 | 1 | | Rhaα(1- | Glcβ(1- | Steviol |
| 4G1R | | | | | | 2)Glcβ1- | 2)[Glcβ(1- | |
| | | | | | | | 3)]Glcβ1- | |
| | Reb H | 1112 | 4 | 1 | | Glcβ1- | Glcβ(1- | Steviol |
| | | | | | | | 3)Rhaα(1- | |
| | | | | | | | 2)[Glcβ1- | |
| | | | | | | | 3)]Glcβ1- | |
| | Reb J | 1112 | 4 | 1 | | Rhaα(1- | Glcβ(1- | Steviol |
| | | | | | | 2)Glcβ1- | 2)[Glcβ1- | |
| | | | | | | | 3)]Glcβ1- | |
| | Reb K | 1112 | 4 | 1 | | Glcβ(1- | Rhaα(1- | Steviol |
| | | | | | | 2)Glcβ1- | 2)[Glcβ1- | |
| | | | | | | | 3)]Glcβ1- | |
| | Reb K2 | 1112 | 4 | 1 | | Glcβ(1- | Rhaα(1- | Steviol |
| | | | | | | 6)Glcβ1- | 2)[Glcβ1- | |
| | | | | | | | 3)]Glcβ1- | |
| | SG-Unk4 | 1112 | 4 | 1 | | — | — | Steviol |
| | SG-Unk5 | 1112 | 4 | 1 | | — | — | Steviol |
| SG-4G1X | Reb U2 | 1098 | 4 | | 1 | Xylβ(1- | Glcβ(1-2)Glcβ1- | Steviol |
| | | | | | | 2)[Glcβ1- | | |
| | | | | | | 3)]Glcβ1- | | |
| | Reb T | 1098 | 4 | | 1 | Xylβ(1- | Glcβ(1- | Steviol |
| | | | | | | 2)Glcβ1- | 2)[Glcβ1- | |
| | | | | | | | 3)]Glcβ1- | |
| | Reb W | 1098 | 4 | | 1 | Glcβ(1- | Glcβ(1-2)Glcβ1- | Steviol |
| | | | | | | 2)[Araβ(1- | | |
| | | | | | | 3)]Glcβ1- | | |
| | Reb W2 | 1098 | 4 | | 1 | Araβ(1- | Glcβ(1- | Steviol |
| | | | | | | 2)Glcβ1- | 2)[Glcβ1- | |
| | | | | | | | 3)]Glcβ1- | |
| | Reb W3 | 1098 | 4 | | 1 | Araβ(1- | Glcβ(1- | Steviol |
| | | | | | | 6)Glcβ1- | 2)[Glcβ1- | |
| | | | | | | | 3)]Glcβ1- | |
| | Reb U | 1098 | 4 | | 1 | Araα(1-2)- | Glcβ(1- | Steviol |
| | | | | | | Glcβ1- | 2)[Glcβ1- | |
| | | | | | | | 3)]Glcβ1- | |
| SG-5G | Reb D | 1128 | 5 | | | Glcβ(1- | Glcβ(1- | Steviol |
| | | | | | | 2)Glcβ1- | 2)[Glcβ1- | |
| | | | | | | | 3)]Glcβ1- | |
| | Reb I | 1128 | 5 | | | Glcβ(1- | Glcβ(1- | Steviol |
| | | | | | | 3)Glcβ1- | 2)[Glcβ1- | |
| | | | | | | | 3)]Glcβ1- | |
| | Reb L | 1128 | 5 | | | Glcβ1- | Glcβ(1- | Steviol |
| | | | | | | | 6)Glcβ(1- | |
| | | | | | | | 2)[Glcβ1- | |
| | | | | | | | 3)]Glcβ1- | |
| | Reb I3 | 1128 | 5 | | | [Glcβ(1 2)Glcβ1- | Glβ(1-2)Glcβ1- | Steviol |
| | | | | | | 6)]Glcβ1- | | |
| | SG-Unk6 | 1128 | 5 | | | — | — | Steviol |
| | Reb Q | 1128 | 5 | | | Glcβ1- | Glcα(1- | Steviol |
| | (SG-5) | | | | | | 4)Glcβ(1- | |
| | | | | | | | 2)[Glcβ1- | |
| | | | | | | | 3)]Glcβ1- | |
| | Reb I2 | 1128 | 5 | | | Glcβ1- | Glcα(1-3)Glcβ1- | Steviol |
| | (SG-6) | | | | | | 2[Glcβ1- | |
| | | | | | | | 3)]Glcβ1- | |
| | Reb Q2 | 1128 | 5 | | | Glcα(1- | Glcβ(1-2)Glcβ1- | Steviol |
| | | | | | | 2)Glcα(1- | | |
| | | | | | | 4)Glcβ1- | | |
| | Reb Q3 | 1128 | 5 | | | Glcβ1- | Glcα(1- | Steviol |
| | | | | | | | 4)Glcβ(1- | |
| | | | | | | | 3)[Glcβ(1- | |
| | | | | | | | 2)]Glcβ1- | |
| SG-5G1R | Reb N | 1274 | 5 | 1 | | Rhaα(1- | Glcβ(1- | Steviol |
| | | | | | | 2)[Glcβ1- | 2)[Glcβ(1- | |
| | | | | | | 3)]Glcβ1- | 3)]Glcβ1- | |
| SG-5G1X | Reb V2 | 1260 | 5 | | 1 | Xylβ(1- | Glcβ(1- | Steviol |
| | | | | | | 2)[Glcβ1-3)]- | 2)[Glcβ(1- | |
| | | | | | | Glcβ1- | 3)]Glcβ1- | |
| | Reb V | 1260 | 5 | | 1 | Glcβ(1- | Xylβ(1- | Steviol |
| | | | | | | 2)[Glcβ(1- | 2)[Glcβ1-3)]- | |
| | | | | | | 3)]Glcβ1- | Glcβ1- | |
| | Reb Y | 1260 | 5 | | 1 | Glcβ(1- | Glcβ(1- | Steviol |
| | | | | | | 2)[Araβ(1- | 2)[Glcβ1- | |
| | | | | | | 3)]Glcβ1- | 3)]Glcβ1- | |
| SG-6G | Reb M | 1290 | 6 | | | Glcβ(1- | Glcβ(1- | Steviol |
| | | | | | | 2)[Glcβ1- | 2)[Glcβ(1- | |
| | | | | | | 3)]Glcβ1- | 3)]Glcβ1- | |
| SG-6G1R | Reb O | 1436 | 6 | 1 | | Glcβ(1- | Glcβ(1- | Steviol |
| | | | | | | 3)Rhaα(1- | 2)[Glcβ(1- | |
| | | | | | | 2)[Glcβ(1- | 3)]Glcβ1- | |
| | | | | | | 3)]Glcβ1- | | |
| | Reb O2 | 1436 | 6 | 1 | | Glcβ(1- | Glcβ(1- | Steviol |
| | | | | | | 4)Rhaα(1- | 2)[Glcβ(1- | |
| | | | | | | 2)[Glcβ(1- | 3)]Glcβ1- | |
| | | | | | | 3)]Glcβ1- | | |
| SG-Rel | Related | 458 | — | | | | | Steviol |
| | SvGn#1 | | | | | | | |
| SG-Rel | Related | 982 | — | | | | | Steviol |
| | SvGn#2 | | | | | | | |
| SG-Rel | Related | 676 | — | | | | | Steviol |
| | SvGn#3 | | | | | | | |
| SG-Rel | Related | 1128 | — | | | | | Steviol |
| | SvGn#4 | | | | | | | |
| SG-Rel | Related | 982 | — | | | | | Steviol |
| | SvGn#5 | | | | | | | |
| — | Iso- | 642 | 2 | | | H- | Glcβ(1-2)Glcβ1- | Isosteviol |
| | Steviolbioside | | | | | | | |
| — | Iso-Reb B | 804 | 3 | | | H- | Glcβ(1- | Isosteviol |
| | | | | | | | 2)[Glcβ(1- | |
| | | | | | | | 3)]Glcβ1- | |
| — | Iso- | 804 | 3 | | | Glcβ1- | Glcβ(1-2)Glcβ1- | Isosteviol |
| | Stevioside | | | | | | | |
| — | Iso-Reb A | 966 | 4 | | | Glcβ1- | Glcβ(1- | Isosteviol |
| | | | | | | | 2)[Glcβ(1- | |
| | | | | | | | 3)]Glcβ1- | |
| — | SG-13 | 804 | 3 | | | Glcβ1- | Glcβ(1-2)Glcβ1- | Isomeric |
| | | | | | | | | steviol |
| | | | | | | | | (12α- |
| | | | | | | | | hydroxy) |
| — | 15α-OH | 1306 | 6 | | | Glcβ1- | Glcβ1-2(Glcβ1- | 15α- |
| | Reb M | | | | | 2(Glcβ1- | 3)Glcβ1- | Hydroxy- |
| | | | | | | 3)Glcβ1- | | steviol |

Steviol glycosides include a hydrophobic part (steviol) and a hydrophilic part (sugars, such as glucose). When steviol glycosides are dissolved in a suitable solvent, steviol glycosides can form solvate(s). It is assumed that steviol glycosides can form clusters similar with flavor molecules as they do for water and other solvents. Such structures can stabilize the flavor, especially volatile substances, either in an aqueous solution or in solid form. It has been found that three steviol glycosides share one water molecule in its crystal structure. Not to be limited by theory, it is believed that steviol glycosides share one or more flavor molecules which can stabilize the flavor molecule better than in the absence of the Stevia. In general, steviol glycosides improve the solubility of flavor substances. It is further believed that Stevia extracts and steviol glycosides have attractive forces to hold the flavor, protect the stability of flavor, and hereafter it is referred to as steviol glycoside flavorate (SGF). One embodiment includes a composition comprising a Stevia extract with a flavor.

Further, stevia glycosides themselves have limited solubility in water. The limited solubility creates inconvenience when using stevia glycosides in food and beverage industry. The inventor surprisingly found that combination of glycosylated monk fruit extract could significantly improve the solubility of stevia glycosides. An embodiment of a method to improve the solubility of stevia glycosides by combination of glycosylated monk fruit together, where stevia glycosides is one or more ingredients selected from RA, RB, RC, RD, RE, RM, RN and RO.

The term “glycosylated mogroside(s)” (GMG, GMGs), refers to a mogroside that is glycosylated at least at one or more positions in addition to those positions glycosylated in native form, obtained, for example, by synthetic manipulation or by enzymatic processes. It should be understood that GMG(s) essentially contains glycosylated mogroside(s), but also contains unreacted mogrosides, dextrin and other non-mogroside substances found in extracts. It should also be understood that the GMG(s) can be purified and/or separated into purified/isolated components.

The term “glycosylated mogroside”, or “glycosylated swingle extract containing a glycosylated mogroside” may also refer to compounds obtained by transglycosylating swingle extract containing mogrosides, or transglycosylating purified mogrosides so as to add glucose units, for example, one, two, three, four, five or more than five glucose units, to the native mogrosides by glycosyltransferase, preferably, CGTase enzyme (cyclodextringlycosyltransferase). Herein, the glycosylated mogroside(s), or the glycosylated swingle extract containing glycosylated mogroside(s), comprises short chain compounds obtained by hydrolyzation of glycosylated product and also comprises non-glycosylated ingredients which are the residue of non-reacted mogrosides, or unreacted components other than mogrosides contained in the swingle extract.

The term “glycosylated steviol glycoside(s)” (GSG, GSGs) as referred to herein, pertains to a steviol glycoside that is glycosylated at multiple positions (including partially glycosylated steviol glycosides) obtained, for example, by synthetic manipulation or by enzymatic processes, such as GSG-RA50. It should be understood that GSG(s) essentially contains a glycosylated steviol glycoside(s), but also contains unreacted steviol glycosides, dextrin and other non-steviol glycoside substances found in extracts. It should also be understood that the GSG(s) can be purified and/or separated into purified/isolated components.

The term “glycosylated steviol glycosides” (GSGs) also refers to compounds obtained by enzymatic processes, for example, by transglycosylating stevia extract containing steviol glycosides, or by common known synthetic manipulation. Herein, the GSGs comprise glycosylated stevia extract containing glycosylated steviol glycoside(s) and also comprises short chain compounds obtained by hydrolyzation of glycosylated product, as well as non-glycosylated components which are the residue of unreacted steviol glycosides, or unreacted components other than steviol glycosides contained in the stevia extract. The methods and GSGs found in KR10-2008-0085811 are herein incorporated by reference. As shown in Formula III, GSGs are comprised of steviol molecules glycosylated at the C13 and/or C19 position(s).

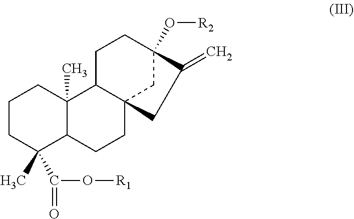

The term “GRU,” as used herein, refers to glycosylated rubusoside.

The abbreviation “YY-GX” is noted throughout the specification and refers to glycosyl groups “G” added to a molecule YY by a glycosylation reaction, where “X” is a value from 1 to 20 and refers to the number of glycosyl groups added to the molecule by the glycosylation reaction. For example, MG G1 (MG-G1) refers to a glycosylated MG having one (1) glycosyl unit added to a MG by glycosylation reaction, MG G2 (MG-G2) refers to a glycosylated MG having two (2) glycosyl units added to a MG by glycosylation reaction, etc. Similarly, mogrosides V G1 (MGV-G1) refers to a glycosylated MGV having one (1) glycosyl unit added to a MGV by glycosylation reaction, mogrosides V G2 (MGV-G2) refers to a glycosylated MGV having two (2) glycosyl units added to a MGV by glycosylation reaction, etc. The glycosylation of the molecule can be determined by HPLC-MS.

The phrases “MG compositions”, “GMG composition(s)”, “GSG compositions”, and “SG compositions” as used herein is intended to mean a combination of at least one MG, GMG, GSG and/or SG (or individual constituents thereof) with at least one other component, such as a MG, GMG, GSG, SG, and/or a sweetener for example. The phrase is also intended to include multiple GMGs, GSGs, MGs and/or multiple steviol glycosides (SGs). Further, the compositions can further include additional additives described throughout the specification.

The term “monk fruit extract” or “MFE” refers to an extract prepared from monk fruit. It should be understood that monk fruit extracts can contain, for example, a mogroside such as MGV, in an amount of 3% by weight, 20% by weight, 40% by weight, 50% by weight, 60% by weight or higher but containing other mogrosides or non-mogrosides in the extracts. For example, other components include other mogrosides such as MGIIe, MGIII, MGIIIe, MGIV MGIVa, MGIVe, IMGV, 7-OMGV, 11-OMGV, DMGV, MGVI, 11-OMGVI, MGA, NMG, MGE, SSI, GVRI, GVRII, GMSI and GMSII. In addition, some other polysaccharides or flavonoids may be present.

The term “Stevia extract” or “SE” refers to an extract prepared from Stevia plant or parts thereof (e.g., leaves of Stevia plant). Stevia extracts generally contain a high percentage of the steviol glycosides (SGs). For example, the leaves of Stevia rebaudiana contain over 10 different SGs, such as steviol, stevioside, steviolbioside, rebaudioside A (RA), rebaudioside B (RB), rebaudioside C (RC), rebaudioside D (RD), rebaudioside E (RE), rebaudioside F (RF), rebaudioside M (RM), rebaudioside O (RO), rebaudioside H (RH), rebaudioside I (RI), rebaudioside L (RL), rebaudioside N (RN), rebaudioside K (RK), rebaudioside J (RJ), rubusoside (RU) and dulcoside A (DA).

The term “sweet tea extract” or “STE” refers to an extract prepared from sweet tea plant (Rubus suavissimus) or parts thereof. Sweet tea extract generally contain SGs such as rubusoside (RU) and other components such as suaviosides.

The acronym “YYxx” are used herein to denote the purity of a given ingredient denoted by the placeholder “YY”, as a mass percentage of a compound, where “xx” is a number between 01 and 99 (or higher) and is the percentage of product YY in the product. For instance, a composition that contains about 50% (w/w) mogroside V would be denoted mogroside V 50 or MGV50 would be denoted MGV50. Similarly, a composition that contains about 90% (w/w) rubusoside would be denoted RU90. A composition that contains 95% (w/w) steviol glycosides (“SG”) would be denoted as “SG95.” As used herein, the acronym “YYxx” allows for a 5% margin of error. For example, a composition designated MGV 50 would contain 45%-55% (w/w) of MGV.

As used herein, the acronym “RAx” refers to a Stevia composition containing RA in amount of ≥x % and <(x+10)% with the following exceptions: the acronym “RA100” specifically refers to pure RA; the acronym “RA99.5” specifically refers to a composition where the amount of RA is ≥99.5 wt %, but <100 wt %; the acronym “RA99” specifically refers to a composition where the amount of RA is ≥99 wt %, but <100 wt %; the acronym “RA98” specifically refers to a composition where the amount of RA is ≥98 wt %, but <99 wt %; the acronym “RA97” specifically refers to a composition where the amount of RA is ≥97 wt %, but <98 wt %; the acronym “RA95” specifically refers to a composition where the amount of RA is ≥95 wt %, but <97 wt %; the acronym “RA85” specifically refers to a composition where the amount of RA is ≥85 wt %, but <90 wt %; the acronym “RA75” specifically refers to a composition where the amount of RA is ≥75 wt %, but <80 wt %; the acronym “RA65” specifically refers to a composition where the amount of RA is ≥65 wt %, but <70 wt %; the acronym “RA20” specifically refers to a composition where the amount of RA is ≥15 wt %, but <30 wt %. Stevia extracts include, but are not limited to, including, but are not limited to RA20, RA40, RA50, RA60, RA80, RA 90, RA95, RA97, RA98, RA99, RA99.5, RB8, RB10, RB15, RC15, RD6, and combinations thereof.

The acronym “YYxx+WWzz” refers to a composition, where each one of “YY” and “WW” refers to a given compound (such as MGV, RU, RA, etc.) or collection of compounds (e.g., MGs, SGs), and where each of “xx” and “zz” refers to a percent by weight number between 1 and 100 denoting the level of purity of a given compound (such as MGV, Ru, RA, etc.) or collection of compounds, where the weight percentage of YY in the dried product is equal to or greater than xx, and where the weight percentage of WW in the dried product is equal to or greater than zz.

The acronym “GSG-RAxx” refers to a GSG composition prepared in an enzymatically catalyzed glycosylation process with RAxx as the starting SG material. More generally, acronyms of the type “GSG-YYxx” refer to a composition of the present application where YY refers to a compound (such as RA, RB, RC or RD), or a composition (e.g., RA20), or a mixture of compositions (e.g., RA40+RB8). For example, GSG-RA20 refers to the glycosylation products formed from RA20.

The term “sweetener(s)” is intended to include materials (other than the MGs, SGs, GMGs and GSGs described herein) that impart sweetness to a composition, such as cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin (a sweet tasting protein), erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, sodium cyclamate, and mixtures thereof.

Other sweet tasting proteins besides thaumatin that are sweeteners, or also referred to as sweetener enhancers, include for example, brazzein, miraculin, curculin, pentadin, mabinlin, etc.

The term “dextrin” refers to a linear low-molecular weight water-soluble glucose polymer which is produced by the hydrolysis of starch that can serve as a sugar donor in a glycosylation reaction. Dextrins are mixtures of polymers of D-glucose units linked primarily by α-(1-4) glycosidic bonds and to a lesser extent α-(1-6) glycosidic bonds. Dextrins are typically produced by enzymatic hydrolysis of starch or application of heat under acid conditions, resulting in a mixture of polyglucose molecules of different chain lengths. “Maltodextrins” are the product of the dextrinization of starch using enzymes coupled with acid hydrolysis or heating; “pyrodextrins” are the product of dextrinization of starch using heat and acid. As used herein, the term “dextrin” includes maltodextrins, pyrodextrins and water-soluble glucose polymers having 3 or more glucose units. Dextrins can be obtained from various natural products, such as wheat, rice, maize and tapioca.

In other aspects the compositions further include one or more salts, such as sodium carbonate, sodium bicarbonate, sodium chloride, potassium chloride, magnesium chloride, sodium sulfate, magnesium sulfate, and potassium sulfate, or any edible salt. The compositions can also further include cyclodextrin.

The phrase “sucrose equivalence” or “SugarE” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted, diet soft drinks must have the same sweetness as a 12% sucrose soft drink, i.e., a diet soft drink must have a 12% SuE. Soft drink dispensing equipment assumes an SuE of 12%, since such equipment is set up for use with sucrose-based syrups.

The phrase “taste profile” is defined as the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness”. A plurality of such human tasters is called a “sensory panel”. In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The term “mouthfeel” involves the physical and chemical interaction of a consumable in the mouth. Herein, specifically, the term “mouthfeel” refers to the fullness sensation experienced in the mouth, which relates to the body and texture of the consumable such as its viscosity.

The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness”. A plurality of such human tasters is called a “sensory panel”. In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The phrase “sweetness detection threshold” refers to the minimum concentration at which panelists consisting of 8 persons are able to detect sweetness in a composition, liquid or solid. This is further defined as provided in the Examples herein.

Threshold of sweetness refers to a concentration of a material that below a concentration where sweetness can be detected may still impart a flavor to the consumable (including water). When half of a trained panel of testers determines something is “sweet” at a given concentration, then the sample meets the threshold. When less than half of a panel of testers cannot discern sweetness at a given concentration, then concentrations of the substance below the sweetness level are considered a flavoring.

The term “flavor” or “flavor characteristic”, as used herein, is the combined sensory perception of the components of taste, odor, and/or texture. The term “enhance”, as used herein, includes augmenting, intensifying, accentuating, magnifying, and potentiating the sensory perception of a flavor characteristic without changing the nature or quality thereof. The term “modify”, as used herein, includes altering, varying, suppressing, depressing, fortifying and supplementing the sensory perception of a flavor characteristic where the quality or duration of such characteristic was deficient.

In certain aspects, a sweet tasting protein is also referred to as a sweetener enhancer.

It should be understood that throughout this specification, when reference is made to a specific sweetening agent, such as an SG, a GSG, an MG, or a GMG and the like, that the example is meant to be inclusive and applicable to sweet tea extracts, stevia extracts, swingle extracts (mogroside extract), single components or mixtures of mogroside(s) (“MGs”), steviol glycosides (“SGs”), sweet tea glycosides, glycosylated mogrosides (“GMGs”), glycosylated steviol glycosides (“GSGs”) and glycosylated sweet tea glycosides.

It should be noted that the percentages provided herein include compositions of combinations of sweetening agents disclosed herein, including low molecular weight SG having a molecular weight of less than or equal to 965 daltons, more particularly a molecular weight less than or equal to 787, sweet tea extracts (STE), sweet tea components (STC), such as rubusoside and suaviosides, glycosylated sweet tea extracts, SG's, GSG's, MG's, GMG's, and mixtures thereof are part of the composition. The weight ratio of low molecular weight SGs, having a molecular weight of less than or equal to 965, more particularly a molecular weight of less than or equal to 787, to other components can range from 100:0.1 to 0.1:100 and all values there between. That is, for example, where a non-low molecular weight SG comprises 90% by weight of the composition, up to 10% by weight of the composition can be a low molecular weight SG, e.g., 90:10 or 9:1. Another example would be where 99% of the composition is a non-low molecular weight SG and 1% by weight would be a low molecular weight SG, having a molecular weight less than or equal to 965, 787, etc., e.g., 99:1, for use in producing sweetening agent compositions.

It should be noted that rubusoside (RU) in whole specification could be obtained either from sweet tea extract, or by conversion of stevioside originated from stevia leaves.

Alternative salts include various chloride or sulfate salts, such as sodium chloride, potassium chloride, magnesium chloride, sodium sulfate, magnesium sulfate, and potassium sulfate, or any edible salt. In some embodiments, the one or more salts comprise one or more SG, MG, GSG, or GMG salts. Additionally, the low molecular weight SG having a molecular weight of less than or equal 965, more particularly a molecular weight less than or equal to 787, can also be in salt form.

Thus the compositions herein are included as suitable sweetener compositions. It should be understood that the singular notations also include plural forms of the abbreviations, e.g., MG includes MGs, GMG includes GMGs, etc.

### Sweetening or Flavoring Composition Comprising Glycosylated Mogrosides (GMGs)

One aspect of the present application relates to a sweetening or flavoring composition comprising glycosylated mogrosides (GMGs). In some embodiments, the GMGs are obtained by synthetic manipulation or by enzymatic processes. The GMGs obtained by these methods are not naturally occurring mogrosides. In some embodiments, the GMGs include glycosylated product of MGIIe, MGIII, MGIIIe, MGIV MGIVa, MGIVe, MGV, IMGV, 7-OMGV, 11-OMGV, DMGV, MGVI, 11-OMGVI, MGA, NMG, MGE, SSI, GVRI and/or GVRII.

The inventor surprisingly found that GMGs could significantly improve the taste of high intensity sweeteners, such as stevia extract, stevia glycosides, monk fruit extract and mogrosides. GMGs with higher degree of glycosylation showed better taste improving effect than GMGs with lower degree of glycosylation. Glycosylation of mogrosides (MGs) or monk fruit extract (MFE), could also reduce the amount of bitter substances in the extract such as other flavonoid glycosides.

### Amount of GMGs in the Sweetening or Flavoring Composition of the Present Application

In some embodiments, the sweetening or flavoring composition of the present application comprises GMGs in an amount of 1% wt/wt, 2% wt/wt, 3% wt/wt, 4% wt/wt, 5% wt/wt, 6% wt/wt, 7% wt/wt, 8% wt/wt, 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt, 99% wt/wt, or 100% wt/wt.

In some embodiments, the sweetening or flavoring composition of the present application comprises GMGs in all ranges between 1 and 100% wt/wt, for example from about 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, and from about 10% wt/wt to about 20% wt/wt, of the composition.

### Amount of the Glycosylated Components in the GMGs of the Present Application

In some embodiments, the GMGs include mono-glucose mogrosides (MG-G1), bi-glucose mogrosides (MG-G2), tri-glucose mogrosides (MG-G3), tetra-glucose mogrosides (MG-G4), penta-glucose mogrosides (MG-G5) and mogrosides with higher levels of glycosylation (e.g., MG-G6, MG-G7, MG-G8, MG-G9, etc.)

MG-G1 may include, but are not limited to, MGV-G1, MGIIe-G1, MGIII-G1, MGIIIe-G1, MGIV-G1, MGVIa-G1, MGIVe-G1 and/or MGVI-G1.

MG-G2 may include, but are not limited to, MGV-G2, MGIIe-G2, MGIII-G2, MGIIIe-G2, MGIV-G2, MGVIa-G2, MGIVe-G2 and/or MGVI-G2.

MG-G3 may include, but are not limited to, MGV-G3, MGIIe-G3, MGIII-G3, MGIIIe-G3, MGIV-G3, MGVIa-G3, MGIVe-G3 and/or MGVI-G3.

MG-G4 may include, but are not limited to, MGV-G4, MGIIe-G4, MGIII-G4, MGIIIe-G4, MGIV-G4, MGVIa-G4, MGIVe-G4 and/or MGVI-G4.

MG-G5 may include, but are not limited to, MGV-G5, MGIIe-G5, MGIII-G5, MGIIIe-G5, MGIV-G5, MGVIa-G5, MGIVe-G5 and/or MGVI-G5.

Mogrosides with higher levels of glycosylation may include, but are not limited to, MGV, MGIIe, MGIII, MGIIIe, MGIV, MGVIa, MGIVe and/or MGVI with higher level of glycosylation.

In some embodiments, the GMGs of the present application comprise at least 1% wt/wt, 10% wt/wt, 15% wt/wt, 20% wt/wt, 25% wt/wt, 30% wt/wt, 35% wt/wt, 40% wt/wt, 45% wt/wt, 50% wt/wt, 55% wt/wt, 60% wt/wt, 65% wt/wt, 70% wt/wt, 75% wt/wt or 80% wt/wt MG-G1.

In some embodiments, the GMGs of the present application comprise at least 1% wt/wt, 10% wt/wt, 15% wt/wt, 20% wt/wt, 25% wt/wt, 30% wt/wt, 35% wt/wt, 40% wt/wt, 45% wt/wt, 50% wt/wt, 55% wt/wt, 60% wt/wt, 65% wt/wt, 70% wt/wt, 75% wt/wt or 80% wt/wt MG-G2.

In some embodiments, the GMGs of the present application comprise at least 0.1% wt/wt, 1% wt/wt, 10% wt/wt, 15% wt/wt, 20% wt/wt, 25% wt/wt, 30% wt/wt, 35% wt/wt, 40% wt/wt, 45% wt/wt, 50% wt/wt, 55% wt/wt, 60% wt/wt, 65% wt/wt, 70% wt/wt, 75% wt/wt or 80% wt/wt MG-G3.

In some embodiments, the GMGs of the present application comprise at least 0.10% wt/wt, 10% wt/wt, 10% wt/wt, 15% wt/wt, 20% wt/wt, 25% wt/wt, 30% wt/wt, 35% wt/wt, 40% wt/wt, 45% wt/wt, 50% wt/wt, 55% wt/wt, 60% wt/wt, 65% wt/wt, 70% wt/wt, 75% wt/wt or 80% wt/wt MG-G4.

In some embodiments, the GMGs of the present application comprise at least 0.1% wt/wt, 1% wt/wt, 10% wt/wt, 15% wt/wt, 20% wt/wt, 25% wt/wt, 30% wt/wt, 35% wt/wt, 40% wt/wt, 45% wt/wt, 50% wt/wt, 55% wt/wt, 60% wt/wt, 65% wt/wt, 70% wt/wt, 75% wt/wt or 80% wt/wt MG-G5.

In some embodiments, the GMGs of the present application comprise at least 0.01% wt/wt, 0.1% wt/wt, 1% wt/wt, 10% wt/wt, 15% wt/wt, 20% wt/wt, 25% wt/wt, 30% wt/wt, 35% wt/wt, 40% wt/wt, 45% wt/wt, 50% wt/wt, 55% wt/wt, 60% wt/wt, 65% wt/wt, 70% wt/wt, 75% wt/wt or 80% wt/wt MG-G6, MG-G7, MG-G8 and/or MG-G9.

In some embodiments, the GMGs of the present application comprises one or more glycosylated MGVs selected from MGV-G1, MGV-G2, MGV-G3, MGV-G4, MGV-G5 and MGV with higher level of glycosylation (e.g., MGV-G6, MGV-G7, MGV-G8, MGV-G9, etc,) in an amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises one or more glycosylated MGVs selected from MGV-G1, MGV-G2, MGV-G3, MGV-G4, MGV-G5 and MGV with higher level of glycosylation (e.g., MGV-G6, MGV-G7, MGV-G8, MGV-G9, etc,) in an amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGV-G1, MGV-G2, MGV-G3, MGV-G4 and/or MGV-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGV-G1, MGV-G2, MGV-G3, MGV-G4 or MGV-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGIIe-G1, MGIIe-G2, MGIIe-G3, MGIIe-G4 or MGIIe-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGIIe-G1, MIIe-G2, MIIe-G3, MGIIe-G4 or MGIIe-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGIII-G1, MGIII-G2, MGIII-G3, MGII-G4 or MGIII-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGIII-G1, MGIII-G2, MGIII-G3, MGIII-G4 and/or MGIII-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGIIIe-G1, MGIIIe-G2, MGIIIe-G3, MGIIIe-G4 and/or MGIIIe-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGIIIe-G1, MGIIIe-G2, MGIIe-G3, MGIIIe-G4 and/or MGIIe-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGIV-G1, MGIV-G2, MGIV-G3, MGIV-G4 and/or MGIV-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGIV-G1, MGIV-G2, MGIV-G3, MGIV-G4 and/or MGIV-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGIVe-G1, MGIVe-G2, MGIVe-G3, MGIVe-G4 and/or MGIVe-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGIVe-G1, MGIVe-G2, MGIVe-G3, MGIVe-G4 and/or MGIVe-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs of the present application comprises GMGs having a MGVI-G1, MGVI-G2, MGVI-G3, MGVI-G4 and/or MGVI-G5 content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the GMGs of the present application comprises GMGs having a MGVI-G1, MGVI-G2, MGVI-G3, MGVI-G4 and/or MGVI-G5 content of of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the GMGs comprise GMGs with molecular weight greater than 1447 Dalton (large MW GMGs), wherein the amount of large MW GMGs is in the range of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the total GMGs.

In some embodiments, the GMGs comprise large MW GMGs, wherein the large MW GMGs comprise MGV-G1, MGV-G2, MGV-G3, MGV-G4, MGV-G5 and/or MGVs with higher level of glycosylation in an amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the large MW GMGs.

In some embodiments, the GMGs comprise large MW GMGs, wherein the large MW GMGs comprise MGV-G1, MGV-G2, MGV-G3, MGV-G4, MGV-G5 and/or MGVs with higher level of glycosylation in an amount of of 0.1-99 wt %, 0.1-95 wt %, 0.1-90 wt %, 0.1-80 wt %, 0.1-70 wt %, 0.1-60 wt %, 0.1-50 wt %, 0.1-40 wt %, 0.1-30 wt %, 0.1-20 wt %, 0.1-10 wt %, 0.1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the large MW GMGs.

In some embodiments, the GMGs comprise glycosylated simenoside content of at least 0.1%, at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the GMGs or any range defined by any pair of these integers.

In some embodiments, the GMGs comprise glycosylated 11-O-Mongroside V in an amount of at least 0.1%, at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the GMGs, or any range defined by any pair of these integers.

### Amount of the Un-Glycosylated (Un-Reacted) Mogrosides (MGs) in the GMGs of the Present Application

In some embodiments, unreacted MGs are present in the GMGs of the present application, but are present in an mounts of less than 1 ppb, less than 1 ppm, less than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the GSGs, or any range defined by any pair of these integers.

In some embodiments, one or more of unreacted MGV, MGIIe, MGIII, MGIIIe, MGIV, MGIVe, MGVI, SSI and/or 11-OMGV are present in the GMGs of the present application, but are present in an mounts of less than 1 ppb, less than 1 ppm, least than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the GSGs, or any range defined by any pair of these integers.

In some embodiments, one or more of unreacted MGs are present in the sweetening or flavoring composition of the present application, but are present in an mounts of less than 1 ppb, less than 1 ppm, less than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the sweetening or flavoring composition, or any range defined by any pair of these integers.

In some embodiments, one or more of unreacted MGV, MGIIe, MGIII, MGIIIe, MGIV, MGIVe, MGVI, SSI and/or 11-OMGV are present in the sweetening or flavoring composition of the present application, but are present in an mounts of less than 1 ppb, less than 1 ppm, less than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the sweetening or flavoring composition, or any range defined by any pair of these integers.

In some embodiments, the sweetener or flavoring composition of the present application comprises unreacted MGs and GMGs with a MGs-to-GMGs ratio of 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween wherein the ratios are from 1:99 and vice versa, e.g., a ratio of from 1:99 to 50:50, from 30:70 to 42:58, etc.

In some embodiments, the sweetener or flavoring composition comprises GMGs and no detectable mogroside IIe content, wherein the GMGs are present in an amount that is greater than zero but less than 1 ppm, less than 100 ppm, less than 1000 ppm, less than 0.01 wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the sweetener or flavoring composition, or any range defined by any pair of these integers.

In some embodiments, the sweetener or flavoring composition comprises GMGs and unreacted simenoside, wherein the unreacted simenoside is present in an amount that is greater than zero but is less than 1 ppm, less than 100 ppm, less than 1,000 ppm, less than 0.1 wt %, less than 1 wt %, less than 2 wt %, less than t 5 wt %, less than 10 wt %, less than 15 wt %, less than 20 wt % of the composition, or any range defined by any pair of these integers.

In some embodiments, the sweetener or flavoring composition comprises GMGs and unreacted mogroside V, wherein the unreacted mogroside V is present in an amount that is greater than zero but is less than 1 ppm, less than 100 ppm, less than 1000 ppm, less than 0.01% wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the composition, or any range defined by any pair of these integers.

In some embodiments, a sweetener or flavoring composition comprises GMGs and unreacted mogrosides, wherein the unreacted mogrosides are present in a total amount of greater than zero but less than 1 ppm, less than 100 ppm, less than 1000 ppm, less than 0.01 wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the composition, or any range defined by any pair of these integers.

### Amount of the Un-Reacted Dextrin/Maltodextrin in the GMGs of the Present Application

In some embodiments, unreacted dextrin are present in the GMGs of the present application, but are present in an mounts of less than 1 ppb, less than 1 ppm, least than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, of the GMGs, or any range defined by any pair of these integer.

In some embodiments, unreacted maltodextrin are present in the GMGs of the present application, but are present in an mounts of less than 1 ppb, less than 1 ppm, least than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, of the GMGs, or any range defined by any pair of these integer.

In some embodiments, unreacted dextrin are present in the sweetening or flavoring composition of the present application, but are present in an mounts of less than 1 ppb, less than 1 ppm, least than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, of the sweetening or flavoring composition, or any range defined by any pair of these integer.

In some embodiments, unreacted maltodextrin are present in the sweetening or flavoring composition of the present application, but are present in an mounts of less than 1 ppb, less than 1 ppm, least than 100 ppm, less than 1000 ppm, less than 0.01%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, of the sweetening or flavoring composition, or any range defined by any pair of these integer.

### Amount of SG, STC, GSG and GSTC in the Sweetening or Flavoring Composition of the Present Application

In some embodiments, the sweetening or flavoring composition of the present application further comprises one or more steviol glycosides (SGs), one or more sweet tes components (STCs), one or more glycosylated steviol glycosides (GSGs) and/or one or more glycosylated sweet tes components (GSTSc). The SGs may include one or more steviol glycosides not obtained from Stevia plant, such as rubusoside (RU). Similarly, the GSGs may include GRU.

In some embodiments, the sweetening or flavoring composition of the present application comprises one or more GMGs and one or more SGs.

In some embodiments, the sweetening or flavoring composition of the present application comprises one or more GMGs and one or more GSGs.

In some embodiments, the sweetening or flavoring composition of the present application comprises one or more GMGs and one or more stevia glycosides selected from RA, RB, RE, RD and RM.

In some embodiments, the sweetening or flavoring composition of the present application comprises (1) one or more GMGs and (2) RD and/or GRD.

In some embodiments, the sweetening or flavoring composition of the present application comprises (1) one or more GMGs and (2) RM or GRM.

In some embodiments, the sweetening or flavoring composition of the present application comprises one or more GMGs and (2) rubusoside (RU) or GRU.

and wherein the glycosylated stevia glycosides comprise one or more of glycosylated products originated from rubusoside, Reb B, steviolbioside, steviolmonoside.

In some embodiments, the sweetening or flavoring composition comprises (1) a GMG or a glycosylated swingle extract, and (2) a glycosylated stevia extract or a glycosylated stevia glycosides.

In some embodiments, the sweetening or flavoring composition comprises (1) a GMG or a glycosylated swingle extract, (2) a glycosylated stevia extract or a glycosylated stevia glycosides, and (3) a stevia extract or a stevia glycoside.

In some embodiments, the sweetening or flavoring composition comprises (1) a GMG or a glycosylated swingle extract, (2) a glycosylated stevia extract or a glycosylated stevia glycosides, and (3) one or more stevia glycosides selected from the group consisting of RA, RB, RE, RD and RM.

In some embodiments, the sweetening or flavoring composition comprises iso-mogrosides, such as iso-mogroside V, and glycosylated stevia extract comprising glycosylated rubusoside.

In some embodiments, the sweetening or flavoring composition comprises iso-mogrosides, such as iso-mogroside V, and a stevia extract comprising one or more stevia glycosides selected from the group consisting of RA, RB, RE, RD and RM.

In some embodiments, the sweetening or flavoring composition of the present invention comprises GMGs and one or more MGs. The MGs of the compositions can make up 1% wt/wt, 2% wt/wt, 3% wt/wt, 4% wt/wt, 5% wt/wt, 6% wt/wt, 7% wt/wt, 8% wt/wt, 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt, 99% wt/wt, or 100% wt/wt and all ranges between 1 and 100% wt/wt, for example from about 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, and from about 10% wt/wt to about 20% wt/wt, of the sweetening or flavoring composition.

In some embodiments, the sweetening or flavoring composition of present application comprises a) one or more of glycosylated monk fruit extract, glycosylated mogrosides; b) unreacted morgorsides and non-morgorsides; c) unreacted dextrins.

In some embodiments, the sweetening or flavoring composition of the present application comprises one or more non-MG sweeteners. The non-MG sweeteners of the compositions can make up 1% wt/wt, 2% wt/wt, 3% wt/wt, 4% wt/wt, 5% wt/wt, 6% wt/wt, 7% wt/wt, 8% wt/wt, 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt, 99% wt/wt, or 100% wt/wt and all ranges between 1 and 100% wt/wt, for example from about 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, and from about 10% wt/wt to about 20% wt/wt, of the sweetening or flavoring composition.

In some embodiments, the sweetening or flavoring composition of the present application comprises (1) GMGs and/or MGs in amounts describes above, and (2) one or more glycosylated steviol glycosides (GSGs). GSGs can be obtained for example, by synthetic manipulation or by enzymatic processes. The GSGs obtained by these methods are not naturally occurring steviol glycosides. The methods and GSGs found in KR10-2008-0085811 are herein incorporated by reference. Examples of GSGs include, but are not limited to, Stevioside G1 (ST-G1), Stevioside G2 (ST-G2), Stevioside G3 (ST-G3), Stevioside G4 (ST-G4), Stevioside G5 (ST-G5), Stevioside G6 (ST-G6), Stevioside G7 (ST-G7), Stevioside G8 (ST-G8), Stevioside G9 (ST-G9), Rebaudioside A G1 (RA-G1), Rebaudioside A G2 (RA-G2), Rebaudioside A G3 (RA-G3), Rebaudioside A G4 (RA-G4), Rebaudioside A G5 (RA-G5), Rebaudioside A G6 (RA-G6), Rebaudioside A G7 (RA-G7), Rebaudioside A G8 (RA-G8), Rebaudioside A G9 (RA-G9), Rebaudioside B G1 (RB-G1), Rebaudioside B G2 (RB-G2), Rebaudioside B G3 (RB-G3), Rebaudioside B G4 (RB-G4), Rebaudioside B G5 (RB-G5), Rebaudioside B G6 (RB-G6), Rebaudioside B G7 (RB-G7), Rebaudioside B G8 (RB-G8), Rebaudioside B G9 (RB-G9), Rebaudioside C G1 (RC-G1), Rebaudioside C G2 (RC-G2), Rebaudioside C G3 (RC-G3), Rebaudioside C G4 (RC-G4), Rebaudioside C G5 (RC-G5), Rebaudioside C G6 (RC-G6), Rebaudioside C G7 (RC-G7), Rebaudioside C G8 (RC-G8), Rebaudioside C G9 (RC-G9), Steviol G1, Steviol G2 Steviol G3, Steviol G4, Steviol G5, Steviol G6, Steviol G7, Steviol G8, Steviol G9, Rebaudioside D G1, Rebaudioside D G2, Rebaudioside D G3, Rebaudioside D G4, Rebaudioside D G5, Rebaudioside D G6, Rebaudioside D G7, Rebaudioside D G8, Rebaudioside D G9, Rebaudioside E G1, Rebaudioside E G2, Rebaudioside E G3, Rebaudioside E G4, Rebaudioside E G5, Rebaudioside E G6, Rebaudioside E G7, Rebaudioside E G8, Rebaudioside E G9, Rebaudioside F G1, Rebaudioside F G2, Rebaudioside F G3, Rebaudioside F G4, Rebaudioside F G5, Rebaudioside F G6, Rebaudioside F G7, Rebaudioside F G8, Rebaudioside F G9, Rebaudioside M G1, Rebaudioside M G2, Rebaudioside M G3, Rebaudioside E G4, Rebaudioside M G5, Rebaudioside M G6, Rebaudioside M G7, Rebaudioside M G8, Rebaudioside M G9, Rubusoside G1, Rubusoside G2, Rubusoside G3, Rubusoside G4, Rubusoside G5, Rubusoside G6, Rubusoside G7, Rubusoside G8, Rubusoside G9, Dulcoside A G1, Dulcoside A G2, Dulcoside A G3, Dulcoside A G4, Dulcoside A G5, Dulcoside A G6, Dulcoside A G7, Dulcoside A G8, Dulcoside A G9, GSG-RA20, GSG-RA30, GSG-RA40, GSG-RA50, GSG-RA60, GSG-RA70, GSG-RA80, GSG-RA90, GSG-RA95, GSG-RA97, GSG-(RA50+RB8), GSG-(RA30+RC15), and GSG-(RA40+RB8).

In some embodiments, the sweetening or flavoring composition of the present application comprises (1) a GMG and (2) a combination of GSG-RA20, GSG-RA30, GSG-RA40, GSG-RA50, GSG-RA60, GSG-RA70, GSG-RA80, GSG-RA90, GSG-RA95, GSG-RA97, GSG-(RA50+RB8), GSG-(RA30+RC15), or GSG-(RA40+RB8) and a steviol glycosides, such as RA, RB, RD, etc. GSG-RA20 is typically prepared from RA20 as a key starting material, GSG-RA30 is typically prepared from RA30 as a key starting material, GSG-RA40 is typically prepared from RA40 as a key starting material, GSG-RA50 is typically prepared from RA50 as a key starting material, GSG-RA60 is typically prepared from RA60 as a key starting material, GSG-RA70 is typically prepared from RA70 as a key starting material, GSG-RA80 is prepared from RA80 as the key starting material, GSG-RA90 is typically prepared from RA90 as a key starting material, GSG-RA95 is typically prepared from RA95 as a key starting material, and GSG-RA97 is prepared from RA97 as a key starting material. Since each composition contains varying concentrations of GSGs and steviol glycosides, then each composition may have different solubility and taste properties.

In some embodiments, the sweetening or flavoring composition of the present application comprises a GMG and one or more GSGs, such as any one or more of GSG-RA20, GSG-RA30, GSG-RA40, GSG-RA50, GSG-RA60, GSG-RA70, GSG-RA80, GSG-RA90, GSG-RA95, GSG-RA97, GSG-(RA50+RB8), GSG-(RA30+RC15), and GSG-(RA40+RB8), wherein the one or more GSGs are present in an amount of 1% wt/wt, 2% wt/wt, 3% wt/wt, 4% wt/wt, 5% wt/wt, 6% wt/wt, 7% wt/wt, 8% wt/wt. 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt, 99% wt/wt, or 100% wt/wt and all ranges between 1 and 100% wt/wt, for example less than about 70 percentage by weight, less than about 50 percentage by weight, from about 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, from about 10% wt/wt to about 20% wt/wt, from about 20 to less than about 50% by weight, from about 30 to less than about 50% by weight, from about 40 to less than about 50% by weight, and from about 20 to 45% by weight of the sweetening or flavoring composition.

In some embodiments, the sweetening or flavoring composition of the present application comprises (1) one or more GMGs and/or MGs, and (2) one or more steviol glycosides (SG's). Examples of SGs include, but are not limited to, steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, and dulcoside A. The steviol glycosides of the compositions can make up 1% wt/wt, 2% wt/wt, 3% wt/wt, 4% wt/wt, 5% wt/wt, 6% wt/wt, 7% wt/wt, 8% wt/wt, 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt, 99% wt/wt, or 100% wt/wt and all ranges between 1 and 100% wt/wt, for example from about 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, and from about 10% wt/wt to about 20% wt/wt of the sweetening or flavoring composition.

In some embodiments, the sweetening or flavoring composition of the present application comprises (1) one or more GMGs and/or MGs, and (2) one or more sweet tea components (STCs) and/or glycosylated STCs (GSTCs). Examples of STCs include, but are not limited to, rubusoside and suaviosides. The STCs and/or GSTCs of the compositions can make up 1% wt/wt, 2% wt/wt, 3% wt/wt, 4% wt/wt, 5% wt/wt, 6% wt/wt, 7% wt/wt, 8% wt/wt, 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt, 99% wt/wt, or 100% wt/wt and all ranges between 1 and 100% wt/wt, for example from about 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, and from about 10% wt/wt to about 20% wt/wt, of the sweetening or flavoring composition.

In some embodiments, the sweetener or flavoring composition of the present application comprises (A) one or more components selected from the group comprising glycosylated stevia glycosides, glycosylated stevia extract or glycosylated sweet tea extract, glycosylated rubuosides, glycosylated steviosides, glycosylated steviobiosides, glycosylated steviomonosides, glycosylated dulcoside A, and glycosylated RB, and (B) GMGs in a A:B ratio of 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween wherein the ratios are from 1:99 and vice versa, e.g., a ratio of from 1:99 to 50:50, from 30:70 to 42:58, etc.

### Combination of GMGs and GRUs

In some embodiments, the sweetener or flavoring composition of the present application comprises a combination of GMGs and GRUs with a GMGs-to-GRUs weight ratio in the range of 99:1 to 1:99, wherein the GMGs comprise MGV-G1, MGV-G2, MGV-G3, MGV-G4, MGV-G5 and/or MGV with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGV-G1, MGV-G2, MGV-G3, MGV-G4, MGV-G5 and/or MGV with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and GRUs with a GMGs-to-GRUs weight ratio in the range of 99:1 to 1:99, wherein the GMGs comprise MGIIe-G1, MGIIe-G2, MGIIe-G3, MGIIe-G4, MGIIe-G5 and/or MGIIe with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGIIe-G1, MIIe-G2, MGIIe-G3, MGIIe-G4, MIIe-G5 and/or MGIIe with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and GRUs with a GMGs-to-GRUs weight ratio in the range of 99:1 to 1:99, wherein the GMGs comprise MGIII-G1, MGIII-G2, MGIII-G3, MGIII-G4, MGIII-G5 and/or MGIII with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGIII-G1, MIII-G2, MGIII-G3, MGIII-G4, MIII-G5 and/or MGIII with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and GRUs with a GMGs-to-GRUs weight ratio in the range of 99:1 to 1:99, wherein the GMGs comprise MGIIIe-G1, MGIIIe-G2, MGIIIe-G3, MGIIIe-G4, MGIIIe-G5 and/or MGIIIe with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGIIIe-G1, MIIIe-G2, MGIIIe-G3, MGIIIe-G4, MIIIe-G5 and/or MGIIIe with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and GRUs with a GMGs-to-GRUs weight ratio in the range of 99:1 to 1:99, wherein the GMGs comprise MGIV-G1, MGIV-G2, MGIV-G3, MGIV-G4, MGIV-G5 and/or MGIV with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGIV-G1, MIV-G2, MGIV-G3, MGIV-G4, MGIV-G5 and/or MGIV with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and GRUs with a GMGs-to-GRUs weight ratio in the range of 99:1 to 1:99, wherein the GMGs comprise MGIVe-G1, MGIVe-G2, MGIVe-G3, MGIVe-G4, MGIVe-G5 and/or MGIVe with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGIVe-G1, MIVe-G2, MGIVe-G3, MGIVe-G4, MGIVe-G5 and/or MGIVe with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and GRUs with a GMGs-to-GRUs weight ratio in the range of 99:1 to 1:99, wherein the GMGs comprise MGVI-G1, MGVI-G2, MGVI-G3, MGVI-G4, MGVI-G5 and/or MGVI with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and GRUs with a GMGs-to-GRUs weight ratio in the range of 99:1 to 1:99, wherein the GMGs comprise MGVI-G1, MVI-G2, MGVI-G3, MGVI-G4, MGVI-G5 and/or MGVI with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, a sweetener or flavoring composition comprises a combination of GMGs and GRUs with a GMGs-to-GRUs weight ratio in the range of 99:1 to 1:99, wherein the GMGs comprise simenoside in an amount that is greater than zero but less than 1 ppm, less than 100 ppm, less than 1000 ppm, less than 0.01 wt %, less than 0.1 wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the GMGs, or any range defined by any pair of these integers.

In some embodiments, a sweetener or flavoring composition comprises a combination of GMGs and GRUs with a GMGs-to-GRUs weight ratio in the range of 99:1 to 1:99, wherein the GMGs comprise glycosylated simenoside in an amount of least 0.1 wt %, at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the GMGs, or any range defined by any pair of these integers.

In some embodiments, the sweetener or flavoring composition comprises a combination of GMGs and GRUs with a GMGs-to-GRUs weight ratio in the range of 99:1 to 1:99, wherein the GMGs comprise 11-O-Mogroside V in an amount of greater than zero but less than 1 ppm, less than 100 ppm, less than 1000 ppm, less than 0.01% wt %, less than 0.1 wt %, less than 0.5%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt %, or any range defined by any pair of these integers.

In some embodiments, the sweetener or flavoring composition comprises a combination of GMGs and GRUs with a GMGs-to-GRUs weight ratio in the range of 99:1 to 1:99, wherein the GMGs comprises glycosylated 11-O-Mongroside V in an amount of at least 0.1 wt %, at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the GMG, or any range defined by any pair of these integers.

In some embodiments, the sweetener or flavoring composition comprises (1) a combination of GMGs and GRUs with a GMGs-to-GRUs weight ratio in the range of 99:1 to 1:99, and (2) one or more non-GRU GSGs.

In some embodiments, the sweetener or flavoring composition comprises (1) a combination of GMGs and GRUs with a GMGs-to-GRUs weight ratio in the range of 99:1 to 1:99, (2) one or more non-GRU GSGs and (3) one or more SGs selected from the group consisting of rubusoside, RB, RD, RM, steviolbioside and steviolmonoside.

In some embodiments, the sweetener or flavoring composition comprises (1) a combination of GMGs and GRUs with a GMGs-to-GRUs weight ratio in the range of 99:1 to 1:99, (2) one or more non-GRU GSGs and (3) one or more SGs with a molecular weight of, or below, 965 dalton.

In all the above embodiments, the combination of GMGs and GRUs may has a GMGs-to-GRUs weight ratio of 99:1 to 30:1, 99:1 to 10:1, 99:1 to 3:1, 99:1 to 1:1, 99:1 to 1:3, 99:1 to 1:10; 99:1 to 1:30, 30:1 to 10:1, 30:1 to 3:1, 30:1 to 1:1, 30:1 to 1:3, 30:1 to 1:10; 30:1 to 1:30, 30:1 to 1:99, 10:1 to 3:1, 10:1 to 1:1, 10:1 to 1:3, 10:1 to 1:10; 10:1 to 1:30, 10:1 to 1:99, 3:1 to 1:1, 3:1 to 1:3, 3:1 to 1:10; 3:1 to 1:30, 3:1 to 1:99, 1:1 to 1:3, 1:1 to 1:10; 1:1 to 1:30, 1:1 to 1:99, 1:3 to 1:10; 1:3 to 1:30, 1:3 to 1:99, 1:10 to 1:30, 1:10 to 1:99 or 1:30 to 1:99.

Combinations of GMGs with RD and/or RM

In some embodiments, the sweetener or flavoring composition of the present application comprises a combination of GMGs and RD, a combination of GMGs and RM, or a combination of GMGs and RD and RM. These combinations are collectively referred to as “a combination of GMGs and RD/RM”.

In some embodiments, the sweetener or flavoring composition of the present application comprises a combination of GMGs and RD/RM with a GMGs-to-RD/RM weight ratio in the range of 99:1 to 1:99, wherein the GMGs comprise MGV-G1, MGV-G2, MGV-G3, MGV-G4, MGV-G5 and/or MGV with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGV-G1, MGV-G2, MGV-G3, MGV-G4, MGV-G5 and/or MGV with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIIe-G1, MGIIe-G2, MGIIe-G3, MGIIe-G4, MGIIe-G5 and/or MGIIe with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIIe-G1, MIIe-G2, MGIIe-G3, MGIIe-G4, MIIe-G5 and/or MGIIe with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIII-G1, MGIII-G2, MGIII-G3, MGIII-G4, MGIII-G5 and/or MGIII with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIII-G1, MIII-G2, MGII-G3, MGIII-G4, MIII-G5 and/or MGIII with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIIIe-G1, MGIIIe-G2, MGIIIe-G3, MGIIIe-G4, MGIIIe-G5 and/or MGIIIe with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIIIe-G1, MIIIe-G2, MGIIIe-G3, MGIIIe-G4, MIIIe-G5 and/or MGIIe with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIV-G1, MGIV-G2, MGIV-G3, MGIV-G4, MGIV-G5 and/or MGIV with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIV-G1, MIV-G2, MGIV-G3, MGIV-G4, MGIV-G5 and/or MGIV with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIVe-G1, MGIVe-G2, MGIVe-G3, MGIVe-G4, MGIVe-G5 and/or MGIVe with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGIVe-G1, MIVe-G2, MGIVe-G3, MGIVe-G4, MGIVe-G5 and/or MGIVe with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition of the present application comprises a combination of GMGs and RD/RM with a GMGs-to-RD/RM weight ratio in the range of 99:1 to 1:99, wherein the GMGs comprise MGVI-G1, MGVI-G2, MGVI-G3, MGVI-G4, MGVI-G5 and/or MGVI with higher levels of glycosylation in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the GMGs.

In some embodiments, the sweetener or flavoring composition of the present application comprises a combination of GMGs and RD/RM with a GMGs-to-RD/RM weight ratio in the range of 99:1 to 1:99, wherein the GMGs comprise MGVI-G1, MVI-G2, MGVI-G3, MGVI-G4, MGVI-G5 and/or MGVI with higher levels of glycosylation in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, a sweetener or flavoring composition comprises a combination of GMGs and RD/RM with a GMGs-to-RD/RM weight ratio in the range of 99:1 to 1:99, wherein the GMGs comprise simenoside in an amount that is greater than zero but less than 1 ppm, less than 100 ppm, less than 1000 ppm, less than 0.01 wt %, less than 0.1 wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the GMGs, or any range defined by any pair of these integers.

In some embodiments, a sweetener or flavoring composition comprises a combination of GMGs and RD/RM with a GMGs-to-RD/RM weight ratio in the range of 99:1 to 1:99, wherein the GMGs comprise glycosylated simenoside in an amount of least 0.1 wt %, at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the GMGs, or any range defined by any pair of these integers.

In some embodiments, the sweetener or flavoring composition comprises a combination of GMGs and RD/RM with a GMGs-to-RD/RM weight ratio in the range of 99:1 to 1:99, wherein the GMGs comprise 11-O-Mogroside V in an amount of greater than zero but less than 1 ppm, less than 100 ppm, less than 1000 ppm, less than 0.01% wt %, less than 0.1 wt %, less than 0.5%, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt %, or any range defined by any pair of these integers.

In some embodiments, the sweetener or flavoring composition comprises a combination of GMGs and RD/RM with a GMGs-to-RD/RM weight ratio in the range of 99:1 to 1:99, wherein the GMGs comprises glycosylated 11-O-Mongroside V in an amount of at least 0.1 wt %, at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the GMG, or any range defined by any pair of these integers.

In some embodiments, the sweetener or flavoring composition comprises (1) a combination of GMGs and RD/RM with a GMGs-to-RD/RM weight ratio in the range of 99:1 to 1:99, and (2) one or more non-GRU GSGs.

In some embodiments, the sweetener or flavoring composition comprises a combination of GMGs and RD/RM, wherein the composition has unreacted Mogroside V content of less than 1 ppm, less than 100 ppm, less than 1000 ppm, less than 0.01 wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the sweetener or flavoring composition, or any range defined by any pair of these integers.

In some embodiments, the sweetener or flavoring composition comprises a combination of GMGs and RD/RM, wherein the composition has total unreacted mogrosides content of less than 1 ppm, less than 100 ppm, less than 1000 ppm, less than 0.01 wt %, less than 1 wt %, less than 2 wt %, less than 5 wt %, less than 10 wt %, less than 15 wt %, less than 20 wt %, less than 25 wt %, less than 30 wt %, less than 35 wt %, less than 40 wt %, less than 45 wt %, less than 50 wt %, less than 55 wt %, less than 60 wt %, less than 65 wt %, less than 70 wt %, less than 75 wt %, less than 80 wt %, less than 85 wt %, less than 90 wt %, less than 95 wt %, less than 99 wt % of the sweetener or flavoring composition, or any range defined by any pair of these integers.

In all the above embodiments, the combination of GMGs and RD/RM may has a GMGs-to-RD/RM weight ratio of 99:1 to 30:1, 99:1 to 10:1, 99:1 to 3:1, 99:1 to 1:1, 99:1 to 1:3, 99:1 to 1:10; 99:1 to 1:30, 30:1 to 10:1, 30:1 to 3:1, 30:1 to 1:1, 30:1 to 1:3, 30:1 to 1:10; 30:1 to 1:30, 30:1 to 1:99, 10:1 to 3:1, 10:1 to 1:1, 10:1 to 1:3, 10:1 to 1:10; 10:1 to 1:30, 10:1 to 1:99, 3:1 to 1:1, 3:1 to 1:3, 3:1 to 1:10; 3:1 to 1:30, 3:1 to 1:99, 1:1 to 1:3, 1:1 to 1:10; 1:1 to 1:30, 1:1 to 1:99, 1:3 to 1:10; 1:3 to 1:30, 1:3 to 1:99, 1:10 to 1:30, 1:10 to 1:99 or 1:30 to 1:99.

In all the above embodiments, the combination of GMGs and RD/RM may has a GMGs-to-RD weight ratio of 99:1 to 30:1, 99:1 to 10:1, 99:1 to 3:1, 99:1 to 1:1, 99:1 to 1:3, 99:1 to 1:10; 99:1 to 1:30, 30:1 to 10:1, 30:1 to 3:1, 30:1 to 1:1, 30:1 to 1:3, 30:1 to 1:10; 30:1 to 1:30, 30:1 to 1:99, 10:1 to 3:1, 10:1 to 1:1, 10:1 to 1:3, 10:1 to 1:10; 10:1 to 1:30, 10:1 to 1:99, 3:1 to 1:1, 3:1 to 1:3, 3:1 to 1:10; 3:1 to 1:30, 3:1 to 1:99, 1:1 to 1:3, 1:1 to 1:10; 1:1 to 1:30, 1:1 to 1:99, 1:3 to 1:10; 1:3 to 1:30, 1:3 to 1:99, 1:10 to 1:30, 1:10 to 1:99 or 1:30 to 1:99.

In all the above embodiments, the combination of GMGs and RD/RM may has a GMGs-to-RM weight ratio of 99:1 to 30:1, 99:1 to 10:1, 99:1 to 3:1, 99:1 to 1:1, 99:1 to 1:3, 99:1 to 1:10; 99:1 to 1:30, 30:1 to 10:1, 30:1 to 3:1, 30:1 to 1:1, 30:1 to 1:3, 30:1 to 1:10; 30:1 to 1:30, 30:1 to 1:99, 10:1 to 3:1, 10:1 to 1:1, 10:1 to 1:3, 10:1 to 1:10; 10:1 to 1:30, 10:1 to 1:99, 3:1 to 1:1, 3:1 to 1:3, 3:1 to 1:10; 3:1 to 1:30, 3:1 to 1:99, 1:1 to 1:3, 1:1 to 1:10; 1:1 to 1:30, 1:1 to 1:99, 1:3 to 1:10; 1:3 to 1:30, 1:3 to 1:99, 1:10 to 1:30, 1:10 to 1:99 or 1:30 to 1:99.

In all the above embodiments, the combination of GMGs and RD/RM may has a GMGs-to-RD+RM weight ratio of 99:1 to 30:1, 99:1 to 10:1, 99:1 to 3:1, 99:1 to 1:1, 99:1 to 1:3, 99:1 to 1:10; 99:1 to 1:30, 30:1 to 10:1, 30:1 to 3:1, 30:1 to 1:1, 30:1 to 1:3, 30:1 to 1:10; 30:1 to 1:30, 30:1 to 1:99, 10:1 to 3:1, 10:1 to 1:1, 10:1 to 1:3, 10:1 to 1:10; 10:1 to 1:30, 10:1 to 1:99, 3:1 to 1:1, 3:1 to 1:3, 3:1 to 1:10; 3:1 to 1:30, 3:1 to 1:99, 1:1 to 1:3, 1:1 to 1:10; 1:1 to 1:30, 1:1 to 1:99, 1:3 to 1:10; 1:3 to 1:30, 1:3 to 1:99, 1:10 to 1:30, 1:10 to 1:99 or 1:30 to 1:99.

### Additional Embodiments of the Composition of the Present Application

Various compositions can be prepared with the components discussed herein including MG(s), SG(s), STC, GSTC, GMG(s), GSG(s), and optionally, in combination a sweetener, such as sugar. Thus the following twenty embodiments are included as suitable compositions. It should be understood that the singular notations also include plural forms of the abbreviations, e.g., GMG includes GMGs.

(1) Mixtures of GMGs.

(2) A GMG in combination with a sweetener, e.g., sugar or a sweet tasting protein.

(3) A GMG in combination with a GSG.

(4) A GMG in combination with an SG.

(5) A GMG in combination with an MG.

(6) A GMG, a GSG and a sweetener, e.g., sugar or a sweet tasting protein.

(7) A GMG, an SG and a sweetener, e.g., sugar or a sweet tasting protein.

(8) A GMG, an MG and a sweetener, e.g., sugar or a sweet tasting protein.

(9) A GMG, a GSG and an SG.

(10) A GMG, a GSG and an MG.

(11) A GMG, an SG and an MG.

(12) A GMG, a GSG, an SG and an MG.

(13) A GMG, a GSG an SG and a sweetener, e.g., sugar or a sweet tasting protein.

(14) A GMG, a GSG, an MG and a sweetener, e.g., sugar or a sweet tasting protein.

(15) A GMG, a GSG an SG, an MG and a sweetener, e.g., sugar or a sweet tasting protein.

(16) An MG, an SG, a GSG and a sweetener, e.g., sugar or a sweet tasting protein.

(17) An MG and a GSG.

(18) An MG, a GSG and an SG.

(19) An MG, a GSG and a sweetener, e.g., sugar or a sweet tasting protein.

(20) An MG, a GSG, an SG and a sweetener, e.g., sugar or a sweet tasting protein.

In some embodiments, the sweetening or flavoring composition of the present application comprises the following combinations, wherein the abbreviation “LMWSG” refers to a low molecular weight SG having a molecular weight of equal to or less than 965, e.g., 949, 935, 803, 787, etc. and the abbreviation “HMWSG” refers to a high molecular weight SG having a molecular weight more than 965, such as RD, RM.

(1) A LMWSG in combination with a GMG.

(2) A LMWSG in combination with a GSG and a GMG.

(3) A HMWSG in combination with GMG;

(4) A HMWSG in combination with GSG and a GMG;

(5) A HMWSG in combination with GMG and rubusoside or Sweet Tea extract;

(6) A HMWSG in combination with GMG and glycosylated rubusoside or glycosylated sweet tea extract;

(7) A composition comprises a) one or more of RA, RB, RD, RE, RM and b) GMG, c) one or more of rubusoside, sweet tea extract, glycosylated rubusoside, glycosylated sweet tea extract.

The composition of any of paragraphs (1) through (2) above, wherein the percentage of each low molecular weight SG in the composition provides an improved taste profile compared to an untreated sweet tea extract, an SG extract, an MG extract, a GSG or an GMG composition.

The composition of any of paragraph (3) through (7) above, wherein the percentage of GMG, rubusoside, sweet tea extract, glycosylated rubuoside, glycosylated sweet tea extract in the composition provides an improved taste profile of stevia composition comprises one or more of RA, RB, RD, RM with less lingering, less bitterness, quicker onset.

In some embodiments, the sweetening or flavoring composition of the present application comprises (1) a GMG, (2) a GSG and/or SG, and (3) a non-SG, non-MG sweetener selected from the group consisting of siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, burned sugar from all sources, polypodoside A, pterocaryoside A, pterocaryoside B, mukurozioside, phlomisoside I, periandrin I, abrusoside A, cyclocarioside I, sugar alcohols, such as erythritol, sucralose, acesulfame acid and salts thereof, such as acesulfame-K and potassium acesulfame; L-.alpha.-aspartyl-L-phenylalanine methylester (Aspartame), N—[N-[3-(3-hydroxy-4-methoxyphenyl) propyl]-.alpha.-aspartyl]-L-phenylalanine (Advantame), N—[N-[3-(3-hydroxy-4-methoxyphenyl) propyl]-.alpha.-aspartyl]-L-phenylalanine 1-methyl ester (ANS9801), alitame, saccharin and salts thereof, neohesperidin dihydrochalcone, cyclamate, cyclamic acid and salts thereof, neotame, trehalose, raffinose, cellobiose, tagatose, DOLCIA PRIMA™, allulose, inulin, and combinations thereof.

The following paragraphs enumerated consecutively from 1 through 151 provide additional embodiments of the present invention. In one embodiment, in a first paragraph (1), the present invention provides:

1. A composition comprising a glycosylated mogroside or a glycosylated swingle extract and at least one non-mogroside based sweetener, a non-swingle based sweetener or a non-stevia based sweetener.

2. The composition according to paragraph 1, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin (a sweet tasting protein), brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

3. The composition of either of paragraph 1 or 2, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

4. The composition of paragraph 3, wherein the glycosylated mogroside or the glycosylated swingle extract comprises glycosylated mogroside V.

5. The composition of paragraph 4, wherein the glycosylated mogroside V is GMG-V20L, GMG-V20S, GMG-V40, or GMG-V60.

6. The composition of any of paragraphs 1 through 5, wherein the ratio of the glycosylated mogroside or the glycosylated swingle extract to the non-mogroside sweetener is from 200:1 to about 1:2000 on a weight basis.

7. A composition comprising a glycosylated mogroside or a glycosylated swingle extract and a glycosylated steviol glycoside or a glycosylated stevia extract.

8. The composition of paragraph 7, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

9. The composition of paragraph 8, wherein the glycosylated mogroside or the glycosylated swingle extract comprises a glycosylated mogroside V.

10. The composition of paragraph 9, wherein the glycosylated mogroside V is GMG-V20L, GMG-V20S, GMG-V40, or GMG-V60.

11. The composition of any of paragraphs 7 through 10, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

12. The composition of paragraph 11, wherein the glycosylated product is a glycosylated rebaudioside A, a glycosylated rebaudioside B, a glycosylated rebaudioside D or combinations thereof.

13. The composition of any of paragraphs 7 through 12, wherein the ratio of the glycosylated mogroside or the glycosylated swingle extract to the glycosylated steviol glycoside or glycosylated stevia extract is from 3:1 to about 1:3 on a weight basis.

14. A composition of a glycosylated mogroside or a glycosylated swingle extract and a steviol glycoside or a stevia extract.

15. The composition of paragraph 14, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

16. The composition of paragraph 15, wherein the glycosylated mogroside or the glycosylated swingle extract comprises a glycosylated mogroside V.

17. The composition of paragraph 16, wherein the glycosylated mogroside V is GMG-V20L, GMG-V20S, GMG-V40, or GMG-V60.

18. The composition of any of paragraphs 14 through 17, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

19. The composition of paragraph 18, wherein the steviol glycoside is rebaudioside A, rebaudioside B, rebaudioside D or mixtures thereof.

20. The composition of paragraph 19, wherein the rebaudioside A is RA98.

21. The composition of any of paragraphs 14 through 20, wherein the ratio of the glycosylated mogroside or the glycosylated swingle extract to the steviol glycoside or stevia extract is from 1:1 to about 1:6 on a weight basis.

22. A composition comprising a glycosylated mogroside or a glycosylated swingle extract and a mogroside or a swingle extract.

23. The composition of paragraph 22, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

24. The composition of paragraph 23, wherein the glycosylated mogroside or the glycosylated swingle extract comprises a glycosylated mogroside V.

25. The composition of paragraph 24, wherein the glycosylated mogroside V is GMG-V20L, GMG-V20S, GMG-V40, or GMG-V60.

26. The composition of any of paragraphs 22 through 25, wherein the mogroside or swingle extract comprises mogroside II, mogroside III, mogroside IV, mogroside V, siamenoside I or 11-oxomogroside V or any combination thereof.

27. A composition comprising a glycosylated mogroside or a glycosylated swingle extract, a glycosylated steviol glycoside or a glycosylated stevia extract and at least one non-mogroside based sweetener, a non-swingle based sweetener or a non-stevia based sweetener.

28. The composition of paragraph 27, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

29. The composition of either of paragraph 27 or 28, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

30. The composition of paragraph 29, wherein the glycosylated mogroside or the glycosylated swingle extract comprises glycosylated mogroside V.

31. The composition of paragraph 30, wherein the glycosylated mogroside V is GMG-V20L, GMG-V20S, GMG-V40, or GMG-V60.

32. The composition of any of paragraphs 27 through 31, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

33. The composition of paragraph 32, wherein the glycosylated product is a glycosylated rebaudioside A, a glycosylated rebaudioside B, a glycosylated rebaudioside D or combinations thereof.

34. A composition comprising a glycosylated mogroside or a glycosylated swingle extract, a steviol glycoside and at least one non-mogroside based sweetener, a non-swingle based sweetener or a non-stevia based sweetener.

35. The composition of paragraph 34, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

36. The composition of either of paragraph 34 or 35, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

37. The composition of paragraph 36, wherein the glycosylated mogroside or the glycosylated swingle extract comprises glycosylated mogroside V.

38. The composition of paragraph 37, wherein the glycosylated mogroside V is GMG-V20L, GMG-V20S, GMG-V40, or GMG-V60.

39. The composition of any of paragraphs 34 through 38, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

40. The composition of paragraph 39, wherein the steviol glycoside is rebaudioside A, rebaudioside B, rebaudioside D or mixtures thereof.

41. The composition of paragraph 40, wherein the rebaudioside A is RA98.

42. A composition comprising a glycosylated mogroside or a glycosylated swingle extract, a mogroside and at least one non-mogroside based sweetener, a non-swingle based sweetener or a non-stevia based sweetener.

43. The composition of paragraph 42, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

44. The composition of either of paragraph 42 or 43, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

45. The composition of paragraph 44, wherein the glycosylated mogroside or the glycosylated swingle extract comprises glycosylated mogroside V.

46. The composition of paragraph 45, wherein the glycosylated mogroside V is GMG-V20L, GMG-V20S, GMG-V40, or GMG-V60.

47. The composition of any of paragraphs 42 through 46, wherein the mogroside or swingle extract comprises mogroside II, mogroside III, mogroside IV, mogroside V, siamenoside I or 11-oxomogroside V or any combination thereof.

48. A composition comprising a glycosylated mogroside or a glycosylated swingle extract, a glycosylated steviol glycoside or a glycosylated stevia extract and a steviol glycoside.

49. The composition of paragraph 48, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

50. The composition of paragraph 49, wherein the glycosylated mogroside or the glycosylated swingle extract comprises glycosylated mogroside V.

51. The composition of paragraph 50, wherein the glycosylated mogroside V is GMG-V20L, GMG-V20S, GMG-V40, or GMG-V60.

52. The composition of any of paragraphs 48 through 51, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

53. The composition of paragraph 52, wherein the glycosylated product is a glycosylated rebaudioside A, a glycosylated rebaudioside B, a glycosylated rebaudioside D or combinations thereof.

54. The composition of any of paragraphs 48 through 54, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

55. The composition of paragraph 54, wherein the steviol glycoside is rebaudioside A, rebaudioside B, rebaudioside D or mixtures thereof.

56. The composition of paragraph 55, wherein the rebaudioside A is RA98.

57. A composition comprising a glycosylated mogroside or a glycosylated swingle extract, a glycosylated steviol glycoside or a glycosylated stevia extract and a mogroside.

58. The composition of paragraph 57, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

59. The composition of paragraph 58, wherein the glycosylated mogroside or the glycosylated swingle extract comprises glycosylated mogroside V.

60. The composition of paragraph 59, wherein the glycosylated mogroside V is GMG-V20L, GMG-V20S, GMG-V40, or GMG-V60.

61. The composition of any of paragraphs 57 through 60, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

62. The composition of paragraph 61, wherein the glycosylated product is a glycosylated rebaudioside A, a glycosylated rebaudioside B, a glycosylated rebaudioside D or combinations thereof.

63. The composition of any of paragraphs 57 through 62, wherein the mogroside or swingle extract comprises mogroside II, mogroside III, mogroside IV, mogroside V, siamenoside I or 11-oxomogroside V or any combination thereof.

64. A composition comprising a glycosylated mogroside or a glycosylated swingle extract, a steviol glycoside or a stevia extract and a mogroside or a swingle extract.

65. The composition of paragraph 64, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

66. The composition of paragraph 65, wherein the glycosylated mogroside or the glycosylated swingle extract comprises glycosylated mogroside V.

67. The composition of paragraph 66, wherein the glycosylated mogroside V is GMG-V20L, GMG-V20S, GMG-V40, or GMG-V60.

68. The composition of any of paragraphs 64 through 67, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

69. The composition of paragraph 68, wherein the steviol glycoside is rebaudioside A, rebaudioside B, rebaudioside D or mixtures thereof.

70. The composition of paragraph 69, wherein the rebaudioside A is RA98.

71. The composition of any of paragraphs 64 through 70, wherein the mogroside or swingle extract comprises mogroside II, mogroside III, mogroside IV, mogroside V, siamenoside I or 11-oxomogroside V or any combination thereof.

72. A composition comprising a glycosylated mogroside or a glycosylated swingle extract, a glycosylated steviol glycoside or a glycosylated stevia extract, a steviol glycoside or a stevia extract and a mogroside or a swingle extract.

73. The composition of paragraph 72, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

74. The composition of paragraph 73, wherein the glycosylated mogroside or the glycosylated swingle extract comprises glycosylated mogroside V.

75. The composition of paragraph 74, wherein the glycosylated mogroside V is GMG-V20L, GMG-V20S, GMG-V40, or GMG-V60.

76. The composition of any of paragraphs 72 through 75, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

77. The composition of paragraph 76, wherein the glycosylated product is a glycosylated rebaudioside A, a glycosylated rebaudioside B, a glycosylated rebaudioside D or combinations thereof.

78. The composition of any of paragraphs 72 through 77, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

79. The composition of paragraph 78, wherein the steviol glycoside is rebaudioside A, rebaudioside B, rebaudioside D or mixtures thereof.

80. The composition of paragraph 79, wherein the rebaudioside A is RA98.

81. The composition of any of paragraphs 72 through 80, wherein the mogroside or swingle extract comprises mogroside II, mogroside III, mogroside IV, mogroside V, siamenoside I or 11-oxomogroside V or any combination thereof.

82. A composition comprising a glycosylated mogroside or a glycosylated swingle extract, a glycosylated steviol glycoside or a glycosylated stevia extract, a steviol glycoside and at least one non-mogroside based sweetener, a non-swingle based sweetener or a non-stevia based sweetener.

83. The composition of paragraph 82, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

84. The composition of paragraph 83, wherein the glycosylated mogroside or the glycosylated swingle extract comprises glycosylated mogroside V.

85. The composition of paragraph 84, wherein the glycosylated mogroside V is GMG-V20L, GMG-V20S, GMG-V40, or GMG-V60.

86. The composition of any of paragraphs 82 through 85, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

87. The composition of paragraph 86, wherein the glycosylated product is a glycosylated rebaudioside A, a glycosylated rebaudioside B, a glycosylated rebaudioside D or combinations thereof.

88. The composition of any of paragraphs 82 through 87, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

89. The composition of paragraph 88, wherein the steviol glycoside is rebaudioside A, rebaudioside B, rebaudioside D or mixtures thereof.

90. The composition of paragraph 89, wherein the rebaudioside A is RA98.

91. The composition of any of paragraphs 82 through 80, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

92. A composition comprising a glycosylated mogroside or a glycosylated swingle extract, a glycosylated steviol glycoside or a glycosylated stevia extract, a mogroside or a swingle extract and at least one non-mogroside based sweetener, a non-swingle based sweetener or a non-stevia based sweetener.

93. The composition of paragraph 92, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

94. The composition of paragraph 93, wherein the glycosylated mogroside or the glycosylated swingle extract comprises glycosylated mogroside V.

95. The composition of paragraph 94, wherein the glycosylated mogroside V is GMG-V20L, GMG-V20S, GMG-V40, or GMG-V60.

96. The composition of any of paragraphs 92 through 95, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

97. The composition of paragraph 96, wherein the glycosylated product is a glycosylated rebaudioside A, a glycosylated rebaudioside B, a glycosylated rebaudioside D or combinations thereof.

98. The composition of any of paragraphs 92 through 97, wherein the mogroside or swingle extract comprises mogroside II, mogroside III, mogroside IV, mogroside V, siamenoside I or 11-oxomogroside V or any combination thereof.

99. The composition of any of paragraphs 92 through 98, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

100. A composition comprising a glycosylated mogroside or a glycosylated swingle extract, a glycosylated steviol glycoside or a glycosylated stevia extract, a steviol glycoside or a stevia extract, a mogroside or a swingle extract and a non-mogroside based sweetener, a non-swingle based sweetener or a non-stevia based sweetener.

101. The composition of paragraph 100, wherein the glycosylated mogroside or the glycosylated swingle extract comprises a glycosylated mogroside II, a glycosylated mogroside III, a glycosylated mogroside IV, a glycosylated mogroside V, a glycosylated siamenoside I or a glycosylated 11-oxomogroside V or any combination thereof.

102. The composition of paragraph 101, wherein the glycosylated mogroside or the glycosylated swingle extract comprises glycosylated mogroside V.

103. The composition of paragraph 102, wherein the glycosylated mogroside V is GMG-V20L, GMG-V20S, GMG-V40, or GMG-V60.

104. The composition of any of paragraphs 100 through 103, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

105. The composition of paragraph 104, wherein the glycosylated product is a glycosylated rebaudioside A, a glycosylated rebaudioside B, a glycosylated rebaudioside D or combinations thereof.

106. The composition of any of paragraphs 100 through 105, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

107. The composition of paragraph 106, wherein the steviol glycoside is rebaudioside A, rebaudioside B, rebaudioside D or mixtures thereof.

108. The composition of paragraph 107, wherein the rebaudioside A is RA98.

109. The composition of any of paragraphs 100 through 108, wherein the mogroside or swingle extract comprises mogroside II, mogroside III, mogroside IV, mogroside V, siamenoside I or 11-oxomogroside V or any combination thereof.

110. The composition of any of paragraphs 100 through 109, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

111. A composition comprising a mogroside or a swingle extract and a glycosylated steviol glycoside or a glycosylated stevia extract.

112. The composition of paragraph 111, wherein the mogroside or swingle extract comprises mogroside II, mogroside III, mogroside IV, mogroside V, siamenoside I or 11-oxomogroside V or any combination thereof.

113. The composition of either paragraphs 111 or 112, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

114. The composition of paragraph 113, wherein the glycosylated product is a glycosylated rebaudioside A, a glycosylated rebaudioside B, a glycosylated rebaudioside D or combinations thereof.

115. A composition comprising a mogroside or a swingle extract, a glycosylated steviol glycoside or a glycosylated stevia extract and a steviol glycoside or a stevia extract.

116. The composition of paragraph 116, wherein the mogroside or swingle extract comprises mogroside II, mogroside III, mogroside IV, mogroside V, siamenoside I or 11-oxomogroside V or any combination thereof.

117. The composition of either paragraphs 115 or 116, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

118. The composition of paragraph 117, wherein the glycosylated product is a glycosylated rebaudioside A, a glycosylated rebaudioside B, a glycosylated rebaudioside D or combinations thereof.

119. The composition of any of paragraphs 115 through 118, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

120. The composition of paragraph 119, wherein the steviol glycoside is rebaudioside A, rebaudioside B, rebaudioside D or mixtures thereof.

121. The composition of paragraph 120, wherein the rebaudioside A is RA98.

122. A composition comprising a mogroside or a swingle extract, a glycosylated steviol glycoside or a glycosylated stevia extract and at least one non-mogroside based sweetener, a non-swingle based sweetener or a non-stevia based sweetener.

123. The composition of paragraph 122, wherein the mogroside or swingle extract comprises mogroside II, mogroside III, mogroside IV, mogroside V, siamenoside I or 11-oxomogroside V or any combination thereof.

124. The composition of either paragraphs 122 or 123, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

125. The composition of paragraph 124, wherein the glycosylated product is a glycosylated rebaudioside A, a glycosylated rebaudioside B, a glycosylated rebaudioside D or combinations thereof.

126. The composition of any of paragraphs 122 through 125, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

127. A composition comprising a mogroside or a swingle extract, a glycosylated steviol glycoside or a glycosylated stevia extract, a steviol glycoside or a stevia extract and at least one non-mogroside based sweetener, a non-swingle based sweetener or a non-stevia based sweetener.

128. The composition of paragraph 127, wherein the mogroside or swingle extract comprises mogroside II, mogroside III, mogroside IV, mogroside V, siamenoside I or 11-oxomogroside V or any combination thereof.

129. The composition of either paragraphs 127 or 128, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

130. The composition of paragraph 129, wherein the glycosylated product is a glycosylated rebaudioside A, a glycosylated rebaudioside B, a glycosylated rebaudioside D or combinations thereof.

131. The composition of any of paragraphs 127 through 130, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

132. The composition of paragraph 131, wherein the steviol glycoside is rebaudioside A, rebaudioside B, rebaudioside D or mixtures thereof.

133. The composition of paragraph 132, wherein the rebaudioside A is RA98.

134. The composition of any of paragraphs 127 through 133, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

135. A composition comprising a glycosylated steviol glycoside or a glycosylated stevia extract, a steviol glycoside or a stevia extract, a mogroside and at least one non-mogroside based sweetener, a non-swingle based sweetener or a non-stevia based sweetener.

136. The composition of paragraph 135, wherein the glycosylated steviol glycoside or glycosylated stevia extract comprises one or more of the glycosylation products of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

137. The composition of any of paragraphs 135 or 136, wherein the steviol glycoside or stevia extract comprises one or more of steviol, stevioside, steviolbioside, rebaudioside A, rebaudioside B, rebaudioside C, rebaudioside D, rebaudioside E, rebaudioside F, rebaudioside M, rebaudioside O, rebaudioside H, rebaudioside I, rebaudioside L, rebaudioside N, rebaudioside K, rebaudioside J, rubusoside, dulcoside A and mixtures thereof.

138. The composition of paragraph 137, wherein the steviol glycoside is rebaudioside A, rebaudioside B, rebaudioside D or mixtures thereof.

139. The composition of paragraph 138, wherein the rebaudioside A is RA98.

140. The composition of any of paragraphs 135 through 139, wherein the non-mogroside based sweetener, the non-swingle based sweetener or the non-stevia based sweetener comprises one or more of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

141. The composition of paragraph 140, wherein the non-mogroside based sweetener is sucrose.

142. The composition of any of paragraphs 1 through 141, further comprising a sweetener enhancer.

143. The composition of paragraph 142, wherein the sweetener enhancer is one or more of thaumatin, brazzein, miraculin, curculin, pentadin, and/or mabinlin.

144. The composition of paragraph 143, wherein the sweetener enhancer is present in the composition at a range of about 0.5 ppm to about 10 ppm.

145. The composition of paragraph 144, further comprising sugar.

146. The composition of paragraph 155, wherein the sugar is present in the composition at a range of about 1 to about 10 weight percent.

147. The composition of any of paragraphs 1 through 146, further comprising a salt or cyclodextrin.

148. The composition of paragraph 147, wherein the salt comprises one or salts, comprising sodium carbonate, sodium bicarbonate, sodium chloride, potassium chloride, magnesium chloride, sodium sulfate, magnesium sulfate, potassium sulfate, or any edible salt.

149. The composition of any of paragraphs 1 through 146, wherein the composition taste characteristics is below the sweetness detection threshold and serves as a flavor.

150. The composition of any of paragraphs 1 through 146, wherein the composition taste characteristics is above the sweetness detection threshold and serves as a sweetener.

151. The composition of any of paragraphs 1 through 146, further comprising a consumable.

Additional embodiments include, but are not limited to the following paragraphs 1 through 20.

1. A sweetener or flavoring composition, comprising: (A) one or more glycosylated mogrosides (GMGs); and (B) one or more non-mogroside sweeteners.

2. The sweetener or flavoring composition composition of paragraph 1, wherein the one or more GMGs comprise a glycosylated mogroside IIe, a glycosylated mogroside III, a glycosylated mogroside IIIe, a glycosylated mogroside IV, a glycosylated mogroside IVe, a glycosylated mogroside V, a glycosylated mogroside VI, a glycosylated siamenoside I, a glycosylated 11-oxomogroside V, or any combination thereof.

3. The sweetener or flavoring composition of paragraph 2, wherein the the one or more GMGs comprises glycosylated mogroside V.

4. The sweetener or flavoring composition of paragraph 3, wherein the glycosylated mogroside V comprises MGV-G1, MGV-G2, MGV-G3, MGV-G4 and/or MGV-G5.

5. The sweetener or flavoring composition of any one of paragraphs 1-4, wherein the one or more non-mogroside sweeteners comprise steviol glycosides.

6. The sweetener or flavoring composition of any one of paragraphs 1-4, wherein the one or more non-mogroside sweeteners comprise RD, RM or both RD and RM.

7. The sweetener or flavoring composition of any one of paragraphs 1-4, wherein the one or more non-mogroside sweeteners comprise RU.

8. The sweetener or flavoring composition of any one of paragraphs 1-4, wherein the one or more non-mogroside sweeteners comprise glycosylated steviol glycosides (GSGs).

9. The sweetener or flavoring composition of any one of paragraphs 1-4, wherein the one or more non-mogroside sweeteners comprise glycosylated RU.

10. The sweetener or flavoring composition of any one of paragraphs 1-9, wherein the weight ratio of A:B is in the range of 99:1 to 1:99.

11. The sweetener or flavoring composition of any one of paragraphs 1-10, further comprising one or more un-reacted mogrosides.

12. The sweetener or flavoring composition of paragraph 11, wherein the one or more un-reacted mogrosides are present in a total amount of 0.001-20 wt % of the composition.

13. The sweetener or flavoring composition of any one of paragraphs 1-12, further comprising un-reacted dextrins.

14. The sweetener or flavoring composition of paragraph 13, wherein the un-reacted dextrins are present in a total amount of 0.001-30 wt % of the composition.

15. The sweetener or flavoring composition of any one of paragraphs 1-14, further comprising a sweetener selected from the group consisting of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

16. A method of improving the taste profile of a steviol glycoside composition, comprising: additing to the steviol glycoside composition, a sufficient amount of a glycosylated mogroside.

17. The method of paragraph 16, wherein the steviol glycoside composition comprises RU.

18. The method of paragraph 16, wherein the steviol glycoside composition comprises RD, RM or a combination thereof.

19. A method of improving the taste profile of a glycosylate steviol glycoside composition, comprising: additing to the glycosylated steviol glycoside composition, a sufficient amount of a glycosylated mogroside.

20. The method of paragraph 19, wherein the glycosylated steviol glycoside composition comprises glycosylated RU.

In some embodiments, the sweetener or flavoring composition of the present application comprises glycosylated mogroside or a glycosylated swingle extract, a glycosylated stevia extract or a glycosylated stevia glycosides, a stevia extract, or a stevia glycoside, where the glycosylated stevia extract contains glycosylated rubusoside and wherein the stevia glycosides have a molecular weight of, or below, 965 Dalton, and wherein the stevia glycosides comprise one or more of stevia rubusoside, RB, steviolbioside, steviolmonoside, and wherein the glycosylated stevia glycosides comprise one or more of glycosylated rubusoside, glycosylated RB, glycosylated steviolbioside, and glycosylated stevioside.

In some embodiments, a sweetener or flavoring composition of the present application comprises one or more component selected from a glycosylated mogroside or a glycosylated swingle extract, a glycosylated stevia extract or a glycosylated stevia glycosides, a stevia extract, or a stevia glycoside, where stevia extract comprises one or more stevia glycosides selected from RA, RB, RE, RD, RM and wherein the stevia glycosides have a molecular weight below 965 Dalton, and wherein the stevia glycosides comprise one or more of stevia rubusoside, RB, steviolbioside, steviolmonoside, and wherein the glycosylated stevia glycosides comprise one or more of glycosylated rubusoside, glycosylated RB, glycosylated steviolbioside, and glycosylated stevioside.

In some embodiments, the sweetening or flavoring composition of the present application comprises additives to enhance flavor characteristics. Examples of the flavor characteristics include, but are not limited to, sweet, fruity, floral, herbaceous, spicy, aromatic, pungent, “nut-like” (e.g., almond, pecan), “spicy” (e.g., cinnamon, clove, nutmeg, anise and wintergreen), “non-citrus fruit” flavor (e.g., strawberry, cherry, apple, grape, currant, tomato, gooseberry and blackberry), “citrus fruit” flavor (e.g., orange, lemon and grapefruit), and other useful flavors, including coffee, cocoa, peppermint, spearmint, vanilla and maple flavor.

Method of Extracting MGs from Monk Fruit

Monk Fruit contains cucubitane-type triterpenoid glycosides, such as mogroside IIe, mogroside III, mogroside IIIe, mogroside IV, mogroside IVe, mogroside V, 7-O-mogroside V, 11-O-mogroside V, mogroside VI, 11-O-mogroside VI, mogroside A, nemogroside, siamenoside I, mogroester, groavenorine I, grosvenorine II, grosmomoside I, grosmomoside II, 11-oxo-mogroside, and their isomers such as iso-mogroside V. In addition, Monk Fruit contains many precursors of mogroside V based on its core structure of mogrol. Among the precursors there are bitter substances, such as mogroside IIe, mogroside IIIe, and other triterpeonoid substances. Additional glycosylation of mogroside V could improve its taste quality, but the intensity of sweetness considerably diminished with the increase the number of glucose residue.

Sources of mogrosides and mogroside extracts include Momordica grosvenori. Other names include Momordica grosvenori fruit, Buddha fruit, Monordica fruit, luo han kuo, Siraitia grosvenorii, Grosvener Siraitia, arhat fruit, monk's fruit, luo han guo, longevity fruit, lohan kuo, luohanguo, la han qua (Vietnamese), rakanka (Japan). The juice or extract of the fruit includes mainly non-sugar natural sweeteners, the triterpenoid glycosides, which include mogroside V (esgoside), mogroside IV, and D-mannitol. The natural sweetness of them is 256-344, 126, and 0.55-0.65 times of that of sugar. The juice/extract contains large amounts of glucose, 14% fructose, proteins, vitamin C, and 26 inorganic elements such as manganese, iron, nickel, selenium, tin, iodine, molybdenum and others. The juice/extract also includes fatty acids, such as linoleic acid, oleic acid, palmitic acid, stearic acid, palmitic acid, myristic acid, lauric acid, and decanoic acid.

In the present application, a swingle extract or mogroside extract containing mogrosides is produced by the method of extracting the fruit of Siraitia grosvenorii (Swingle) with an alcohol, water, or a mixture of alcohol and water, to obtain a mixture of mogrosides. The mixture of mogrosides is then purified to provide desired mogrosides, such as mogroside V.

In some embodiments, a swingle extract containing mogrosides is produced by extraction of the fruit of Siraitia grosvenorii (Swingle) with an alcohol, a mixture of alcohol and water, or water. The swingle extract contains mogrosides (such as mogroside V) in an amount ranging from about 1 wt % to 99 wt %. In a preferred embodiment, the swingle extract contains about 3-90 wt % mogrosides. In another preferred embodiment, the swingle extract contains about 20-80 wt % mogrosides. In another preferred embodiment, the swingle extract contains about 30-70 wt % mogrosides. In another preferred embodiment, the swingle extract contains about 40-60 wt % mogrosides.

In some embodiments, Luo Han Guo fruit is extracted with water or a mixture of water/alcohol (ethanol or methanol) at a temperature of from about 40° C. to about 80° C. with the ratio of fruit to solvent being about 1:10 to about 1:20 (weight to volume). The liquid can be clarified by flocculation or membrane filtration followed by purification through a macroporous resin and ion exchange resin. Decloratizatioin can be accomplished with activated carbon. Solids are then filtered and dried.

Method of preparing GMGs

### (1) Glycosyltransferase

The glycosylated products described in the present application, such as GMGs, are formed by an exogenous glycosylation reaction in the present of a glycosyltransferase.

As used herein, a “glycosyltransferase” refers to an enzyme that catalyzes the formation of a glycosidic linkage to form a glycoside. A glycoside is any molecule in which a sugar group is bonded through its anomeric carbon to another group via a glycosidic bond. Glycosides can be linked by an O- (an O-glycoside), N- (a glycosylamine), S- (a thioglycoside), or C- (a C-glycoside) glycosidic bond. The sugar group is known as the glycone and the non-sugar group is known as the aglycone. The glycone can be part of a single sugar group (monosaccharide) or several sugar groups (oligosaccharide). A glycosyltransferase according to the present application further embraces “glycosyltransferase variants” engineered for enhanced activities.

Glycosyltransferases utilize “activated” sugar phosphates as glycosyl donors, and catalyze glycosyl group transfer to an acceptor molecule comprising a nucleophilic group, usually an alcohol. A retaining glycosyltransferases is one which transfers a sugar residue with the retention of anomeric configuration. Retaining glycosyltransferase enzymes retain the stereochemistry of the donor glycosidic linkage after transfer to an acceptor molecule. An inverting glycosyltransferase, on the other hand, is one which transfers a sugar residue with the inversion of anomeric configuration. Glycosyltransferases are classified based on amino acid sequence similarities. Glycosyltransferases are classified by the Nomenclature Committee of the International Union of Biochemistry and Molecular Biology (NC-IUBMB) in the enzyme class of EC 2.4.1 on the basis of the reaction catalyzed and the specificity.

Glycosyltransferases can utilize a range of donor substrates. Based on the type of donor sugar transferred, these enzymes are grouped into families based on sequence similarities. Exemplary glyosyltransferases include glucanotransferases, N-acetylglucosaminyltransferases, N-acetylgalactosaminyltransferases, fucosyltransferases, mannosyltransferases, galactosyltransferases, sialyltransferases sialyltransferases, galactosyltransferases, fucosyltransferase, Leloir glycosyltransferases, non-Leloir glycosyltransferases, and other glycosyltransferases in the enzyme class of EC 2.4.1. The Carbohydrate-Active Enzymes database (CAZy) provides a continuously updated list of the glycosyltransferase families.

In some embodiments, the glycosylation products described in the present application, such as GMGs, are formed from a reaction mixture comprising an exogenous glycosyltransferase classified as an EC 2.4.1 enzyme, including but not limited to members selected from the group consisting of cyclomaltodextrin glucanotransferase (CGTase; EC 2.4.1.19), amylosucrase (EC 2.4.1.4), dextransucrase (EC 2.4.1.5), amylomaltase, sucrose:sucrose fructosyltransferase (EC 2.4.1.99), 4-α-glucanotransferase (EC 2.4.1.25), lactose synthase (EC 2.4.1.22), sucrose-1,6-α-glucan 3(6)-α-glucosyltransferase, maltose synthase (EC 2.4.1.139), alternasucrase (EC 2.4.1.140), including variants thereof.

Cyclomaltodextrin glucanotransferase, also known as CGTase, is an enzyme assigned with enzyme classification number EC 2.4.1.19, which is capable of catalyzing the hydrolysis and formation of (1→4)-α-D-glucosidic bonds, and in particular the formation of cyclic maltodextrins from polysaccharides as well as the disproportionation of linear oligosaccharides.

Dextransucrase is an enzyme assigned with enzyme classification number EC 2.4.1.5, and is also known as sucrose 6-glucosyltransferase, SGE, CEP, sucrose-1,6-α-glucan glucosyltransferase or sucrose: 1,6-α-D-glucan 6-α-D-glucosyltransferase. Dextransucrases are capable of catalyzing the reaction: sucrose+[(1→6)-α-D-glucosyl]ₙ=D-fructose+[(1→6)-α-D-glucosyl]ₙ₊₁. In addition, a glucosyltransferase (DsrE) from Leuconostoc mesenteroides, NRRL B-1299 has a second catalytic domain (“CD2”) capable of adding alpha-1,2 branching to dextrans (U.S. Pat. Nos. 7,439,049 and 5,141,858; U.S. Patent Appl. Publ. No. 2009-0123448; Bozonnet et al., J. Bacteria 184:5753-5761, 2002).

Glycosyltransferases and other glycosylating enzymes for use in the present application may be derived from any source and may be used in a purified form, in an enriched concentrate or as a crude enzyme preparation.

In some embodiments, the glycosylation reaction is carried out by glycosylating an aglycone or glycoside substrate using e.g., a nucleotide sugar donor (e.g., sugar mono- or diphosphonucleotide) or “Leloir donor” in conjunction with a “Leloir glycosyltransferase” (after Nobel prize winner, Luis Leloir) that catalyzes the transfer of a monosaccharide unit from the nucleotide-sugar (“glycosyl donor’) to a “glycosyl acceptor”, typically a hydroxyl group in an aglycone or glycoside substrate.

Accordingly, in some embodiments the glycosylation product of the present application is formed from a reaction mixture comprising a nucleotide sugar.

In certain embodiments, the glycosylation reactions may involve the use of a specific Leloir glycosyltransferase in conjunction with a wide range of sugar nucleotides donors, including e.g., UDP-glucose, GDP-glucose, ADP-glucose, CDP-glucose, TDP-glucose or IDT-glucose in combination with a glucose-dependent glycosyltransferase (GDP-glycosyltransferases; GGTs), ADP-glucose-dependent glycosyltransferase (ADP-glycosyltransferases; AGTs), CDP-glucose-dependent glycosyltransferase (CDP-glycosyltransferases; CGTs), TDP-glucose-dependent glycosyltransferase (TDP-glycosyltransferases; TGTs) or IDP-glucose-dependent glycosyltransferase (IDP-glycosyltransferases; IGTs), respectively.

In particular embodiments, the exogenous glycosylation reaction is carried out using an exogenous Leloir-type UDP-glycosyltransferase enzyme of the classification EC 2.4.1.17, which catalyzes the transfer of glucose from UDP-α-D-glucuronate (also known as UDP-glucose) to an acceptor, releasing UDP and forming acceptor β-D-glucuronoside. In some embodiments, the glycosyltransferases include, but are not limited to, enzymes classified in the GT1 family. In certain preferred embodiment, the glycosylation reaction is catalyzed by an exogenous UDP-glucose-dependent glycosyltransferase. In some embodiments, the glycosylaton reaction is catalyzed by a glycosyltransferase capable of transferring a non-glucose nonosaccharide, such as fructose, galactose, ribose, arabinose, xylose, mannose, psicose, fucose and rhamnose, and derivative thereof, to the recipient.

U.S. Pat. No. 9,567,619 describes several UDP-dependent glycosyltransferases that can be used to transfer monosaccharides to rubusoside, including UGT76G1 UDP glycosyltransferase, HV1 UDP-glycosyltransferase, and EUGT11, a UDP glycosyltransferase-sucrose synthase fusion enzyme. The EUGT11 fusion enzyme contains a uridine diphospho glycosyltransferase domain coupled to a sucrose synthase domain and can exhibit 1,2-β glycosidic linkage and 1,6-β glycosidic linkage enzymatic activities, as well as sucrose synthase activity. Of the foregoing enzymes, UGT76G1 UDP glycosyltransferase contains a 1,3-O-glucose glycosylation activity which can transfer a second glucose moiety to the C-3′ of 13-O-glucose of rubusoside to produce rebaudioside G (“Reb G”); HV1 UDP-glycosyltransferase contains a 1,2-O-glucose glycosylation activity which can transfer a second glucoside moiety to the C-2′ of 19-O-glucose of rubusoside to produce rebaudioside KA (“Reb KA”); and the EUGT 11 fusion enzyme contains a 1,2-O-glucose glycosylation activity which transfers a second glucose moiety to the C-2′ of 19-O-glucose of rubusoside to produce rebaudioside KA or transfer a second glucose moiety to the C-2′ of 13-O-glucose of rubusoside to produce stevioside. In addition, HV1 and EUGT11 can transfer a second sugar moiety to the C-2′ of 19-O-glucose of rebaudioside G to produce rebaudioside V (“Reb V”) and can additionally transfer a second glucose moiety to the C-2′ of 13-O-glucose of rebaudioside KA to produce rebaudioside E (“Reb E”). Furthermore, when used singly or in combination, these enzymes can be used to generate a variety of steviol glycosides known to be present in Stevia rebaudiana, including rebaudioisde D (“Reb D”) and rebaudioside M (“Reb M”). The same technology could be used for generate variety of MGs and GMGs.

In some embodiments, monosaccharides that can be transferred to a saccharide or nonsaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid.

In some embodiments, glycosylation of RU and/or other STCs is driven by an exogenous glycosyl hydrolase or glycosidase from the enzyme class of EC 3.2.1. GHs normally cleave a glycosidic bond. However, they can be used to form glycosides by selecting conditions that favor synthesis via reverse hydrolysis. Reverse hydrolysis is frequently applied e.g., in the synthesis of aliphatic alkylmonoglucosides.

Glycosyl hydrolases have a wide range of donor substrates employing usually monosaccharides, oligosaccharides or/and engineered substrates (i.e., substrates carrying various functional groups). They often display activity towards a large variety of carbohydrate and non-carbohydrate acceptors. Glycosidases usually catalyze the hydrolysis of glycosidic linkages with either retention or inversion of stereochemical configuration in the product.

In some embodiments, the glycosylation products of the present application, such as GMGs, are formed from a reaction mixture comprising an exogenous glycosyl hydrolase classified as an EC 3.2.1 enzyme, including but not limited to alpha-glucosidase, beta-glucosidase and beta-fructofuranosidase.

Exemplary glycosyl hydrolases for use in the present application include, but are not limited to α-amylases (EC 3.2.1.1), α-glucosidases (EC 3.2.1.20), β-glucosidases (EC 3.2.1.21), α-galactosidases (EC 3.2.1.22), β-galactosidases (EC 3.2.1.23), α-mannosidase (EC 3.2.1.24), β-mannosidase (EC 3.2.1.25), β-fructofuranosidase (EC 3.2.1.26), amylo-1,6-glucosidases (EC 3.2.1.33), β-D-fucosidases (EC 3.2.1.38), α-L-rhamnosidases (EC 3.21.40), glucan 1,6-α-glucosidases (EC 3.2.70), and variants thereof.

In some embodiments, the glycosylation products of the present application are formed using a class of glycoside hydrolases or glycosyltransferases known as “transglycosylases.” As used herein, the term “transglycosylase” and “transglycosidase” (TG) are used interchangeably with reference to a glycoside hydrolase (GH) or glycosyltransferase (GT) enzyme capable of transferring a monosaccharide moiety from one molecule to another. Thus, a GH can catalyse the formation of a new glycosidic bond either by transglycosylation or by reverse hydrolysis (i.e., condensation).

The acceptor for transglycosylase reaction acceptor can be saccharide acceptor or a nonsaccharide acceptor. Thus, a transglycosidase can transfer a monosaccharide moiety to a diverse set of aglycones, including e.g., nonsaccharide acceptors, such as aromatic and aliphatic alcohols. Transglycosidases can transfer a wide variety of monosaccharides (D- or L-configurations) to saccharide acceptors, including glycosides, as well as nonsaccharide acceptors, including a wide variety of flavonoid aglycones, such as naringenin, quercetin, hesperetin.

Monosaccharides that can be transferred to a saccharide or nonsaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid. The term “transglucosidase” is used when the monosaccharide moiety is a glucose moiety.

Transglycosidases include GHs or GTs from the enzyme classes of EC 3.2.1 or 2.4.1, respectively. In spite of the inclusion of certain glycosyltransferases as transglycosidases, TGs are classified into various GH families on the basis of sequence similarity. A large number of retaining glycosidases catalyze both hydrolysis and transglycosylation reactions. In particular, these enzymes catalyze the intra- or intermolecular substitution of the anomeric position of a glycoside. Under kinetically controlled reactions, retaining glycosidases can be used to form glycosidic linkages using a glycosyl donor activated by a good anomeric leaving group (e.g., nitrophenyl glycoside). In contrast, the thermodynamically controlled reverse hydrolysis uses high concentrations of free sugars.

Transglycosidases corresponding to any of the GH families with notable transglycosylase activity may be used in the present application, and may include the use of e.g., members of the GH2 family, including LacZ β-galactosidase, which converts lactose to allolactose; GH13 family, which includes cyclodextran glucanotransferases that convert linear amylose to cyclodextrins, glycogen debranching enzyme, which transfers three glucose residues from the four-residue glycogen branch to a nearby branch, and trehalose synthase, which catalyzes the interconversion of maltose and trehalose; GH16 family, including xyloglucan endotransglycosylases, which cuts and rejoins xyloglucan chains in the plant cell wall; GH31, for example α-transglucosidases, which catalyze the transfer of individual glucosyl residues between α-(1→4)-glucans; GH70 family, for example glucansucrases, which catalyse the synthesis of high molecular weight glucans, from sucrose; GH77 family, for examples amylomaltase, which catalyzes the synthesis of maltodextrins from maltose; and the GH23, GH102, GH103, and GH104 families, which include lytic transglycosylases that convert peptidoglycan to 1,6-anhydrosugars.

In one embodiment, the glycosyltransferase is a transglucosylase from the glycoside hydrolase 70 (GH70) family. GH70 enzymes are transglucosylases produced by lactic acid bacteria from, e.g., Streptococcus, Leuconostoc, Weisella or Lactobacillus genera. Together with the families GH13 and GH77 enzymes, they form the clan GH-H. Most of the enzymes classified in this family use sucrose as the D-glucopyranosyl donor to synthesize α-D-glucans of high molecular mass (>10⁶ Da) with the concomitant release of D-fructose. They are also referred to as glucosyltransferases or glucansucrases.

A wide range of α-D-glucans, varying in size, structure, degree of branching and spatial arrangements can thus be produced by GH70 family members. For example, GH70 glucansucrases can transfer D-glucosyl units from sucrose onto hydroxyl acceptor groups. Glucansucrases catalyze the formation of linear as well as branched α-D-glucan chains with various types of glycosidic linkages, namely α-1,2; α-1,3; α-1,4; and/or α-1,6.

In addition, sucrose analogues such as α-D-glucopyranosyl fluoride, p-nitrophenyl α-D-glucopyranoside, α-D-glucopyranosyl α-L-sorofuranoside and lactulosucrose can be utilized as D-glucopyranosyl donors. A large variety of acceptors may be recognized by glucansucrases, including carbohydrates, alcohols, polyols or flavonoids to yield oligosaccharides or gluco-conjugates.

Exemplary glucansucrases for use in the present application include e.g., dextransucrase (sucrose:1,6-α-D-glucosyltransferase; EC 2.4.1.5), alternansucrase (sucrose:1,6(1,3)-α-D-glucan-6(3)-α-D-glucosyltransferase, EC 2.4.1.140), mutansucrase (sucrose:1,3-α-D-glucan-3-α-D-glucosyltransferase; EC 2.4.1.125), and reuteransucrase (sucrose:1,4(6-α-D-glucan-4(6)-α-D-glucosyltransferase; EC 2.4.1.-). The structure of the resultant glucosylated product is dependent upon the enzyme specificity.

In some embodiments, a fructosyltransferase may be used to catalyze the transfer of one or more fructose units, optionally comprising terminal glucose, of the following sequence: (Fru)n-Glc consisting of one or more of: β 2,1, β 2,6, α 1,2 and β-1,2 glycosidic bonds, wherein n typically is 3-10. Variants include Inulin type 3-1,2 and Levan type 3-2,6 linkages between fructosyl units in the main chain. Exemplary fructosytransferase for use in the present application include e.g., 0-fructofuranosidase (EC 3.2.1.26), inulosucrase (EC 2.4.1.9) levansucrase (EC 2.4.1.10), or endoinulinase.

In some embodiments, a galactosyltransferase or β-galactosidase may be used to catalyze the transfer of multiple saccharide units, in which one of the units is a terminal glucose and the remaining units are galactose and disaccharides comprising two units of galactose. In certain embodiments, the resulting structure includes a mixture of galactopyranosyl oligomers (DP=3-8) linked mostly by β-(1,4) or β-(1,6) bonds, although low proportions of 3-(1,2) or β-(1,3) linkages may also be present. Terminal glucosyl residues are linked by β-(1,4) bonds to galactosyl units. These structures may be synthesized by the reverse action of β-galactosidases (EC 3.2.1.23) on lactose at relatively high concentrations of lactose.

In some embodiments, the transglycosidase is an enzyme having trans-fucosidase, trans-sialidase, trans-lacto-N-biosidase and/or trans-N-acetyllactosaminidase activity.

In some embodiments, the glycosylation reactions may utilize a combination of any of glycosyltransferases described herein in combination with any one of the glycosyl hydrolases or transglycosidases described herein. In these reactions, the transglycosylase and the glycosyl hydrolase or translygosidase may be present in a range of ratios (w/w), wherein the transglycosylase/glycosyl hydrolase ratio (w/w) ranges from 100:1, 80:1, 60:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

### (2) Reaction Conditions

The glycosylating enzyme may be dissolved in the reaction mixture or immobilized on a solid support which is contacted with the reaction mixture. If the enzyme is immobilized, it may be attached to an inert carrier. Suitable carrier materials are known in the art. Examples for suitable carrier materials are clays, clay minerals such as kaolinite, diatomeceous earth, perlite, silica, alumina, sodium carbonate, calcium carbonate, cellulose powder, anion exchanger materials, synthetic polymers, such as polystyrene, acrylic resins, phenol formaldehyde resins, polyurethanes and polyolefins, such as polyethylene and polypropylene. For preparing carrier-bound enzymes the carrier materials usually are used in the form of fine powders, wherein porous forms are preferred. The particle size of the carrier material usually does not exceed 5 mm, in particular 2 mm. Further, suitable carrier materials are calcium alginate and carrageenan. Enzymes may directly be linked by glutaraldehyde. A wide range of immobilization methods are known in the art. Ratio of reactants can be adjusted based on the desired performance of the final product. The temperature of the glycosylation reaction can be in the range of 1−100° C., preferably 40-80° C., more preferably 50-70° C.

The enzymatically catalyzed reaction can be carried out batch wise, semi-batch wise or continuously. Reactants can be supplied at the start of reaction or can be supplied subsequently, either semi-continuously or continuously. The catalytic amount of glycosidase or glycosyltransferase required for the method of the invention depends on the reaction conditions, such as temperature, solvents and amount of substrate.

The reaction can be performed in aqueous media such as buffer. A buffer adjusts the pH of the reaction mixture to a value suitable for effective enzymatic catalysis. Typically the pH is in the range of about pH 4 to about pH 9, for example of about pH 5 to about pH 7. Suitable buffers comprise, but are not limited to, sodium acetate, tris(hydroxymethyl)aminomethane (“Tris”) and phosphate buffers.

Optionally, the reaction may take place in the presence of a solvent mixture of water and a water miscible organic solvent at a weight ratio of water to organic solvent of from 0.1:1 to 9:1, for example from 1:1 to 3:1. The organic solvent is no primary or secondary alcohol and, accordingly, is non-reactive towards the polysaccharide. Suitable organic solvents comprise alkanones, alkylnitriles, tertiary alcohols and cyclic ethers, and mixtures thereof, for example acetone, acetonitrile, t-pentanol, t-butanol, 1,4-dioxane and tetrahydrofuran, and mixtures thereof. Generally, the use of organic solvents is not preferred.

In one aspect as an example, glycosylated mogroside V (GMGV), is produced by dissolving MG and dextrin in water (reverse osmosis water). The ratio of dextrin to water is about 1:10 (weight/volume, (w/v)). A swingle extract with a mogroside content of between 1% and 99% is added to dextrin solution. In one embodiment, the dextrin to swingle extract ratio was optimized to a ratio of between 30:70 and 70:30. CGTase enzyme is added to the mixture (ratio of GMGV to CGTase is about 20:1 (w/v) and incubated at 60-70° C. for a desired length of reaction time (typically from about 2 hours to about 72 hours, more preferably from about 8 hours to about 48 hours, even more preferably from about 12 hours to about 24 hours) to glycosylate mogrosides with glucose molecules derived from dextrin, wherein the addition amount by volume is about 0.1-0.5 ml based on 1 g mogrosides. (The ratio of MGV to CGTase is from about 10:1 to about 20:1 w/v). After the desired ratio of GMGs and residual mogroside and dextrin contents are achieved (monitored by HPLC to analyze the content of unreacted MGV), the reaction mixture is heated to 80-100° C. for 30 min to inactivate the CGTase, which is then removed by filtration. The resulting solution of GMGs, residual mogroside and dextrin is decolored and spray dried.

In some embodiments, GMGs are produced with sugar donor-to-MGs/swingle extract weight ratio of 1:99 to 99:1, preferably above 30:70, more preferably above 50:50, 60:40, 70:30, 80:20, 90:10, 99:1.

In some embodiments, GMGs are produced with sugar donor-to-MGs/swingle extract weight ratio of 100:1, 80:1, 60:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

In some embodiments, GMGs are produced with sugar donor-to-MGs/swingle extract weight ratio of 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween wherein the ratios are from 1:99 and vice versa, e.g., a ratio of from 1:99 to 50:50, from 30:70 to 42:58, etc.

In some embodiments, GMGs are produced with mono-saccharide as the sugar donor.

In some embodiments, GMGs are produced with di-saccharide as the sugar donor.

In some embodiments, GMGs are produced with tri-saccharide as the sugar donor.

In some embodiments, GMGs are produced with tetra-saccharide as the sugar donor.

In some embodiments, GMGs are produced with penta-saccharide as the sugar donor.

In one embodiment, the method to prepare GMGs or glycosylated swingle extract(s) comprises the steps of: i) dissolving dextrin in water (e.g., reverse osmosis), ii) adding the mogrosides or extract to the solubilized dextrin to obtain a mixture, wherein the ratio of dextrin to mogrosides/extract is optimized in a ratio of between 40:60 and 60:40, iii) adding a CGTase to the mixture followed by incubating the mixture at 60° C. for a desired length of reaction time to glycosylate mogrosides with glucose molecules derived from dextrin, iv) after achieving the desired ratio of GMG(s) and residual mogroside(s) contents, heating the reaction mixture to 90-100° C. for 30 minutes to inactivate the CGTase, and v) removing the CGTase by filtration.

In some embodiments, the method further comprises the steps of adding amylase to the mixture and incubating the mixture at 70° C. for a desired period of time to shorten the length of glucose chain(s) in GMG molecules.

In some embodiments, the method further comprises the step of decolorizating the reaction mixture after glycosylation reaction, and/or spray drying the reaction mixture after glycosylation reaction. The final product typically comprises a mixture of GMGs, residual mogrosides and dextrin.

### Products Preparable by the Methods of the Present Application

Another aspect of the present application relates to glycosylation products preparable by the methods described in the present application.

In some embodiments, the glycosylation products comprise GMGs and un-reacted MGs. In some embodiments, the un-reacted MGs are present in a total amount of less than 20 wt %, less than 15 wt %, less than 10 wt %, less than 5 wt %, less than 4 wt %, less than 3 wt %, less than 2 wt %, less than 1 wt %, less than 0.5 wt %, less than 0.2 wt %, less than 0.1 wt %, or less than 0.01 wt % of the glycosylation product. In some embodiments, the un-reacted MGs are present in a total amount of 0.001-20 wt %, 0.001-15 wt %, 0.001-10 wt %, 0.001-5 wt %, 0.001-4 wt %, 0.001-3 wt %, 0.001-2 wt %, 0.001-1 wt %, 0.001-0.5 wt %, 0.001-0.2 wt %, 0.001-0.1 wt %, or 0.001-0.01 wt % of the glycosylation product.

In some embodiments, the glycosylation products comprise GMGs and un-reacted dextrins. In some embodiments, the un-reacted dextrins are present in a total amount of less than 30%, less than 20 wt %, less than 15 wt %, less than 10 wt %, less than 5 wt %, less than 4 wt %, less than 3 wt %, less than 2 wt %, less than 1 wt %, less than 0.5 wt %, less than 0.2 wt %, less than 0.1 wt %, or less than 0.01 wt % of the glycosylation product. In some embodiments, the un-reacted dextrins are present in a total amount of 0.001-30 wt %, 0.001-15 wt %, 0.001-10 wt %, 0.001-5 wt %, 0.001-4 wt %, 0.001-3 wt %, 0.001-2 wt %, 0.001-1 wt %, 0.001-0.5 wt %, 0.001-0.2 wt %, 0.001-0.1 wt %, or 0.001-0.01 wt % of the glycosylation product.

In some embodiments, the glycosylation products comprise GMGs, un-reacted MGs and un-reacted dextrins. In some embodiments, the un-reacted MGs and/or un-reacted dextrins are present in a total amount of less than 30%, less than 20 wt %, less than 15 wt %, less than 10 wt %, less than 5 wt %, less than 4 wt %, less than 3 wt %, less than 2 wt %, less than 1 wt %, less than 0.5 wt %, less than 0.2 wt %, less than 0.1 wt %, or less than 0.01 wt % of the glycosylation product. In some embodiments, the un-reacted MGs and/or un-reacted dextrins are present in a total amount of 0.001-30 wt %, 0.001-15 wt %, 0.001-10 wt %, 0.001-5 wt %, 0.001-4 wt %, 0.001-3 wt %, 0.001-2 wt %, 0.001-1 wt %, 0.001-0.5 wt %, 0.001-0.2 wt %, 0.001-0.1 wt %, or 0.001-0.01 wt % of the glycosylation product.

### Consumables Comprising the Sweetening or Flavoring Composition

Another aspect of the present application relates to consumables comprising the sweetening or flavoring composition of the present application.

In some embodiments, the consumable comprises the sweetening or flavoring composition of the present application in an amount of above 1 ppm, 10 ppm, 50 ppm, 100 ppm, 200 ppm, 300 ppm, 500 ppm, 1,000 ppm or 10,000 ppm.

In some embodiments, the consumable comprises the sweetening or flavoring composition of the present application in an amount in the range of 1-15,000 ppm, 10-15,000 ppm, 20-15,000 ppm, 50-15,000 ppm, 100-15,000 ppm, 200-15,000 ppm, 500-15,000 ppm, 1,000-15,000 ppm, 2,000-15,000 ppm, 5,000-15,000 ppm, 10,000-15,000 ppm, 1-10,000 ppm, 10-10,000 ppm, 20-10,000 ppm, 50-10,000 ppm, 100-10,000 ppm, 200-10,000 ppm, 500-10,000 ppm, 1,000-10,000 ppm, 2,000-10,000 ppm, 5,000-10,000 ppm, 1-5,000 ppm, 10-5,000 ppm, 20-5,000 ppm, 50-5,000 ppm, 100-5,000 ppm, 200-5,000 ppm, 500-5,000 ppm, 1,000-5,000 ppm, 2,000-5,000 ppm, 1-2,000 ppm, 10-2,000 ppm, 20-2,000 ppm, 50-2,000 ppm, 100-2,000 ppm, 200-2,000 ppm, 500-2,000 ppm, 1,000-2,000 ppm, 1-1,000 ppm, 10-1,000 ppm, 20-1,000 ppm, 50-1,000 ppm, 100-1,000 ppm, 200-1,000 ppm, 500-1,000 ppm, 1-500 ppm, 10-500 ppm, 20-500 ppm, 50-500 ppm, 100-500 ppm, 200-500 ppm, 1-200 ppm, 10-200 ppm, 20-200 ppm, 50-200 ppm, 100-200 ppm, 1-100 ppm, 10-100 ppm, 20-100 ppm, 50-100 ppm, 1-50 ppm, 10-50 ppm, 20-50 ppm, 1-20 ppm, 10-20 ppm or 1-10 ppm.

In some embodiments, the consumable comprises one or more components selected from a glycosylated mogroside or a glycosylated swingle extract, a glycosylated stevia extract or a glycosylated stevia glycosides, a stevia extract, or a stevia glycoside, wherein the amount of the one or more components is above 1 ppm, 10 ppm, 50 ppm, 100 ppm, 200 ppm, 300 ppm, 500 ppm, 1,000 ppm, 10,000 ppm.

In some embodiments, the consumable comprises GMGs in an amount of above 1 ppm, 10 ppm, 50 ppm, 100 ppm, 200 ppm, 300 ppm, 500 ppm, 1,000 ppm or 10,000 ppm.

In some embodiments, the consumable comprises MG-G1, MG-G2, MG-G3, MG-G4 and/or MG-G5 in an amount of above 1 ppm, 10 ppm, 50 ppm, 100 ppm, 200 ppm, 300 ppm, 500 ppm, 1,000 ppm or 10,000 ppm.

In some embodiments, the consumable comprises MG-G1, MG-G2, MG-G3, MG-G4 and/or MG-G5 in an amount in the range of 1-15,000 ppm, 10-15,000 ppm, 20-15,000 ppm, 50-15,000 ppm, 100-15,000 ppm, 200-15,000 ppm, 500-15,000 ppm, 1,000-15,000 ppm, 2,000-15,000 ppm, 5,000-15,000 ppm, 10,000-15,000 ppm, 1-10,000 ppm, 10-10,000 ppm, 20-10,000 ppm, 50-10,000 ppm, 100-10,000 ppm, 200-10,000 ppm, 500-10,000 ppm, 1,000-10,000 ppm, 2,000-10,000 ppm, 5,000-10,000 ppm, 1-5,000 ppm, 10-5,000 ppm, 20-5,000 ppm, 50-5,000 ppm, 100-5,000 ppm, 200-5,000 ppm, 500-5,000 ppm, 1,000-5,000 ppm, 2,000-5,000 ppm, 1-2,000 ppm, 10-2,000 ppm, 20-2,000 ppm, 50-2,000 ppm, 100-2,000 ppm, 200-2,000 ppm, 500-2,000 ppm, 1,000-2,000 ppm, 1-1,000 ppm, 10-1,000 ppm, 20-1,000 ppm, 50-1,000 ppm, 100-1,000 ppm, 200-1,000 ppm, 500-1,000 ppm, 1-500 ppm, 10-500 ppm, 20-500 ppm, 50-500 ppm, 100-500 ppm, 200-500 ppm, 1-200 ppm, 10-200 ppm, 20-200 ppm, 50-200 ppm, 100-200 ppm, 1-100 ppm, 10-100 ppm, 20-100 ppm, 50-100 ppm, 1-50 ppm, 10-50 ppm, 20-50 ppm, 1-20 ppm, 10-20 ppm or 1-10 ppm.

In some embodiments, the consumable comprises (1) one or more GMGs in an amount of above 1 ppm, 10 ppm, 50 ppm, 100 ppm, 200 ppm, 300 ppm, 500 ppm, 1,000 ppm, or 10,000 ppm, and (2) one or more of glycosylated products originated from rubusoside, RB, steviolbioside and steviolmonoside.

In some embodiments, the consumable comprises (1) MG-G1, MG-G2, MG-G3, MG-G4 and/or MG-G5 in an total amount of above 1 ppm, 10 ppm, 50 ppm, 100 ppm, 200 ppm, 300 ppm, 500 ppm, 1,000 ppm, or 10,000 ppm, and (2) one or more of glycosylated products originated from rubusoside, RB, steviolbioside and steviolmonoside.

In some embodiments, the consumable comprises (1) one or more GMGs in an amount of above 1 ppm, 10 ppm, 50 ppm, 100 ppm, 200 ppm, 300 ppm, 500 ppm, 1,000 ppm, or 10,000 ppm, and (2) one or more of stevia glycosides having a molecular weight of, or below, 965 dalton. In some embodiments, the consumable comprises (1) MG-G1, MG-G2, MG-G3, MG-G4 and/or MG-G5 in an total amount of above 1 ppm, 10 ppm, 50 ppm, 100 ppm, 200 ppm, 300 ppm, 500 ppm, 1,000 ppm, or 10,000 ppm, and (2) one or more of glycosylated stevia glycosides, wherein the glycosylated stevia glycosides are derived from stevia glycosides having a molecular weight of or below 965 dalton.

In some embodiments, the consumable comprises (1) one or more GMGs in an total amount of above 1 ppm, 10 ppm, 50 ppm, 100 ppm, 200 ppm, 300 ppm, 500 ppm, 1,000 ppm, or 10,000 ppm, (2) one or more glycosylated stevia glycosides selected from the group consisting of glycosylated rubusoside, glycosylated Reb B, glycosylated steviolbioside, and glycosylated stevioside, and (3) one or more stevia glycosides selected from the group consisting of rubusoside, RB, steviolbioside and stevioside.

In some embodiments, the consumable comprises (1) MG-G1, MG-G2, MG-G3, MG-G4 and/or MG-G5 in an total amount of above 1 ppm, 10 ppm, 50 ppm, 100 ppm, 200 ppm, 300 ppm, 500 ppm, 1,000 ppm, or 10,000 ppm, (2) one or more glycosylated stevia glycosides selected from the group consisting of glycosylated rubusoside, glycosylated Reb B, glycosylated steviolbioside, and glycosylated stevioside, and (3) one or more stevia glycosides selected from the group consisting of rubusoside, RB, steviolbioside and stevioside.

In some embodiments, the consumable comprises (1) one or more GMGs in an total amount of above 1 ppm, 10 ppm, 50 ppm, 100 ppm, 200 ppm, 300 ppm, 500 ppm, 1,000 ppm, or 10,000 ppm, and (2) iso-mogrosides, such as iso-mogroside V.

In some embodiments, the consumable comprises (1) MG-G1, MG-G2, MG-G3, MG-G4 and/or MG-G5 in an total amount of above 1 ppm, 10 ppm, 50 ppm, 100 ppm, 200 ppm, 300 ppm, 500 ppm, 1,000 ppm, or 10,000 ppm, and (2) iso-mogrosides, such as iso-mogroside V.

In some embodiments, the consumable comprises (1) one or more GMGs in an total amount of above 1 ppm, 10 ppm, 50 ppm, 100 ppm, 200 ppm, 300 ppm, 500 ppm, 1,000 ppm, or 10,000 ppm, and (2) a glycosylation product selected from the group consisting of glycosylated stevia glycosides, glycosylated stevia extract or glycosylated sweet tea extract, glycosylated rubuosides, glycosylated steviosides, glycosylated steviobiosides, glycosylated steviomonosides, glycosylated dulcoside A, and glycosylated RB.

In some embodiments, the consumable comprises the sweetening or flavoring composition of the present application in an amount in the range of 0.5-10 ppm, 1-9 ppm, 2-8 ppm, 3-7 ppm, 4-6 ppm, and all values and ranges encompassed over the range of from about 0.5 ppm to about 10 ppm.

### Applications of Compositions Comprising GMGs

The sweetener or flavoring compositions of the present application can be used as a sugar substitute alone or in combination with a food product.

The sweetener or flavoring compositions of the present application can be used in beverages, broths, and beverage preparations selected from the group comprising carbonated, non-carbonated, frozen, semi-frozen (“slush”), non-frozen, ready-to-drink, concentrated (powdered, frozen, or syrup), dairy, non-dairy, herbal, non-herbal, caffeinated, non-caffeinated, alcoholic, non-alcoholic, flavored, non-flavored, vegetable-based, fruit-based, root/tuber/corm-based, nut-based, other plant-based, cola-based, chocolate-based, meat-based, seafood-based, other animal-based, algae-based, calorie enhanced, calorie-reduced, and calorie-free products, optionally dispensed in open containers, cans, bottles or other packaging. Such beverages and beverage preparations can be in ready-to-drink, ready-to-cook, ready-to-mix, raw, or ingredient form and can use the composition as a sole sweetener or as a co-sweetener.

The sweetener or flavoring compositions of the present application can be used in foods and food preparations (e.g., sweeteners, soups, sauces, flavorings, spices, oils, fats, and condiments) from dairy-based, cereal-based, baked, vegetable-based, fruit-based, root/tuber/corm-based, nut-based, other plant-based, egg-based, meat-based, seafood-based, other animal-based, algae-based, processed (e.g., spreads), preserved (e.g., meals-ready-to-eat rations), and synthesized (e.g., gels) products.

The sweetener or flavoring compositions of the present application can be used in candies, confections, desserts, and snacks selected from the group comprising dairy-based, cereal-based, baked, vegetable-based, fruit-based, root/tuber/corm-based, nut-based, gum-based, other plant-based, egg-based, meat-based, seafood-based, other animal-based, algae-based, processed (e.g., spreads), preserved (e.g., meals-ready-to-eat rations), and synthesized (e.g., gels) products. Such candies, confections, desserts, and snacks can be in ready-to-eat, ready-to-cook, ready-to-mix, raw, or ingredient form, and can use the compositions as a sole sweetener or as a co-sweetener.

The sweetener or flavoring compositions of the present application can be used in prescription and over-the-counter pharmaceuticals, assays, diagnostic kits, and therapies selected from the group comprising weight control, nutritional supplement, vitamins, infant diet, diabetic diet, athlete diet, geriatric diet, low carbohydrate diet, low fat diet, low protein diet, high carbohydrate diet, high fat diet, high protein diet, low calorie diet, non-caloric diet, oral hygiene products (e.g., toothpaste, mouthwash, rinses, floss, toothbrushes, other implements), personal care products (e.g., soaps, shampoos, rinses, lotions, balms, salves, ointments, paper goods, perfumes, lipstick, other cosmetics), professional dentistry products in which taste or smell is a factor (e.g., liquids, chewables, inhalables, injectables, salves, resins, rinses, pads, floss, implements), medical, veterinarian, and surgical products in which taste or smell is a factor (e.g., liquids, chewables, inhalables, injectables, salves, resins, rinses, pads, floss, implements), and pharmaceutical compounding fillers, syrups, capsules, gels, and coating products.

The sweetener or flavoring compositions of the present application can be used in consumer goods packaging materials and containers selected from the group comprising plastic film, thermoset and thermoplastic resin, gum, foil, paper, bottle, box, ink, paint, adhesive, and packaging coating products.

The sweetener or flavoring compositions of the present application can be used in goods including sweeteners, co-sweeteners, coated sweetener sticks, frozen confection sticks, medicine spoons (human and veterinary uses), dental instruments, presweetened disposable tableware and utensils, sachets, edible sachets, potpourris, edible potpourris, artificial flowers, edible artificial flowers, clothing, edible clothing, massage oils, and edible massage oils.

Without limitation, the components (MGs, STC, SGs, GTCs, GMGs and GSGs) described herein can each individually be in an amorphous form, each individually in a polymorphic form, each individually in a hydrate form, or mixtures thereof.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1. Preparation of Glycosylated Mogroside V (GMG) from Mogroside V 50%

Materials: Mogroside V 50% (available from Hunan Huacheng Biotech, Inc., Lot #: LHGE-161112), CGtase (available from Amano Enzyme, Inc., Lot #CGTN0450202SLK), maltodextrin (available from Baolingbao Biology Co., Ltd., Lot #16052872).

A glycosylated reaction product composition was prepared using mogroside V 50% according to the following method:

Mogroside V 50, maltodextrin, water, CGTase enzyme were weighed as Table 1-1.
i) The weighed maltodextrin was dissolved in 100 mL deionized water
ii) The weighed mogroside was added to the dissolved dextrin solution to form a mixture
iii) The weighed CGTase enzyme and deionized water were added to the mixture and incubated at 69° C. for 10 hours to glycosylate the mogroside V 50 with glucose molecules derived from maltodextrin.
iv) The reaction mixture of iii) was heated to 85° C. for 10 min to inactivate the CGTase, which was then removed by filtration
v) The resulting solution of glycosylated mogroside (GMG), residual mogroside and dextrin were decolored and spray dried, thereby resulting GMG as off-white powder.

TABLE 1-1
Sample composition

| | Weight of | Weight of | Weight of |
|---|---|---|---|
| Product | mogroside | maltodextrin | water |
| NO. | V 50 (g) | (g) | (g) |
| 1-01 | 40 | 33 | 400 |
| 1-02 | 40 | 40 | 400 |
| 1-03 | 40 | 56 | 400 |

The method of production of GMGs should not be limited by above example. The ratio of reactants including amount of Monk fruit Extract, dextrin could vary from ratio of 1:100 to 100:1. Amount of added CGTase could be added in any amount as required. Temperature could from 0° C. to 100° C., and reaction time could be from 1 second to one week or even longer depends on requirement of glycosylated degree.

### Example 2. Evaluation of GMGs Prepared with Different Ratios of Maltodextrin in their Performance in RU90 Solution

Materials: 1) GMG: product 1-01 to product 1-03 from Example 1) RU90: available from EPC Natural Products Co., Ltd., Lot #: 20062501, the content of RU is 92.8%.

Process: GMGs (product 1-01 to product 1-03 from Example 1) and RU90 were weighed, mixed, dissolved in 100 mL pure water as set forth in Table 2-1, and subjected to sensory evaluation tests according to the evaluation method below, the results of which are shown in Table 2-2.

TABLE 2-1
Preparation of mixtures of GMG (product 1-01
to product 1-03 from Example 1) and RU90

| | | | Volume |
|---|---|---|---|
| | | Weight | of |
| Sample | | of | pure |
| mixture | | RU90 | water |
| No. | Weight of GMGs (mg) | (mg) | (mL) |
| 2-00 | 0 | 20 | 100 |
| 2-01 | 10 (product 1-01 from example 1) | | |
| 2-02 | 10 (product 1-02 from example 1) | | |
| 2-03 | 10 (product 1-03 from example 1) | | |

Sensory Evaluation Method:

Products were evaluated in terms of sweetness onset, bitterness, sweet lingering, metallic aftertaste and overall likability.

A panel of 6 trained testers evaluated the samples and gave scores of 1-5 according to the followed standards. The average score of the panel members was taken as the score of each factor.

1) Sweetness Onset

Evaluation Standard:

The sample to be evaluated was dissolved in neutral deionized water. The tester placed 20-30 mL of the evaluation solution in their mouth, and timing was started to record the sweetness start time and peak time. The test solution was then spit out. The time at which the sweetness of the solution can be detected by the panelists was recorded as the time of sweetness onset time and was compared in the table below to determine the score of sweetness onset.

TABLE 2-2
Sweetness onset evaluation test standard

| RA97 | 250 ppm | | | | |
|---|---|---|---|---|---|
| Range of yeast extract | <25 | 25-50 | 50-75 | 75-100 | >100 |
| concentration | ppm | ppm | ppm | ppm | ppm |
| Score of kokumi level | 1 | 2 | 3 | 4 | 5 |

2) Bitterness

Quinine (99% purity) concentration of 10⁻⁸-10⁻⁴ mol/L was the bitterness standard, and the specific bitterness scoring standards are shown in the following table.

TABLE 2-3
Bitterness evaluation test standard

| | | | | | |
|---|---|---|---|---|---|
| Time at which | <0.2 s | 0.2-1 s | 1-2 s | 2~3 s | >3 s |
| sweetness can be | | | | | |
| detected | | | | | |
| Score of | 5 | 4 | 3 | 2 | 1 |
| bitterness | | | | | |

The sample to be evaluated was dissolved in neutral deionized water. The tester placed 20-30 mL of the evaluation solution in their mouth. After 5 seconds the sample was spit out. After a rinse step with water, the standard solution was tasted. If the bitter taste was similar, the bitterness of the sample could be determined as the bitterness value of the standard solution. Otherwise it was necessary to take additional standard solution(s) and try again until the bitterness value was determined.

3) Sweet Lingering

The sample to be evaluated was dissolved in neutral deionized water. The tester placed 20-30 mL of the evaluation solution in their mouth, and timing was started to record the sweetness start time and peak time. The test solution was then spit out. Recording of time continued for the time when the sweetness disappeared completely. The time at which the sweetness completely disappeared was compared to the time in the table below to determine the value of sweet lingering.

TABLE 2-4
Sweet lingering evaluation test standard

| | Time at which sweetness completely disappears | | | | |
|---|---|---|---|---|---|
| | <20 s | 20-30 s | 30-40 s | 40-50 s | >50 s |
| Score of sweet | 1 | 2 | 3 | 4 | 5 |
| lingering | | | | | |

4) Metallic Aftertaste

Sucralose (available from Anhui Jinhe Industrial Co., Ltd and Lot # is 201810013) was used as a standard reference. The specific metallic aftertaste scoring standards are shown in Table 2-5.

TABLE 2-5
Metallic aftertaste evaluation test standard

| | Range of sucralose concentration | | | | |
|---|---|---|---|---|---|
| | <50 | 50-100 | 100-150 | 150-200 | >200 |
| | ppm | ppm | ppm | ppm | ppm |
| Score of metallic | 1 | 2 | 3 | 4 | 5 |
| aftertaste | | | | | |

The sample to be evaluated was dissolved in neutral deionized water. The tester placed 20-30 mL of the evaluation solution in their mouth. After 5 seconds, the solution was spit out. After a rinse step with water the standard solution was tasted. If the metallic aftertaste was similar, the metallic aftertaste of the sample was determined as the metallic aftertaste score of the standard liquid, otherwise it was necessary to take additional standard liquid samples and taste it again until the metallic aftertaste score was determined.

5) Overall Likability

Overall likability is the general impact of the sample. The sample to be evaluated was dissolved in neutral deionized water. The tester places 20-30 mL of the evaluation solution in their mouth and evaluate the general impact based on its kokumi, bitterness, bitterness lingering, sweet lingering, and metallic aftertaste. The test solution was then spit out. A score of 1-5 indicates a strong dislike, dislike, average, like, and strong like

6) Time-Intensity Curves

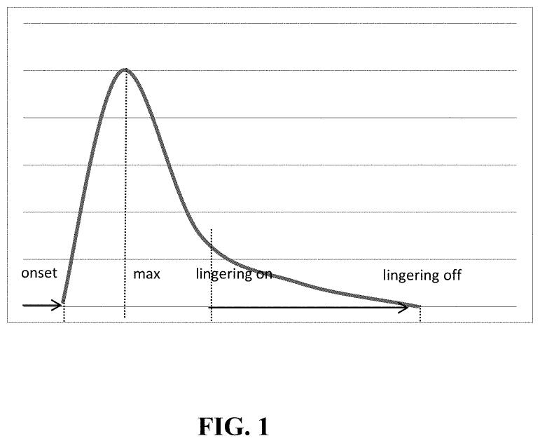

Evaluation method: Each person of the test panel had to drink sample solutions with defined concentrations. During the test, all persons had a time clock. They had to note the appearance-time for four specific points of a time-intensity curves (onset, maximum sweetness, lingering on and lingering off). The results were recorded and make a graph, mean values were calculated from at least 6 individual test persons. FIG. 1 shows a schematic diagram of the Time-intensity curve.

TABLE 2-6
Sensory evaluation results

| Sample | Sweet- | Sweet | | | |
|---|---|---|---|---|---|
| mixture | ness | linger- | bitter- | Metallic | Overall |
| No. | onset | ing | ness | aftertaste | likability |
| 2-00 | 2 | 4 | 4 | 3 | 2 |
| 2-01 | 3.5 | 2 | 2.5 | 2 | 4 |
| 2-02 | 3.5 | 2.5 | 2 | 2 | 3.5 |
| 2-03 | 4 | 2 | 2. | 1.5 | 4.5 |

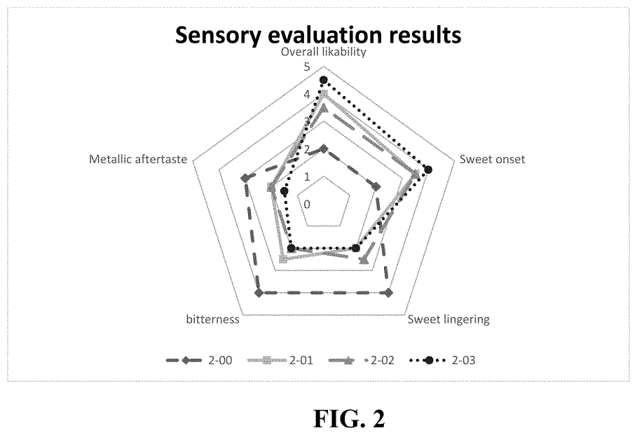

Conclusion: The result showed that all three GMGs prepared in Example 1 significantly improved the taste profile of the RU90 solution by cutting sweet linger, reducing the metallic taste and bitterness, and quickening the sweetness onset (see FIG. 2). This effect was observed in all three tested samples. The GMG prepared with the ratio of MGV50%:maltodextrin=1:1.4 showed the most significant improvement comparing to the other two GMSs that also showed their ability to enhance the taste profile of the RU90 solution. It shows higher degree of glycosylation of mogroside and mogroside precursors could significantly improve its performance to improve its taste profile to be used as flavor or sweeteners.

### Example 3. Evaluation of GMGs Prepared with Different Ratios of Maltodextrin in their Performance in Reb M Solution

Materials: 1) GMG: product 1-01 to product 1-03 from Example 1, 2) Reb M: available from Tate & Lyle Sugar Co, Ltd., Lot #:DP18w92701, the content of Reb M is no less than 95%.

Process: GMGs (product 1-01 to product 1-03 from Example 1) and Reb M were weighed, mixed, dissolved in 100 mL pure water as set forth in Table 3-1, and subjected to sensory evaluation tests, the results of which are shown in Table 3-2.

TABLE 3-1
Sample composition

| Sample | | Weight | Volume of |
|---|---|---|---|
| mixture | | of Reb | pure water |
| No. | Weight of GMGs (mg) | M (mg) | (mL) |
| 3-00 | 0 | 20 | 100 |
| 3-01 | 10 (product 1-01 from example 1) | | |
| 3-02 | 10 (product 1-02 from example 1) | | |
| 3-03 | 10 (product 1-03 from example 1) | | |

TABLE 3-2
Sensory evaluation results

| Sample | Sweet- | | | | |
|---|---|---|---|---|---|
| mixture | ness | Sweet | bitter- | Metallic | Overall |
| No. | onset | lingering | ness | aftertaste | likability |
| 3-00 | 3 | 4 | 2.5 | 4.5 | 2.5 |
| 3-01 | 4 | 2 | 1.5 | 2 | 4 |
| 3-02 | 3.5 | 2.5 | 1.5 | 1.5 | 4 |
| 3-03 | 4 | 2 | 1.5 | 1 | 4.5 |

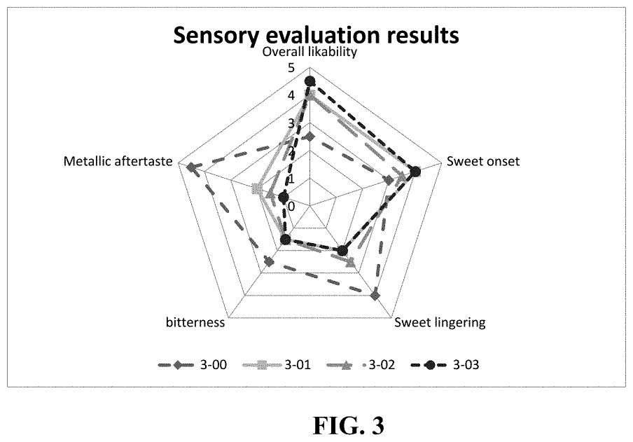

Conclusion: The result showed that all three GMGs prepared in Example 1 significantly improved the taste profile of the Reb M solution by cutting sweet linger, reducing the bitterness, significantly reducing the metallic aftertaste, and quickening the sweetness onset (see FIG. 3). This effect was observed in all three tested samples. The GMG prepared with the ratio of MGV50%:maltodextrin=1:1.4 showed the most significant improvement comparing to the other two GMGs that also showed their ability to enhance the taste profile of the Reb M solution. The example demonstrates that different degree of GMGs could improve the taste profile of stevia glycosides even for good taste of stevia glycosides or higher molecular weight of stevia glycosides such as Reb M. The ratio of GMGs and stevia glycosides could vary from 1:99 to 99:1 on weight to weight basis.

### Example 4. GMG (Product 1-03 from Example 1) Improves the Taste Profile of RU90

Materials: 1) GMG: product 1-03 from Example 1) RU90: available from EPC Natural Products Co., Ltd., Lot #: 20062501, the content of RU is 92.8%.

Process: GMG (product 1-03 from Example 1) and RU90 were weighed, mixed, dissolved in 100 mL pure water as set forth in Table 4-1, and subjected to sensory evaluation tests, the results of which are shown in Table 4-2.

TABLE 4-1
Preparation of mixtures of GMG (product
1-03 from Example 1) and RU90

| | Ratio | | Weight of | |
|---|---|---|---|---|
| | of GMG | Weight | GMG (product | Volume |
| Sample | (product 1-03 | of | 1-03 from | of pure |
| mixture | from Example 1) | RU90 | Example 1) | water |
| No. | to GRU | (mg) | (mg) | (mL) |
| 4-00 | 0/200 | 20 | 0 | 100 |
| 4-01 | 10/200 | | 1 | |
| 4-02 | 20/200 | | 2 | |
| 4-03 | 50/200 | | 5 | |
| 4-04 | 100/200 | | 15 | |
| 4-05 | 200/200 | | 20 | |
| 4-06 | 400/200 | | 40 | |
| 4-07 | 800/200 | | 80 | |
| 4-08 | 2000/200 | | 200 | |

TABLE 4-2
Sensory evaluation results

| Sample | | | | | |
|---|---|---|---|---|---|
| mixture | Sweetness | Sweet | | Metallic | Overall |
| No. | onset | lingering | bitterness | aftertaste | likability |
| 4-00 | 2 | 4 | 4 | 3 | 2 |
| 4-01 | 2.5 | 2.5 | 2.5 | 2.5 | 3.5 |
| 4-02 | 3 | 2.5 | 2.5 | 2 | 3.5 |
| 4-03 | 3 | 1.5 | 2 | 1.5 | 4 |
| 4-04 | 3.5 | 1 | 1 | 1 | 4.5 |
| 4-05 | 4 | 1.5 | 1 | 1 | 4.5 |
| 4-06 | 4 | 1.5 | 1.5 | 1 | 4.5 |
| 4-07 | 4 | 2 | 1.5 | 1.5 | 4 |
| 4-08 | 4 | 2.5 | 2 | 2 | 4 |

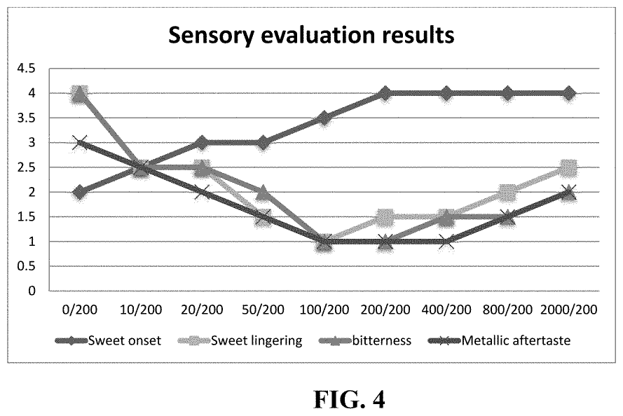

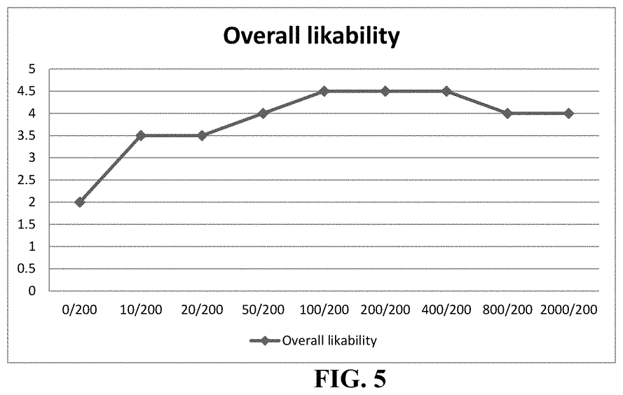

Conclusion: The result showed that GMG could significantly reduce the unpleasant sweet linger, metallic aftertaste, bitterness and quicken sweetness onset of 200 ppm RU90 solution (see FIGS. 4-5). This effect was observed in all the tested GMG-to-RU90 ratios mentioned in the tables above. The effect can be extended to the GMG-to-RU90 ratio range of 99:1 to 1:99. This example demonstrates that GMG can improve taste profile, cut sweet linger, reduce the metallic aftertaste and bitterness while quickening the sweetness onset of the RU90 solutions. The example shows that different degree of glycosylated mogrosides could improve taste profile of stevia glycosides with low molecular weight such as rubusoside. The example could be extended to stevioside, Reb B, steviobioside, steviomonoside, ducoside A. It could also improve the taste profile of sweet tea extract accordingly.

### Example 5. GMG (Product 1-03 from Example 1) Improved the Taste Profile of RM Solutions

Raw material: 1) GMG: product 1-03 Example 1) RM: Tate & Lyle Co, Ltd., Lot #:DP18I92701, the content of Reb M is no less than 95%.

Process: 1) A 200 ppm Reb M solution was prepared by dissolving 0.12 g of RM ( ), in 300 ml deionized water. Then the solution was sonicated with ultrasonic cleaner for 15 min, resulting in a fully dissolved RM solution. 2) GMGs were weighed, mixed and dissolved in 100 ml RM solutions as set forth in Table 5-1 and subjected to sensory evaluation tests, the results of which are shown in Table 5-2.

TABLE 14-1
Preparation of mixtures of GMGs
(product of Example 1) and RM solution

| | Ratio | | Weight of | Volume of |
|---|---|---|---|---|
| | of GMGs | | GMGs (product | 200 ppm |
| Sample | (product 1-03 | Weight | 1-03 of | Reb M |
| mixture | of Example 1) | RM | Example 1) | solution |
| No. | to Reb M | (mg) | (mg) | (mL) |
| 5-00 | 0/200 | 200 | 0 | 100 |
| 5-01 | 10/200 | | 1 | |
| 5-02 | 20/200 | | 2 | |
| 5-03 | 50/200 | | 5 | |
| 5-04 | 100/200 | | 10 | |
| 5-05 | 200/200 | | 20 | |
| 5-06 | 400/200 | | 40 | |
| 5-07 | 800/200 | | 80 | |
| 5-08 | 2000/200 | | 200 | |

Experiments: Several mixtures of GMGs (product 1-03 of Example 1) and 200 ppm RM solution were prepared and evaluated according to the following sensory evaluation method:

The average scores from the panel were taken as the evaluation test results to produce the taste profiles depicted in Table 5-2.

TABLE 5-2
Sensory evaluation results

| Sample | | | | | |
|---|---|---|---|---|---|
| mixture | Sweetness | Sweet | | Metallic | Overall |
| No. | onset | lingering | Bitterness | aftertaste | likability |
| 5-00 | 3 | 4 | 2.5 | 4.5 | 2.5 |
| 5-01 | 3 | 4 | 2.5 | 4 | 3 |
| 5-02 | 3 | 3.5 | 2 | 3.5 | 3 |
| 5-03 | 3.5 | 2.5 | 2 | 2.5 | 3.5 |
| 5-04 | 4 | 2 | 1.5 | 2 | 4 |
| 5-05 | 4 | 2.5 | 1.5 | 2 | 4 |
| 5-06 | 3.5 | 3 | 1.5 | 2 | 3.5 |
| 5-07 | 3.5 | 3 | 2 | 2 | 3.5 |
| 5-08 | 3.5 | 3.5 | 2 | 2 | 3.5 |

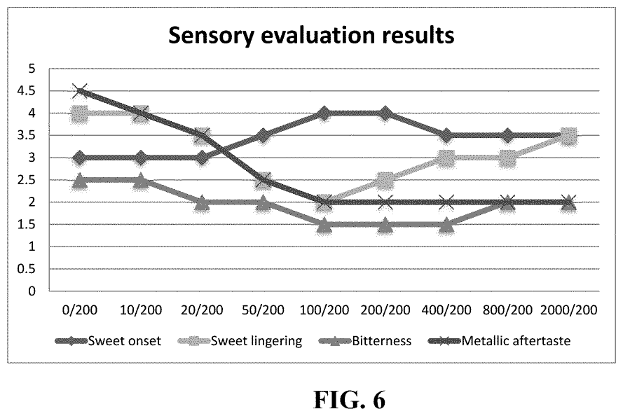

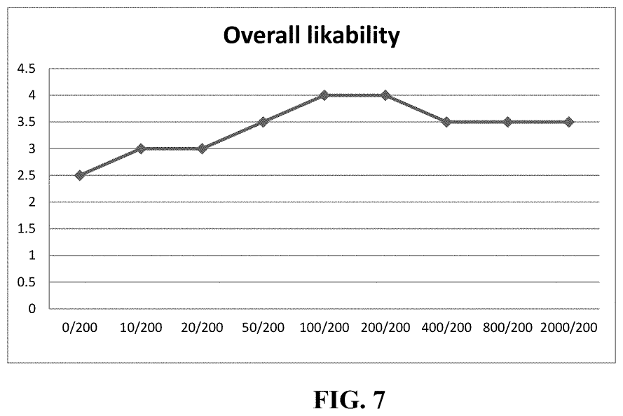

Conclusion: The result showed that GMG could significantly reduce the unpleasant sweet linger, metallic aftertaste, bitterness and quicken sweetness onset of 200 ppm RM solution (see FIGS. 6-7). This effect was observed in all the tested GMG-to-RM ratios mentioned in the tables above. The effect can be extended to the GMG-to-RM ratio range of 99:1 to 1:99. This example demonstrates that GMG can improve taste profile, cut sweet linger, reduce the metallic aftertaste and bitterness while quickening the sweetness onset of the RM solutions. This example further shows glycosylated monk fruit extract or mogrosides of different glycosylation degrees that contains glycosylated mogrosides of different molecular weight and chain lengths including mono-glycosyl MG, di-glycosyl MG and etc., could improve the taste profile of stevia glycosides of higher molecular weight such as RM. This effect can be further extended to stevia glycosides of relatively higher molecular weight such as RE, RO, RN, and etc.

### Example 6. GMG (Product 1-03 from Example 1) Improves the Taste Profile of GRU

Materials: 1) GMG: product 1-03 from Example 1) GRU (glycosylated rubusoside 90): available from EPC Natural Products Co., Ltd., Lot #: 313-15-1.

Process: GMG (product 1-03 from Example 1) and GRU were weighed, mixed, dissolved in 100 mL pure water as set forth in Table 6-1, and subjected to sensory evaluation tests, the results of which are shown in Table 6-2.

TABLE 6-1
Preparation of mixtures of GMG (product
1-03 from Example 1) and GRU

| | Ratio | | Weight of | |
|---|---|---|---|---|
| | of GMG | Weight | GMG (product | Volume |
| Sample | (product 1-03 | of | 1-03 from | of pure |
| mixture | from Example 1) | GRU | Example 1) | water |
| No. | to GRU | (mg) | (mg) | (mL) |
| 6-00 | 0/200 | 20 | 0 | 100 |
| 6-01 | 10/200 | | 1 | |
| 6-02 | 20/200 | | 2 | |
| 6-03 | 50/200 | | 5 | |
| 6-04 | 150/200 | | 15 | |
| 6-05 | 200/200 | | 20 | |
| 6-06 | 400/200 | | 40 | |
| 6-07 | 800/200 | | 80 | |
| 6-08 | 2000/200 | | 200 | |

Experiments: Several mixtures of GMGs (product 1-03 of Example 1) and 200 ppm GRU solution were prepared and evaluated according to the aforementioned sensory evaluation standard in Example 2. Average scores from the test panel for each sensory criterion were taken as the evaluation test results. The taste profiles of the resulting beverage product samples are based on the sensory criteria in Example 2.

TABLE 6-2
Sensory evaluation results

| Sample | Sweet- | | | | |
|---|---|---|---|---|---|
| mixture | ness | Sweet | bitter- | Metallic | Overall |
| No. | onset | lingering | ness | aftertaste | likability |
| 6-00 | 2.5 | 3 | 3 | 2.5 | 3 |
| 6-01 | 2.5 | 2.5 | 2.5 | 2.5 | 3.5 |
| 6-02 | 3 | 2.5 | 2.5 | 2 | 3.5 |
| 6-03 | 3 | 1.5 | 2 | 1.5 | 4 |
| 6-04 | 3.5 | 1 | 1 | 1 | 4.5 |
| 6-05 | 4 | 1.5 | 1 | 1 | 4.5 |
| 6-06 | 4 | 1.5 | 1.5 | 1 | 4.5 |
| 6-07 | 4 | 2 | 1.5 | 1.5 | 4 |
| 6-08 | 4 | 2.5 | 2 | 2 | 4 |

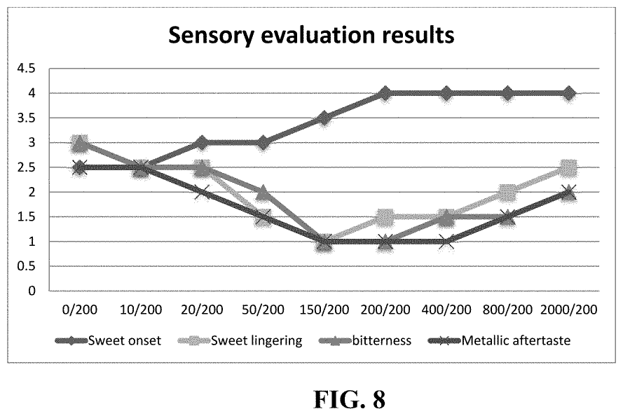

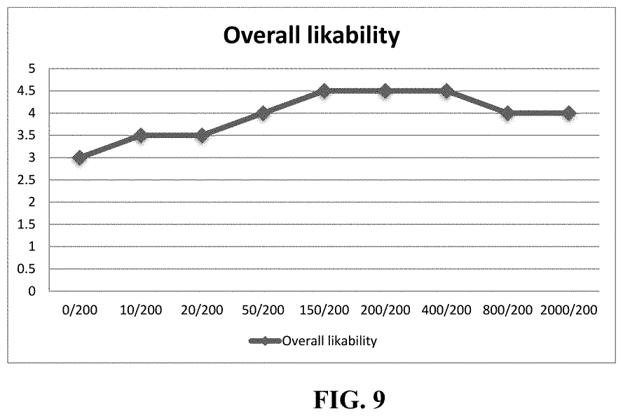

Conclusion: The result showed that GMG could significantly reduce the unpleasant sweet linger, metallic aftertaste, bitterness and quicken sweetness onset of 200 ppm GRU solution (see FIGS. 8-9). This effect was observed in all the tested GMG-to-GRU ratios mentioned in the tables above. The effect can be extended to the GMG-to-GRU ratio range of 99:1 to 1:99. This example demonstrates that GMG can improve taste profile, cut sweet linger, reduce the metallic aftertaste and bitterness while quickening the sweetness onset of the GRU solutions. This example further shows that glycosylated monk fruit extract or mogrosides of different glycosylation degrees that contain glycosylated mogrosides with different molecular weight and glucose chain lengths including mono-glycosyl MGs, di-glucosyl MGs, tri-glucosyl MGs, tetra-glucosyl MGs could improve the taste profile of glycosylated stevia glycosides, glycosylated stevia extract or glycosylated sweet tea extract, glycosylated rubuosides, glycosylated steviosides, glycosylated steviobiosides, glycosylated steviomonosides, glycosylated dulcoside A, glycosylated RB, etc.

### Example 7. GMG (Product 1-03 from Example 1) Improves the Taste Profile of RD

Materials: 1) GMG: product 1-03 from Example 10) RD: available from Sweet Green Fields, Lot #: 478/38/70, the content of RD is no less than 95%.

Process: GMG (product 1-03 from Example 1) and RD were weighed, mixed, dissolved in 100 mL pure water as set forth in Table 7-1, and subjected to sensory evaluation tests, the results of which are shown in Table 7-2.

TABLE 7-1
Preparation of mixtures of GMG (product
1-03 from Example 1) and RD

| | Ratio | | Weight of | |
|---|---|---|---|---|
| | of GMG | Weight | GMG (product | Volume |
| Sample | (product 1-03 | of | 1-03 from | of pure |
| mixture | from Example 1) | RD | Example 1) | water |
| No. | to GRU | (mg) | (mg) | (mL) |
| 7-00 | 0/200 | 20 | 0 | 100 |
| 7-01 | 10/200 | | 1 | |
| 7-02 | 20/200 | | 2 | |
| 7-03 | 50/200 | | 5 | |
| 7-04 | 150/200 | | 15 | |
| 7-05 | 200/200 | | 20 | |
| 7-06 | 400/200 | | 40 | |
| 7-07 | 800/200 | | 80 | |
| 7-08 | 2000/200 | | 200 | |

Experiments: Several mixtures of GMGs (product 1-03 of Example 1) and 200 ppm RD solution were prepared and evaluated according to the aforementioned sensory evaluation standard in Example 2. Average scores from the test panel for each sensory criterion were taken as the evaluation test results. The taste profiles of the resulting beverage product samples are based on the sensory criteria in Example 2.

TABLE 7-2
Sensory evaluation results

| Sample | Sweet- | | | |
|---|---|---|---|---|
| mixture | ness | Sweet | Metallic | Overall |
| No. | onset | lingering | aftertaste | likability |
| 7-00 | 2.5 | 4 | 4 | 2 |
| 7-01 | 2.5 | 3.5 | 3.5 | 2.5 |
| 7-02 | 3 | 3 | 3 | 3 |
| 7-03 | 3.5 | 2.5 | 3 | 3.5 |
| 7-04 | 3.5 | 2 | 2 | 4 |
| 7-05 | 3.5 | 2.5 | 2 | 3.5 |
| 7-06 | 3 | 3 | 2 | 3.5 |
| 7-07 | 3 | 3 | 2 | 3 |
| 7-08 | 3 | 3.5 | 2 | 3 |

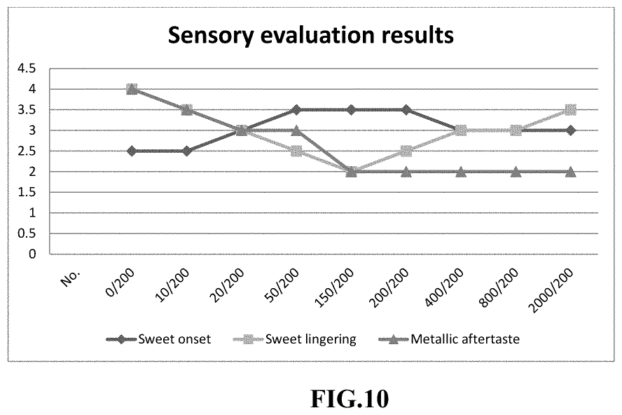

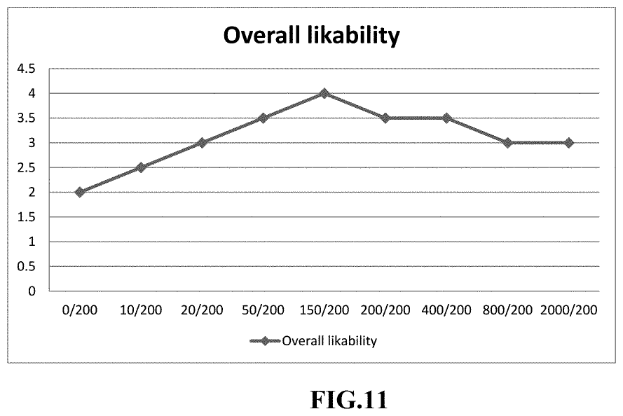

Conclusion: The result showed that GMG could significantly reduce the unpleasant sweet linger, metallic aftertaste, and quicken sweetness onset of 200 ppm RD solution (see FIGS. 10-11). This effect was observed in all the tested GMG-to-RD ratios mentioned in the tables above. The effect can be extended to the GMG-to-RD ratio range of 99:1 to 1:99. This example demonstrates that GMG can improve taste profile, cut sweet linger, reduce the metallic aftertaste while quickening the sweetness onset of the RD solutions. This example further shows that different degree of glycosylated monk fruit extract or mogrosides that contains glycosylated mogrosides of different molecular weight and glucose chain lengths including mono-glycosyl MGs, di-glycosyl MGs, tri-glycosyl MGs, tetra-glycosyl MGs, etc, could improve the taste profile of stevia glycosides of relatively higher molecular weight of (longer chain) stevia glycosides such as RD and RM, RO, RN.

### Example 8. GMG (Product 1-03 from Example 1) Improves the Taste Profile of RD/RM Mixture

Materials: 1) GMG: product 1-03 from Example 1) RD: available from Sweet Green Fields, Lot #: 478/38/70, the content of Reb D is no less than 95%, RM: available from Tate & Lyle Sugar Co., Ltd., Lot #: DP18I92701, the content of Reb M is no less than 95%.

Process: GMG (product 1-03 from Example 1) RD and RM were weighed, mixed, dissolved in 100 mL pure water as set forth in Table 8-1, and subjected to sensory evaluation tests, the results of which are shown in Table 8-2.

TABLE 8-1
Preparation of mixtures of GMG (product
1-03 from Example 1) and RD/RM

| | Ratio | | | Weight of | |
|---|---|---|---|---|---|
| | of GMG | | | GMG (product | Volume |
| Sample | (product 1-03 | Weight | Weight | 1-03 from | of pure |
| mixture | from Example 1) | of RM | of RD | Example 1) | water |
| No. | to RD to RM | (mg) | (mg) | (mg) | (mL) |
| 8-00 | 0/200/200 | 20 | 20 | 0 | 100 |
| 8-01 | 20/180/200 | | 18 | 2 | |
| 8-02 | 50/150/200 | | 15 | 5 | |
| 8-03 | 100/100/200 | | 10 | 10 | |
| 8-04 | 150/50/200 | | 5 | 15 | |
| 8-05 | 200/0/200 | | 0 | 20 | |

Experiments: Several mixtures of GMG (product 1-03 of Example 1), RM and RD solution were prepared and evaluated according to the aforementioned sensory evaluation standard in Example 2. Average scores from the test panel for each sensory criterion were taken as the evaluation test results. The taste profiles of the resulting beverage product samples are based on the sensory criteria in Example 2.

TABLE 8-2
Sensory evaluation results

| Sample | | | | |
|---|---|---|---|---|
| mixture | | Sweet | Metallic | |
| No. | Sweetness onset | lingering | aftertaste | Overall likability |
| 8-00 | 3 | 4.5 | 4.5 | 1.5 |
| 8-01 | 4 | 3.5 | 3.5 | 3 |
| 8-02 | 4 | 3 | 2 | 3.5 |
| 8-03 | 4 | 2.5 | 2 | 3.5 |
| 8-04 | 4 | 2.5 | 2 | 3.5 |
| 8-05 | 4 | 2 | 2 | 4 |

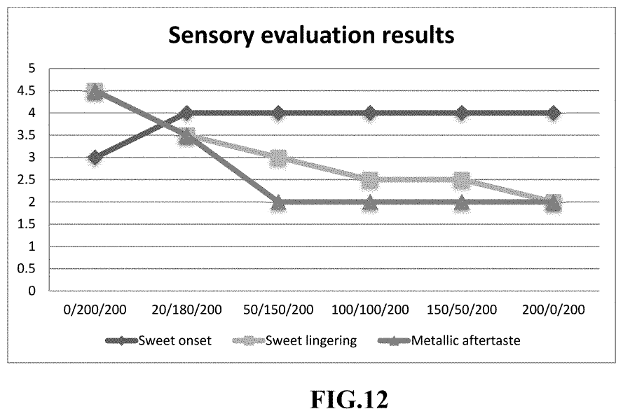

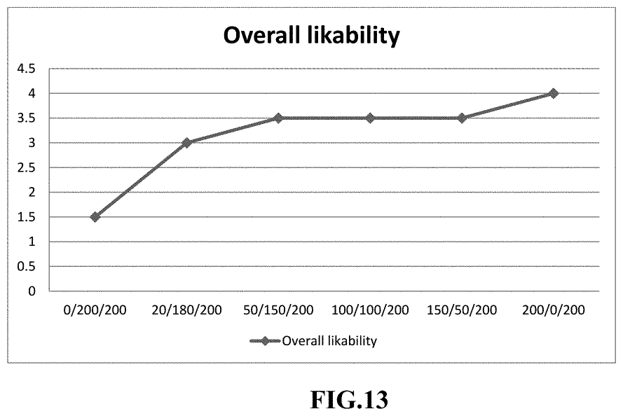

Conclusion: The results showed that with an increase in the proportion of GMG to RD in the 200 ppm RM solution could significantly reduce the unpleasant sweet linger, metallic aftertaste and quicken sweetness onset of the mixture solution (see FIGS. 12-13). It demonstrated that GMG can improve the taste profile, cut sweet linger, reduce the metallic aftertaste and improve the overall likability of the mixture solutions. This example demonstrates that different degree of glycosylated monk fruit extract or mogrosides that contains glycosylated mogrosides of different molecular weight and chain lengths including mono-glycosyl MGs, di-glycosyl MGs, tri-glycosyl MGs, tetra-glycosyl MGs and etc, could improve the taste profile of stevia glycosides of relatively higher (longer chain) molecular weight such as combination of RD and RM. It could further include one or more stevia glycosides selected from RA, RB, RE, stevioside, RO, RN etc.

### Example 9. Analysis of Glycosylated Mogrosides and Mogrosides in Monk Fruit Extracts and GMGs (Products from Example 1)

Material and Methods:

A Reference standards for Mogroside V (No. 1445448-100MG) was obtained from Sigma-Aldrich (Vienna). Solvents and reagents (HPLC grade) were obtained from VWR (Vienna) or Sigma-Aldrich (Vienna). Davisil Grade 633 (high-purity grade silica gel, pore size 60 Å, 200-425 mesh particle size was obtained from Sigma-Aldrich (Vienna).

Sample Preparation:

For analysis the samples were fractionated over a glass column (100×5 mm) filled with Davisil Grade 633. The column was equilibrated with ethlyacetate/Acetic acid/H2O=7/3/2 (v/v/v). 100 mg sample, dissolved in 2 ml H₂O, were loaded on the column and eluted with ethlyacetate/Acetic acid/H2O=7/3/2 at a flow rate of 1.5 ml/min. The first 6 ml of the eluate were discarded and 2×35 ml fractions containing mogrosides and glycosylated mogrosides, respectively, were collected. From each sample 3 replicates were fractionated, pooled, evaporated to dryness and reconstituted in 20 ml Acetonitrile/H2O=9/1 (v/v) corresponding to an equivalent sample concentrations in the fractions of 150 mg sample/10 ml. The method was qualified by fractionation of mogroside V (fraction I) and glycosylated mogrosides (fraction II) prepared in-house from mogroside V. An elution yield of >97% of mogroside V and the corresponding glycosylated mogrosides was observed, the carry over between the fraction was calculated to less than 3%.

HPLC-Method:

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis the samples prepared according to Sample Preparation were used. The samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution. Mobile Phase A consisted of a 0.01 molar NH4-Acetate buffer (native pH) with 0.1% acetic acid, 0.05% trimethylamine and 0.001% dichloromethane. Mobile Phase B consisted of 0.01 molar NH4-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl. The detectors were set to 210 nm (VWD), to 205 nm, 210 nm and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V). Detection at 210 nm were used to quantify (glycosylated) mogrosides, the MS-spectra were used to determine the molar mass and structural information of individual peaks. ESI-MS traces could detect peaks up to a molar mass of 2700 by evaluation of double-charged ions triggered by addition of dichloromethane into the mobile phase. Samples were quantified by external standardization against mogroside V and correction of molar mass as obtained from ESI-MS.

Results:

The analytical test results for MGV50%, GMGs (product 1-01 to 1-03) are shown in Table 9-1 to Table 9-4 below. Pls note abbreviation: Mo: Mogroside; Sia: Siamenoside; 1Glc: added one glucose; 2Glc: added two glucoses; 3Glc: Added three glucoses; 4Glc: added four glucoses; 5Glc: added five glucoses; 6Glc: added six glucoses; 7Glc: added seven glucoses.

TABLE 9-1
Analytical test results for mogroside V 50% (Lot #: LHGE-161112)

| | Molar | Weight content % |
|---|---|---|
| Compound name | mass | (m/m) |
| (Grosvenorine I) | 739 | 0.518 |
| (7-O Mo V) | 1299 | 2.45 |
| (11-O Mo VI) | 1445 | 4.41 |
| (Grosvenorine II) | 577 | 0.275 |
| (Mo VI) | 1447 | 10.4 |
| (11 O-Mo V) | 1283 | 4.48 |
| (Mo V) | 1285 | 47.9 |
| (Mo V Iso) | 1285 | 4.65 |
| (Mo IV/Siam I) | 1123 | 4.35 |
| (Mo IV/Siam I) | 1123 | 3.10 |
| (Mo IV/Siam I) | 1123 | 1.59 |
| (Dehydroxy Mo V) | 1269 | 3.33 |
| (Mo IIIE) | 799 | 0.716 |
| (Mo III) | 961 | 2.88 |

| | |
|---|---|
| Sum: | 91.0 |

TABLE 9-2
Analytical test results of GMG (product 1-01 from Example 1)

| | molar | Observed |
|---|---|---|
| Compound | mass | % (m/m) |
| (Grosvenorine I) | 739 | <0.05 |
| (7-O Mo V) | 1299 | 0.103 |
| (11-O Mo VI) | 1445 | 0.107 |
| (Grosvenorine II) | 577 | <0.05 |
| (Mo VI) | 1447 | 0.186 |
| (11 O-Mo V) | 1283 | 0.534 |
| (Mo V) | 1285 | 1.24 |
| (Mo V Iso) | 1285 | <0.05 |
| (Mo IV/Siam I) | 1123 | 0.288 |
| (Mo IV/Siam I) | 1123 | 0.52 |
| (Mo IV/Siam I) | 1123 | 0.233 |
| (Dehydroxy Mo V) | 1269 | 1.21 |
| (Mo IIIE) | 799 | <0.05 |
| (Mo III) | 961 | <0.05 |
| Sum: | | 4.42 |
| (7-O Mo V + 1 Glc) | 1461 | 0.776 |
| (7-O Mo V + 2 Glc) | 1623 | 0.413 |
| (7-O Mo V + 3 Glc) | 1785 | 0.152 |
| (7-O Mo V + 4 Glc) | 1947 | <0.10 |
| (7-O Mo V + 5 Glc) | 2109 | n.d |
| (11-O Mo VI + 1 Glc) | 1607 | 1.285 |
| (11-O Mo VI + 2 Glc) | 1769 | 0.699 |
| (11-O Mo VI + 3 Glc) | 1931 | 0.325 |
| (11-O Mo VI + 4 Glc) | 2093 | 0.259 |
| (11-O Mo VI + 5 Glc) | 2255 | <0.10 |
| (Mo VI + 1 Glc) | 1609 | 3.97 |
| (Mo VI + 2 Glc) | 1771 | 0.897 |
| (Mo VI + 3 Glc) | 1933 | 0.799 |
| (Mo VI + 4 Glc) | 2095 | 0.472 |
| (Mo VI + 5 Glc) | 2257 | <0.10 |
| (11 O-Mo V + 1 Glc) | 1445 | 0.946 |
| (11 O-Mo V + 2 Glc) | 1607 | 0.589 |
| (11 O-Mo V + 3 Glc) | 1769 | 0.282 |
| (11 O-Mo V + 4 Glc) | 1931 | 0.317 |
| (11 O-Mo V + 5 Glc) | 2093 | <0.10 |
| (Mo V + 1 Glc) | 1447 | 18.2 |
| (Mo V + 2 Glc) | 1609 | 6.19 |
| (Mo V + 3 Glc) | 1771 | 4.09 |
| (Mo V + 4 Glc) | 1933 | 2.06 |
| (Mo V + 5 Glc) | 2095 | 1.04 |
| (Mo V + 6 Glc) | 2257 | 0.514 |
| (Mo V + 7 Glc) | 2419 | 0.269 |
| (Mo IV/Siam I + 1 Glc) | 1285 | 2.03 |
| (Mo IV/Siam I + 2 Glc) | 1447 | 1.30 |
| (Mo IV/Siam I + 3 Glc) | 1609 | 0.983 |
| (Mo IV/Siam I + 4 Glc) | 1771 | 0.541 |
| (Mo IV/Siam I + 5 Glc) | 1933 | 0.236 |

TABLE 9-3
Analytical test results for GMG (product 1-02 from Example 1)

| | molar | Observed |
|---|---|---|
| Compound | mass | % (m/m) |
| (Grosvenorine I) | 739 | <0.05 |
| (7-O Mo V) | 1299 | <0.05 |
| (11-O Mo VI) | 1445 | 0.112 |
| (Grosvenorine II) | 577 | <0.05 |
| (Mo VI) | 1447 | 0.134 |
| (11 O-Mo V) | 1283 | 0.501 |
| (Mo V) | 1285 | 1.57 |
| (Mo V Iso) | 1285 | <0.05 |
| (Mo IV/Siam I) | 1123 | 0.263 |
| (Mo IV/Siam I) | 1123 | 0.179 |
| (Mo IV/Siam I) | 1123 | 0.086 |
| (Dehydroxy Mo V) | 1269 | 0.1 |
| (Mo IIIE) | 799 | <0.05 |
| (Mo III) | 961 | <0.05 |
| Sum: | | 2.95 |
| (7-O Mo V + 1 Glc) | 1461 | 0.831 |
| (7-O Mo V + 2 Glc) | 1623 | 0.432 |
| (7-O Mo V + 3 Glc) | 1785 | <0.10 |
| (7-O Mo V + 4 Glc) | 1947 | n.d |
| (7-O Mo V + 5 Glc) | 2109 | n.d |
| (11-O Mo VI + 1 Glc) | 1607 | 1.126 |
| (11-O Mo VI + 2 Glc) | 1769 | 0.577 |
| (11-O Mo VI + 3 Glc) | 1931 | 0.596 |
| (11-O Mo VI + 4 Glc) | 2093 | <0.10 |
| (11-O Mo VI + 5 Glc) | 2255 | n.d |
| (Mo VI + 1 Glc) | 1609 | 3.37 |
| (Mo VI + 2 Glc) | 1771 | 1.289 |
| (Mo VI + 3 Glc) | 1933 | 0.823 |
| (Mo VI + 4 Glc) | 2095 | 0.204 |
| (Mo VI + 5 Glc) | 2257 | <0.10 |
| (11 O-Mo V + 1 Glc) | 1445 | 1.36 |
| (11 O-Mo V + 2 Glc) | 1607 | 0.551 |
| (11 O-Mo V + 3 Glc) | 1769 | 0.299 |
| (11 O-Mo V + 4 Glc) | 1931 | 0.259 |
| (11 O-Mo V + 5 Glc) | 2093 | <0.10 |
| (Mo V + 1 Glc) | 1447 | 16.8 |
| (Mo V + 2 Glc) | 1609 | 6.82 |
| (Mo V + 3 Glc) | 1771 | 3.34 |
| (Mo V + 4 Glc) | 1933 | 1.71 |
| (Mo V + 5 Glc) | 2095 | 1.003 |
| (Mo V + 6 Glc) | 2257 | 0.285 |
| (Mo V + 7 Glc) | 2419 | <0.10 |
| (Mo IV/Siam I + 1 Glc) | 1285 | 2.33 |
| (Mo IV/Siam 1 + 2 Glc) | 1447 | 1.126 |
| (Mo IV/Siam 1 + 3 Glc) | 1609 | 0.752 |
| (Mo IV/Siam 1 + 4 Glc) | 1771 | 0.460 |
| (Mo IV/Siam I + 5 Glc) | 1933 | 0.121 |

TABLE 9-4
Analytical test results GMG (product 1-03 from Example 1)

| | molar | Observed |
|---|---|---|
| Compound | mass | % (m/m) |
| (Grosvenorine I) | 739 | <0.05 |
| (7-O Mo V) | 1299 | <0.05 |
| (11-O Mo VI) | 1445 | <0.05 |
| (Grosvenorine II) | 577 | <0.05 |
| (Mo VI) | 1447 | 0.106 |
| (11 O—Mo V) | 1283 | 0.462 |
| (Mo V) | 1285 | 1.47 |
| (Mo V Iso) | 1285 | <0.05 |
| (Mo IV/Siam I) | 1123 | 0.197 |
| (Mo IV/Siam I) | 1123 | 0.138 |
| (Mo IV/Siam I) | 1123 | 0.0809 |
| (Dehydroxy Mo V) | 1269 | <0.05 |
| (Mo IIIE) | 799 | <0.05 |
| (Mo III) | 961 | <0.05 |
| Sum: | | 2.45 |
| (7-O Mo V + 1 Glc) | 1461 | 0.675 |
| (7-O Mo V + 2 Glc) | 1623 | 0.269 |
| (7-O Mo V + 3 Glc) | 1785 | 0.123 |
| (7-O Mo V + 4 Glc) | 1947 | n.d. |
| (7-O Mo V + 5 Glc) | 2109 | n.d. |
| (11-O Mo VI + 1 Glc) | 1607 | 0.940 |
| (11-O Mo VI + 2 Glc) | 1769 | 0.498 |
| (11-O Mo VI + 3 Glc) | 1931 | 0.365 |
| (11-O Mo VI + 4 Glc) | 2093 | n.d. |
| (11-O Mo VI + 5 Glc) | 2255 | n.d. |
| (Mo VI + 1 Glc) | 1609 | 3.26 |
| (Mo VI + 2 Glc) | 1771 | 0.796 |
| (Mo VI + 3 Glc) | 1933 | 0.419 |
| (Mo VI + 4 Glc) | 2095 | <0.10 |
| (Mo VI + 5 Glc) | 2257 | n.d. |
| (11 O—Mo V + 1 Glc) | 1445 | 0.743 |
| (11 O—Mo V + 2 Glc) | 1607 | 0.413 |
| (11 O—Mo V + 3 Glc) | 1769 | 0.303 |
| (11 O—Mo V + 4 Glc) | 1931 | 0.166 |
| (11 O—Mo V + 5 Glc) | 2093 | n.d. |
| (Mo V + 1 Glc) | 1447 | 12.8 |
| (Mo V + 2 Glc) | 1609 | 5.95 |
| (Mo V + 3 Glc) | 1771 | 2.58 |
| (Mo V + 4 Glc) | 1933 | 0.98 |
| (Mo V + 5 Glc) | 2095 | 0.49 |
| (Mo V + 6 Glc) | 2257 | n.d. |
| (Mo V + 7 Glc) | 2419 | n.d. |
| (Mo IV/Siam I + 1 Glc) | 1285 | 2.26 |
| (Mo IV/Siam I + 2 Glc) | 1447 | 1.33 |
| (Mo IV/Siam I + 3 Glc) | 1609 | 0.695 |
| (Mo IV/Siam I + 4 Glc) | 1771 | 0.298 |
| (Mo IV/Siam I + 5 Glc) | 1933 | <0.10 |

TABLE 9-5
The ratio of mono-, di- and tri-glycosylated mogroside V to the total
glycosylated mogrosides of the analyzed GMG samples (product 1-01
to 1-03 of Example 10)

| | Total content | Sum of mono-, di, | Ratio of mono, di, tri- |
|---|---|---|---|
| | of glycosylated | tri-glycosylated | glycosylated mogrosides |
| Product | mogrosides | mogroside V | V to total glycosylated |
| Name | (%, m/m) | (%, m/m) | mogrosides (%, m/m) |
| 9-01 | 49.612 | 28.48 | 57.41 |
| 9-02 | 46.481 | 26.96 | 58.00 |
| 9-03 | 36.344 | 21.33 | 58.70 |

Conclusion: GMGs prepared with a higher maltodextrin-to-mogroside V 50% ratio resulted in final products with higher mono-, di-, and tri-glycosylated mogroside V (Mo V+1Glc, Mo V+2Glc, Mo V+3Glc)-to-total glycosylated mogrosides ratio. The glycosylation process reduces the amount of non-mogroside V, such as grosvenorine I and II, 7-O-Mogroside V, 11-O-Mogroside V and VI, Iso-Mogroside V, Mogroside IV, Simenoside I, dehydroxy Mogroside V, Mogroside III, and Mogroside IIIe. Glycosylated monk fruit extract provides a pleasant taste and a sweet profile that is close to that of sucrose solutions. In addition, mono-, di, and tri-glycosylated mogroside V exhibited good quality of sweetness with less after-taste and bitterness. It thus appears that GMG prepared with a higher amount of maltodextrin provides a better taste and sweet profile.

### Example 10. Analysis of the Residual Maltodextrin in the Prepared GMG Samples (Product 1-01 to 1-03 from Example 1)

Materials:

GMGs (product 1-01 to 1-03 from Example 1).

Method:

Assay for Residual Dextrin Content by Macroporous Adsorption Resin Method Test solution. Weigh about 5 g glycosylated monk fruit extract accurately, and pour it into 250 mL of water for dissolution. Fill the solution in a glass column containing 200 mL of macroporous resin (inner diameter 25 mm) at the ratio below 15 mL/min, and then wash the resin with 1000 mL water. Elute the adsorbed stevioside with 1000 mL 50% (by volume) ethanol at the ratio of 15 mL/min or lower. Evaporate the collected ethanol elute and aqueous washing liquid to a dried state, then place them in a vacuum oven and dry at 105° C. for two hours. Weigh and record the dry weight of each component. Calculate Total TMG (total monk fruit ingredients including unreacted mogrosides and glycosylated mogrosides) and residue dextrin contents (%) according to the formula.

Calculate the TMG mass fraction w1 according to the formula (A.1), and calculate the residue dextrin content mass fraction w2 according to the formula (A.2):

$${w}_{1} \frac{{m}_{1}}{{m}_{2} \times ( 1 \; 00 - {w}_{h} ) \times 1 {0}^{- 2}} \times 100 \% \qquad ( A .1 )$$

where
m1—Total amount of the ethanol component after drying, in grams (g);
m2—Wet weight of the original sample, in grams (g);
wh—Moisture content (%);

$${w}_{2} \frac{{m}_{3}}{{m}_{2} \times ( 1 \; 00 - {w}_{h} ) \times 1 {0}^{- 2}} \times 100 \% \qquad ( A .2 )$$

### Where

m3—Total amount of the water component after drying, in grams (g);
m2—Wet weight of the original sample, in grams (g);
wh—Moisture content (%);

### Acceptance Criteria:

The sample recovery ratio must be within the range of 98.0%-102.0%, and the sample recovery ratio w3 is calculated according to the formula (A.3):

$${w}_{3} = {w}_{1} + {w}_{2} \qquad ( A .3 )$$

### Where

w1—Mass fraction of total TMG content (%);
w2—Mass fraction of Rebaudioside D content (%);

Results:

The results for the residual maltodextrin of the GMG samples (product 1-01 to 1-03) are shown in Table 10-1.

TABLE 10-1
Analytical test results for residual maltodextrin in GMG samples
(product 1-01 to 1-03 from Example 1)

| | Original | Residual | Reacted |
|---|---|---|---|
| Product No. | maltodextrin (%) | maltodextrin (%) | maltodextrin (%) |
| 1-01 | 45.21 | 13.85 | 31.36 |
| 1-02 | 50 | 16.11 | 33.89 |
| 1-03 | 58.33 | 20.09 | 38.24 |

Conclusion: GMGs prepared with a higher maltodextrin-to-mogroside V 50% ratio resulted in final products with a higher content of reacted maltodextrin.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A sweetener or flavoring composition, comprising:
(A) one or more glycosylated mogrosides (GMGs); and
(B) one or more non-mogroside sweeteners.

2. The sweetener or flavoring composition composition of claim 1, wherein the one or more GMGs comprise a glycosylated mogroside IIe, a glycosylated mogroside III, a glycosylated mogroside IIIe, a glycosylated mogroside IV, a glycosylated mogroside IVe, a glycosylated mogroside V, a glycosylated mogroside VI, a glycosylated siamenoside I, a glycosylated 11-oxomogroside V, or any combination thereof.

3. The sweetener or flavoring composition of claim 2, wherein the the one or more GMGs comprises glycosylated mogroside V.

4. The sweetener or flavoring composition of claim 3, wherein the glycosylated mogroside V comprises MGV-G1, MGV-G2, MGV-G3, MGV-G4 and/or MGV-G5.

5. The sweetener or flavoring composition of claim 1, wherein the one or more non-mogroside sweeteners comprise steviol glycosides.

6. The sweetener or flavoring composition of claim 1, wherein the one or more non-mogroside sweeteners comprise RD, RM or both RD and RM.

7. The sweetener or flavoring composition of claim 1, wherein the one or more non-mogroside sweeteners comprise RU.

8. The sweetener or flavoring composition of claim 1, wherein the one or more non-mogroside sweeteners comprise glycosylated steviol glycosides (GSGs).

9. The sweetener or flavoring composition of claim 1, wherein the one or more non-mogroside sweeteners comprise glycosylated RU.

10. The sweetener or flavoring composition of claim 1, wherein the weight ratio of A:B is in the range of 99:1 to 1:99.

11. The sweetener or flavoring composition of claim 1, further comprising one or more un-reacted mogrosides.

12. The sweetener or flavoring composition of claim 11, wherein the one or more un-reacted mogrosides are present in a total amount of 0.001-20 wt % of the composition.

13. The sweetener or flavoring composition of claim 1, further comprising un-reacted dextrins.

14. The sweetener or flavoring composition of claim 13, wherein the un-reacted dextrins are present in a total amount of 0.001-30 wt % of the composition.

15. The sweetener or flavoring composition of claim 1, further comprising a sweetener selected from the group consisting of cane sugar, beet sugar, honey, sucrose, fructose, maltose, xylitol, sorbitol, dextrose, glucose, mannitol, arabinose, galactose, mannose, rhamnose, xylose, inulin, sucralose, aspartame, stevia acesulfame-K, neotame, thaumatin, brazzein, miraculin, curculin, pentadin, mabinlin, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, monellin, or sodium cyclamate and mixtures thereof.

16. A method of improving the taste profile of a steviol glycoside composition, comprising:
additing to the steviol glycoside composition, a sufficient amount of a glycosylated mogroside.

17. The method of claim 16, wherein the steviol glycoside composition comprises RU.

18. The method of claim 16, wherein the steviol glycoside composition comprises RD, RM or a combination thereof.

19. A method of improving the taste profile of a glycosylate steviol glycoside composition, comprising:
additing to the glycosylated steviol glycoside composition, a sufficient amount of a glycosylated mogroside.

20. The method of claim 19, wherein the glycosylated steviol glycoside composition comprises glycosylated RU.
